(19) United States
(12) Patent Application Publication
(10) Pub. No.: US 2025/0129215 A1
(43) Pub. Date: Apr. 24, 2025

(54) (POLY)SILSESQUIOXANE-FORMING COMPOSITE COMPOSITION

(71) Applicant: Robert Bosch GmbH, Stuttgart (DE)

(72) Inventors: Tobias Kohler, Reutlingen (DE); Martin Schubert, Stuttgart (DE); Stefan Henneck, Leonberg (DE); Andreas Harzer, Schwieberdingen (DE)

(21) Appl. No.: 18/689,326

(22) PCT Filed: Sep. 27, 2022
(86) PCT No.: PCT/EP2022/076865

§ 371 Date: Mar. 5, 2024

(30) Foreign Application Priority Data
Sep. 27, 2021 (DE) 10 2021 210 765.6
Jun. 8, 2022 (DE) 10 2022 205 830.5

(51) Int. Cl. C08G 77/04; C08G 77/06; C08G 77/18; C08K 3/22; C09D 7/40; C09D 7/61; C09D 183/04

(52) U.S. Cl. CPC C08G 77/045; C08G 77/06; C08G 77/18; C09D 7/61; C09D 7/69; C09D 183/04; C08K 2003/2227; C08K 2201/005

(57) ABSTRACT

A composite composition for forming a composite, for example for potting electronics and/or electrics, in particular power electronics. The composite composition comprises, relative to the total weight of the composite composition, ≥10 wt. % to ≤95 wt. % of at least one filler and ≥1 wt. % to ≤20 wt. % of at least one oligomeric and/or polymeric silanol and/or silsesquioxane prepolymer, in particular polysilsesquioxane prepolymer and/or ≥1 wt. % to ≤20 wt. % of at least one oligomeric and/or polymeric silanol precursor having hydrolyzable groups and/or ≥1 wt. % to ≤20 wt. % of at least one silanol having hydrolyzable groups. A method for the preparation thereof, preparation methods for preparing silane compounds and/or silane compositions therefor, corresponding silane compounds and/or compositions, a correspondingly prepared composite and/or silsesquioxane, and the use thereof are also described.

### FIELD

The present invention relates to a composite composition for forming a composite, for example which can be used for potting electronics and/or electrics, in particular power electronics. The present invention also relates to a method for the preparation thereof, preparation methods for preparing silane compounds and/or silane compositions therefor, corresponding silane compounds and/or compositions, a correspondingly prepared composite and/or silsesquioxane, and the use thereof.

### BACKGROUND INFORMATION

Electronics are nowadays usually encapsulated with silicone gels or epoxy resins.

In addition, inorganically bonded potting compounds are also described, for example, in German Patent Application Nos. DE 10 2018 214 641 A1 and DE 10 2018 215 694 A1.

U.S. Patent Application Publication No. US 2015/0065643 A1 describes a thermosetting resin composition as an encapsulation material for optical semiconductors. European Patent No. EP 3 101 068 B1 describes a polysilsesquioxane (PSSO)-based UV-LED encapsulation material that comprises phosphoric acid as a catalyst. In the document: “Progress in Organic Coatings,” vol. 143, 105639 (DOI: 10.1016/j.porgcoat.2020.105639), foldable, hard coating materials based on reaction-controlled polysilsesquioxanes for flexible electronic devices are described. European Patent Application Nos. EP 0 406 911 A1, EP 0 198 976 A2, EP 0 406 911 B1 and EP 0 198 976 B1 describe methods for preparing polysilsesquioxanes. European Patent Application No. EP 3 181 646 A1 describes an electronic device with an anti-fingerprint coating comprising polysilsesquioxane. U.S. Patent Application Publication No. US 2006/0202288 A1 and Japan Patent Application No. JP 2006253510 A describe an insulator composition that comprises a polysilsesquioxane derivative. In Materials Science Forum, vol. 498-499, pages 369-374, M. A. Schiavon and others describe ceramic composites formed by pyrolysis of Nb/Al₂O₃-filled polysilsesquioxanes at 1400° C.

### SUMMARY

The present invention relates to a composite composition for forming a composite, in particular for potting electronics and/or electrics. According to an example embodiment of the present invention, the composite composition comprises, relative to the total weight of the composite composition,
≥10 wt. % to ≤95 wt. % of at least one filler and
≥1 wt. % to ≤20 wt. % of at least one oligomeric and/or polymeric silanol and/or silsesquioxane prepolymer, for example polysilsesquioxane prepolymer, and/or
≥1 wt. % to ≤20 wt. % of at least one oligomeric and/or polymeric silanol precursor having hydrolyzable groups, and/or
≥1 wt. % to ≤20 wt. % of at least one, in particular monomeric, silanol having hydrolyzable groups.

A composite composition for forming a composite can in particular be understood to mean a composition that can be solidified, in particular cured, to form a composite.

Within the meaning of the present invention, oligomeric or an oligomer can in particular be understood to mean a molecule having repeat units that has at least two to one hundred repeat units.

Within the meaning of the present invention, polymeric or a polymer can in particular be understood to mean a molecule, for example macromolecule, having repeat units that has more than one hundred repeat units.

A silanol can in particular be understood to mean a silane derivative in which a hydroxy group (OH group) or multiple hydroxy groups (OH groups) is or are bonded to a silicon atom.

A silsesquioxane prepolymer, in particular a polysilsesquioxane prepolymer, can be understood in particular to mean a prepolymer from which a silsesquioxane, in particular polysilsesquioxane, can be formed, in particular by means of a condensation reaction.

A silsesquioxane can be understood in particular to mean an organic silicon compound that is based on the general chemical formula: [RSiO_{3/2}]ₙ or [RSiO_{1,5}]ₙ. In this case, R can stand for an organic radical, for example. Silsesquioxanes can have a polymeric and/or cage-like structure with Si—O—Si linkages and, in particular tetrahedral, silicon vertices.

A polysilsesquioxane can in particular be understood to mean a polymeric silsesquioxane.

A condensation reaction or condensation or condensing can in particular be understood to mean a chemical reaction in which two functional groups form a covalent bond with elimination of a low-molecular-weight substance, for example of a reaction solvent, for example of water and/or an alcohol. The chemical reaction can take place, for example, between two molecules, which each have one of the functional groups, and/or intramolecularly, in particular between two functional groups of a molecule.

A hydrolyzable group, in particular of a silicon compound, for example a silanol precursor or silanol, can in particular be understood to mean a functional group, in particular a functional group bonded to a silicon atom, which can be hydrolyzed with water to form a hydroxy group (OH group), in particular to form a silanol. For example, a hydrolyzable group, in particular of a silicon compound, for example a silanol precursor or silanol, can be an alkoxy group or a halogen atom.

A silanol precursor can in particular be understood to mean a silicon compound that can be hydrolyzed with water to form a silanol.

According to an example embodiment of the present invention, the composite composition can advantageously (itself) be flowable and/or castable, for example before the solidification, in particular curing, thereof. The composite composition can therefore be used in particular for casting and/or for coating and/or for potting and/or for encasing. The composite composition can particularly advantageously be used for potting and/or encasing. The composite composition can therefore also be referred to as a potting compound and/or encasing compound. In particular, the composite composition can also be used for potting and/or for encasing, for example for encapsulating, electronics and/or electrics, for example power electronics, in particular for high voltages and currents, for example power electronics modules, for example in the form of frame modules.

In this case, the potting compound and/or encasing compound can advantageously also be used for potting and/or encasing electronics and/or electrics by means of the glob-top technique and/or the dam-and-fill technique.

According to the present, advantageously, very stable composites can be formed, for example at temperatures from ≥100° C., in particular from ≥130° C., to ≤250° C., from oligomeric and/or polymeric silanols and/or oligomeric and/or polymeric silanol precursors and/or silanols having hydrolyzable groups. The hydroxy groups of silanols can condense directly with elimination of water and formation of strong, covalent bonds to form a three-dimensional, in particular polymeric, network, for example to form silsesquioxanes, in particular polysilsesquioxanes, and/or with OH groups, for example on material surfaces, for example of the at least one filler and/or of a substrate. Hydrolyzable groups of silanol precursors and/or silanols can also condense directly hereby, in particular to form silsesquioxanes, for example polysilsesquioxanes. In addition, hydrolyzable groups of silanol precursors and/or silanols can condense indirectly, in particular first via a hydrolysis of the hydrolyzable groups to hydroxy groups, and then via condensation of the hydroxy groups, in particular to form silsesquioxanes, for example polysilsesquioxanes.

It has been found within the scope of the present invention that particularly advantageous organosilicon-bonded composites can be formed from silsesquioxanes, for example from polysilsesquioxanes. Since silsesquioxanes, for example polysilsesquioxanes, advantageously have a large fraction based on silicon-oxygen bonds, in particular which is rather associated with inorganic, in particular ceramic, properties, and only a comparatively small organic fraction, in particular which is formed substantially by the organic radical explained later and can, for example, only be a simple methyl group, composites formed therefrom can advantageously have quasi-ceramic properties or similar properties to ceramic composites. For example, composites containing silsesquioxane, for example polysilsesquioxane, can have a high strength, hardness and/or robustness in comparison with composites with polymeric binders. In comparison with (purely) inorganic, in particular ceramic, composites, which also include, for example, composites formed by pyrolysis of silsesquioxanes, for example polysilsesquioxanes, for example at 1400° C.—since these lose their organic fraction during the pyrolysis and are then (purely) inorganic—composites formed from silsesquioxanes, for example polysilsesquioxanes, by curing at temperatures from ≥100° C., in particular from ≥130° C., to ≤250° C., retain their organic fraction, for example in the form of an organic radical per silicon atom, which organic radical can provide these with, for example, a certain elasticity and/or low brittleness and/or improved adhesion and/or increased hydrophobicity and/or reduced water absorption.

Filler materials generally have at least a small fraction of OH groups on their surface, whether because the filler material itself is already an oxygen-containing, for example, ceramic, for example oxidic and/or siliceous, material or a material that is, for example, essentially oxygen-free, for example a ceramic and/or metallic material, but that can have an oxidized surface having OH groups due to passivation and/or degradation phenomena, for example by reaction with atmospheric humidity, such as other types of ceramic materials such as nitrides, for example aluminum nitride and/or boron nitride, and/or metals, such as copper, silver, gold, nickel, aluminum, iron et cetera, and/or semimetals, such as silicon, and/or carbon modifications. This makes it possible for silanols and/or silanol precursors having hydrolyzable groups and/or silanols with OH groups on the surface of the at least one filler to react by means of a condensation reaction with elimination of water and thereby form a strong chemical, in particular covalent. bond to the surface of the at least one filler. Highly thermally conductive, for example ceramic, fillers can thus advantageously be bonded in the composite formed.

In addition, most materials used in the field of electronic and/or electrical engineering and/or construction and bonding technology, for example metals, such as copper, silver, gold, nickel, aluminum, et cetera and/or semiconductors, such as silicon, and/or ceramic materials, such as silicon dioxide and/or aluminum oxide, also have a surface having OH groups, possibly due to passivation and/or degradation phenomena, for example by reaction with atmospheric humidity. This makes it possible for silanols and/or silanol precursors and/or silanols having hydrolyzable groups to react, also thereby by means of a condensation reaction with elimination of water, and also thereby to form a strong chemical, in particular covalent, bond to the surface of such substrates, for example electronic and/or electrical components.

In this way, the at least one oligomeric and/or polymeric silanol and/or silsesquioxane prepolymer, for example polysilsesquioxane prepolymer, and/or the at least one oligomeric and/or polymeric silanol precursor having hydrolyzable groups, and/or the at least one silanol having hydrolyzable groups, in the composite composition advantageously make it possible to form, in particular by curing at a temperature in a range from ≥100° C., in particular from ≥130° C., to ≤250° C., a very solid, strongly adherent, in particular self-adhesive and thermally stable composite on the basis of an Si—O—Si—O structure with strong chemical bonds to the at least one filler and possibly also to another surface in contact with same, for example of a substrate, for example an electronic and/or electrical component, on and/or against and/or with which the composite composition was cast and/or potted and/or encased and/or coated, which in particular can also be used at operating temperatures above 200° C. and, for example, also in long-term thermal loads up to 300° C.

Good adhesion, for example even to metals, such as aluminum and/or copper, can be of crucial importance, for example, for the robustness of an electronic component, in particular for active electronic components, for example with Si, SiC and/or GaN semiconductors, which is why the compositions, compounds and/or composites according to the present invention can be used particularly advantageously for this purpose, in particular in contrast to conventional inorganically bonded potting compounds, which usually have inadequate adhesion.

Because the composite composition comprises at least one oligomeric and/or polymeric silanol and/or silsesquioxane prepolymer, for example polysilsesquioxane prepolymer, and/or at least one oligomeric and/or polymeric silanol precursor having hydrolyzable groups and/or at least one silanol having hydrolyzable groups, the amount of water that is eliminated during condensation to form the composite and/or the amount of water contained due to the preparation method, and thereby in turn a shrinkage during curing of the composite composition to form the composite, can advantageously be reduced, in particular minimized, and/or the curing thereof can be accelerated, and/or corrosion can be avoided.

In the case of oligomeric and/or polymeric silanols and/or silsesquioxane prepolymers, for example polysilsesquioxane prepolymers, a plurality, in particular the majority, of the hydroxy groups condensable with elimination of water can advantageously already be condensed, in particular oligomerized and/or polymerized, beforehand outside the composite composition, so that, by using oligomeric and/or polymeric silanols and/or silsesquioxane prepolymers, for example polysilsesquioxane prepolymer, in the composite composition, the elimination of water during curing of the composite composition and thus its shrinkage can advantageously be greatly reduced, in particular minimized, and/or the curing thereof can be greatly accelerated, and/or corrosion can be avoided. In addition, oligomeric and/or polymeric silanols and/or silsesquioxane prepolymers, for example polysilsesquioxane prepolymers, can have a low volatility, which can have an advantageous effect on curing of the composite composition.

Oligomeric and/or polymeric silanol precursors having hydrolyzable groups can have, as such, substantially no hydroxy groups condensable with elimination of water and can already be condensed, in particular oligomerized and/or polymerized, beforehand, in particular outside the composite composition. As a result of this condensation, in particular oligomerization and/or polymerization, carried out beforehand, in particular outside the composite composition, the amount of water formed during curing of the composite composition to form the composite can advantageously be reduced, and the shrinkage during curing can thereby also be reduced, and/or the curing thereof can be accelerated. During the curing of the composite composition to form the composite, oligomeric and/or polymeric silanol precursors having hydrolyzable groups can, for example, condense directly with OH groups on material surfaces, for example of the filler and/or of a substrate, and/or with hydroxy groups of other components of the composite composition, for example from the at least one oligomeric and/or polymeric silanol and/or silsesquioxane prepolymer, for example polysilsesquioxane prepolymer, and/or from the at least one silanol having hydrolyzable groups, and/or indirectly initially hydrolyze with water, for example in the form of (residual) moisture in at least one other component of the composite composition, for example in the at least one filler, and/or in the form of a low water admixture, for example water in an in particular very small amount of substance, which can be, for example, stoichiometric to half-stoichiometric to the hydrolyzable groups of the at least one oligomeric and/or polymeric silanol precursor having hydrolyzable groups, and/or initially at least partially hydrolyze with atmospheric humidity to form hydroxy groups, and the hydroxy groups then condense with one another and/or with hydrolyzable groups.

Silanols having hydrolyzable groups can advantageously condense, in particular oligomerize and/or polymerize, directly amongst one another by a condensation reaction of two hydroxy groups and/or by a condensation reaction of a hydroxy group with a hydrolyzable group and/or by a condensation reaction of hydroxy groups and/or hydrolyzable groups with an OH groups on material surfaces, for example of the filler and/or of a substrate, and/or initially at least partially hydrolyze indirectly by water eliminated during the condensation and then condense. In this way, by using silanols having hydrolyzable groups in the composite composition, the contained and/or eliminated amount of water can advantageously be reduced during curing of the composite composition, in particular in comparison with silanols having only hydroxy groups, and thus at least the curing process thereof can be accelerated and/or corrosion can be reduced.

A reduction, in particular minimization, of the amount of water has proven particularly more advantageous in particular for electronic and/or electrical applications, in particular in the case of active components, for example which can be particularly moisture-sensitive.

Because the at least one oligomeric and/or polymeric silanol and/or silsesquioxane prepolymer, for example polysilsesquioxane prepolymer, and/or the at least one oligomeric and/or polymeric silanol precursor having hydrolyzable groups, in particular alkoxy groups, and/or the at least one silanol having hydrolyzable groups of the composite composition can itself already react with OH groups on substrate surfaces to form strong chemical, in particular covalent, bonds, it is also advantageously possible to dispense with an application of an additional adhesion promoter layer. The composite composition can thus advantageously be used as a so-called single-system casting. As a result, process steps can advantageously be reduced and preparation methods can be simplified.

In the composite, the at least one oligomeric and/or polymeric silanol and/or silsesquioxane prepolymer, for example polysilsesquioxane prepolymer, and/or the at least one oligomeric and/or polymeric silanol precursor having hydrolyzable groups, and/or the at least one silanol precursor having hydrolyzable groups, can form, for example, a closely meshed, and in particular also a three-dimensional, network, whereby the composite formed therefrom advantageously can have on the one hand a high strength, in particular stiffness and/or hardness, for example which can exceed those of conventional crosslinked polysiloxane resins, and on the other hand also hardly any or no thermoplastic softening, in particular no glass transition temperature detectable in the dilatometer.

Because the at least one filler has a comparatively high weight percentage, for example from ≥10 wt. % to ≤95 wt. %, in particular from ≥60 wt. % to ≤95 wt. %, for example from ≥75 wt. % to ≤95 wt. %, and thus in particular can also make up a high volume fraction of the composite composition and of the composite formed therefrom, and because the at least one oligomeric and/or polymeric silanol and/or silsesquioxane prepolymer, for example polysilsesquioxane prepolymer, and/or the at least one oligomeric and/or polymeric silanol precursor having hydrolyzable groups, and/or the at least one silanol having hydrolyzable groups can make up a rather low weight percentage, in particular from ≥1 wt. % to ≤20 wt. %, for example from ≥5 wt. % to ≤20 wt. %, and in particular also volume fraction of the composite composition and the composite formed therefrom, a low shrinkage and a low coefficient of thermal expansion or thermal expansion coefficient, in particular with at the same time high stiffness, can also advantageously be realized, which can be particularly advantageous in particular in the potting of bulky structures and in particular electronics, such as power electronics.

The composite composition according to the present invention can be used, inter alia, particularly advantageously for potting electronics and/or electrics, such as power electronics, since due to low coefficients of thermal expansion, for example in a range of 7-9·10⁻⁶ K⁻¹, for example with respect to metals of conductor tracks and/or a printed circuit board assembly, and also the high strength and the high adhesive strength of the composite formed therefrom, thermally induced deformations and/or relative movements, for example of printed circuit board or printed circuit board assembly, bonding wires, chips, and solders, which occur in particular in the case of high electrical loads and thereby generated heat loss in conventional electronic pottings and in the long term can lead to a decomposition of layers and connections, can be impeded by the composite. Thus, by means of the composite formed from the composite composition, a compression stabilization or fixing of the construction and connection technology on the substrate, for example on the printed circuit board, for example of a bonding layer, for example a solder layer and/or sinter layer, for example between semiconductor chips and printed circuit board, and/or of wire or ribbon bonding connections, for example in the case of thermal cycling, can advantageously be achieved, and, for example, a thermal delamination and, for example, a so-called bonding wire lift-off can be prevented. Electronics can thus also be protected from thermomechanical influences in addition to mechanical influences by the composite formed from the composite composition. In this case, the composite formed from the composite composition can have high thermal stability and high continuous thermal load capacity, for example of above 180° C. up to 260° C. (junction temperature), in comparison with epoxy-based potting compounds. This in turn advantageously makes it possible, by potting with the composite composition, to increase the service life of electronics and/or electrics, in particular power electronics, significantly, for example by a factor of 3 in comparison with conventional potting compounds for this purpose.

In addition, oligomeric and/or polymeric silanols and/or silsesquioxane prepolymers, for example polysilsesquioxane prepolymers, in particular in, for example, alcoholic, for example ethanolic, solutions, and/or oligomeric and/or polymeric silanol precursors having hydrolyzable groups and/or silanols having hydrolyzable groups can advantageously be less viscous than, for example, polysiloxane or silicone elastomers, which makes it possible to provide a highly flowable composite composition also with a very high filling level of the at least one filler and/or in particular also with a wide granulation band of the at least one filler and/or in particular also with fillers having large particles, for example in a range from ≥1 μm to ≤200 μm, which advantageously also can be processed, in particular cast and/or potted, without pressure and/or without a vacuum, i.e., utilizing gravity and/or without the need for vacuum, and/or without the need to heat the potting compound during potting.

In addition, the low viscosity of the at least one oligomeric and/or polymeric silanol and/or silsesquioxane prepolymer, for example polysilsesquioxane prepolymer, and/or of the at least one oligomeric and/or polymeric silanol precursor having hydrolyzable groups, and/or of the at least one silanol having hydrolyzable groups and its low weight percentage or volume fraction, allows the particles of the at least one filler to be chemically connected to one another via very thin structures, for example, layers, formed from the at least one oligomeric and/or polymeric silanol and/or silsesquioxane prepolymer, for example polysilsesquioxane prepolymer, and/or the at least one oligomeric and/or polymeric silanol precursor having hydrolyzable groups, and/or the at least one silanol having hydrolyzable groups, whereby a high thermal conductivity, for example above 5 W/(m·K), and/or an improved thermal spreading can be achieved within the composite formed therefrom, which can in particular be higher than the thermal conductivity and thermal spreading of conventional polysiloxane or silicone elastomer-based potting compounds and/or pressurelessly and cold-castable silicone gels and/or unfilled and filled polyurethanes and/or epoxy resins, in particular that can only achieve relatively low thermal conductivities, for example of only up to approximately 2.5 W/(m·K), which are inadequate in particular for cooling power electronics. Since, in the case of power electronics in particular a high thermal conductivity and thermal spreading are needed for effective heat dissipation, the composite composition can be used particularly advantageously for potting and/or for encasing the same. In particular on power electronics modules with so-called “bare die” semiconductor chips, which are constructed on ceramic printed circuit boards, for example DBC (direct bonded copper), AMB (active metal brazed), LTCC (low temperature co-fired ceramic) et cetera, the composite composition can make possible a significant increase in the service life, for example by at least a factor of 3 in comparison with an identical structure with a conventional silicone gel potting, and/or in particular also allow higher continuous operating temperatures, for example of above 180° C., at the semiconductors. Since the power utilization of SiC semiconductors, for example in the case of frame modules with power electronics, is limited in particular by the level of the continuous operation temperature, and the composite composition enables higher continuous operation temperatures, for example of above 180° C., the power utilization of SiC semiconductors, for example in the case of frame modules with power electronics, can thus advantageously also be increased by the composite composition.

Since the condensation reaction of the at least one oligomeric and/or polymeric silanol and/or silsesquioxane prepolymer, for example polysilsesquioxane prepolymer, and/or the at least one oligomeric and/or polymeric silanol precursor having hydrolyzable groups, and/or the at least one silanol having hydrolyzable groups, only occurs effectively at high temperatures, for example from ≥100° C., in particular from 130° C., to ≤250° C., the composite composition according to the present invention can advantageously have a long pot life, for example of several days at moderate temperatures, for example at room temperature, for example in a closed system, which can be particularly advantageous in particular for process development of series production. In order to counteract a filler sedimentation during the pot life, the composite composition can, for example, be stirred continuously or stirred at least before its use.

Since the condensation reaction of the at least one oligomeric and/or polymeric silanol and/or silsesquioxane prepolymer, for example polysilsesquioxane prepolymer, and/or of the at least one oligomeric and/or polymeric silanol precursor having hydrolyzable groups, and/or of the at least one silanol having hydrolyzable groups, only occurs effectively at high temperatures, for example from ≥100° C., in particular from 130° C., to ≤250° C., the composite composition according to the present invention can also be dried after the application thereof, for example after casting and/or potting and/or encasing and/or coating, initially at low temperatures, for example in a range from ≥0° C. to ≤90° C., for example using a negative pressure, in particular before the curing at high temperature, for example, from ≥100° C., in particular from 130° C., to ≤250° C. For example, volatile solvents, for example alcohols and/or water, can be removed in the process. During drying, the composite composition can advantageously remain deformable and adapt its shape to its surroundings, for example to the shape of a substrate potted and/or encased and/or coated therewith, for example an electronic and/or electrical component. Mechanical stresses and, for example, crack formation can thus be minimized. In addition, because the composite composition is dried before curing, the time in which the substrate potted and/or encased and/or coated with the composite composition, for example electronics, is in contact with solvents and/or a bubble formation during curing can be minimized.

Overall, a composite composition with reduced, in particular minimized, curing shrinkage and/or accelerated drying and/or curing and/or a low corrosion potential can thus advantageously be provided, for example which can be used in a simple manner for casting and/or potting and/or encasing and/or coating, for example for encapsulating, in particular for potting and/or for encasing, for example electronics and/or electrics, in particular power electronics, and from which a solid, in particular rigid, adhesive, in particular self-adhesive, and thermally stable composite can be formed with a low coefficient of thermal expansion, with a high thermal conductivity and/or thermal spreading and with a high continuous thermal load capacity. The composite composition can be used particularly advantageously for potting and/or encasing electronics and/or electrics, in particular power electronics, wherein the electronics and/or electrics are protected and in particular compression-stabilized and/or the service life and/or power utilization thereof can be increased by the composite formed therefrom.

In one example embodiment of the present invention, the composite composition comprises, relative to the total weight of the composite composition,
≥2 wt. % to ≤20 wt. %, in particular ≥5 wt. % to ≤20 wt. %, for example ≥5 wt. % to ≤15 wt. %, for example ≥10 wt. % to ≤15 wt. %, of the at least one oligomeric and/or polymeric silanol and/or silsesquioxane prepolymer, in particular polysilsesquioxane prepolymer, and/or
≥2 wt. % to ≤20 wt. %, in particular ≥5 wt. % to ≤20 wt. %, for example ≥5 wt. % to ≤15 wt. %, for example ≥10 wt. % to ≤15 wt. %, of the at least one oligomeric and/or polymeric silanol precursor having hydrolyzable groups, and/or
≥2 wt. % to ≤20 wt. %, in particular ≥5 wt. % to ≤20 wt. %, for example ≥5 wt. % to ≤15 wt. %, for example ≥10 wt. % to ≤15 wt. %, of the at least one silanol having hydrolyzable groups.

In a further embodiment of the present invention, the composite composition comprises, relative to the total weight of the composite composition, ≥1 wt. % to ≤20 wt. %, for example ≥2 wt. % to ≤20 wt. %, in particular ≥5 wt. % to ≤20 wt. %, for example ≥5 wt. % to ≤15 wt. %, for example ≥10 wt. % to ≤15 wt. %, in total of the at least one oligomeric and/or polymeric silanol and/or silsesquioxane prepolymer, for example polysilsesquioxane prepolymer, and/or of the at least one oligomeric and/or polymeric silanol precursor having hydrolyzable groups, and/or of the at least one silanol having hydrolyzable groups. This has proven to be particularly advantageous in the context of the present invention.

In the context of the present invention, it has surprisingly been found that high to very high filling levels of the at least one filler can be realized even by a comparatively small amount of ≥1 wt. % to ≤20 wt. %, for example of ≥2 wt. % to ≤20 wt. %, in particular of ≥5 wt. % to ≤20 wt. %, for example of ≥10 wt. % to ≤15 wt. %, relative to the total weight of the composite composition, in total of the at least one oligomeric and/or polymeric silanol and/or silsesquioxane prepolymer, for example polysilsesquioxane prepolymer, and/or of the at least one oligomeric and/or polymeric silanol precursor having hydrolyzable groups, and/or of the at least one silanol having hydrolyzable groups, in the composite composition. For example, the composite composition can comprise, relative to the total weight of the composite composition, ≥15 wt. % or ≥20 wt. % or ≥25 wt. % or ≥30 wt. % or ≥35 wt. % or ≥40 wt. % or ≥45 wt. % or ≥50 wt. % or ≥55 wt. %, in particular ≥60 wt. % or ≥65 wt. % or ≥70 wt. %, for example ≥75 wt. %, to ≤95 wt. %, for example to 94 wt. % or ≤93 wt. % or ≤92 wt. %, optionally to ≤91 wt. % or ≤90 wt. % of the at least one filler. Due to a high filling level of the at least one filler, the mechanical stability, the thermal conductivity, the thermal spreading, the electrical insulation capacity and/or the thermal expansion coefficient of the composite formed from the composite composition can advantageously be further optimized, and in particular a shrinkage of the composite composition during curing to form the composite can also be further minimized.

In one embodiment of the present invention, the composite composition therefore comprises, relative to the total weight of the composite composition, ≥60 wt. % to ≤95 wt. % of the at least one filler. For example, the composite composition can comprise, relative to the total weight of the composite composition, ≥61 wt. % or ≥62 wt. % or ≥63 wt. % or ≥64 wt. % or ≥65 wt. % or ≥66 wt. % or ≥67 wt. % or ≥68 wt. % or ≥69 wt. %, for example ≥70 wt. % or ≥71 wt. % or ≥72 wt. % or ≥73 wt. % or ≥74 wt. %, in particular ≥75 wt. % or ≥76 wt. % or ≥77 wt. % or ≥78 wt. % or ≥79 wt. %, optionally ≥80 wt. % or ≥81 wt. % or ≥82 wt. % or ≥83 wt. % or ≥84 wt. % or ≥85 wt. %, to ≤95 wt. %, for example to ≤94 wt. % or ≤93 wt. %, for example to ≤92 wt. %, optionally to ≤91 wt. % or ≤90 wt. %, of the at least one filler.

In a specific embodiment of the present invention, the composite composition comprises, relative to the total weight of the composite composition, ≥75 wt. % to ≤95 wt. %, of the at least one filler. This has proven to be particularly advantageous with regard to the thermal conductivity, the thermal spreading, the mechanical stability, the electrical insulation capacity and the thermal expansion coefficient of the composite formed from the composite composition, and a minimization of the shrinkage of the composite composition during curing to form the composite, and for the volume potting. The composite composition can optionally comprise, relative to the total weight of the composite composition, ≥85 wt. % to ≤90 wt. % of the at least one filler.

Of the three silicon compound classes, in particular the at least one oligomeric and/or polymeric silanol and/or silsesquioxane prepolymer, for example polysilsesquioxane prepolymer, the at least one oligomeric and/or polymeric silanol precursor having hydrolyzable groups, and the at least one silanol having hydrolyzable groups, the composite composition can comprise, for example (only) the at least one oligomeric and/or polymeric silanol and/or silsesquioxane prepolymer, in particular polysilsesquioxane prepolymer, or (only) the at least one oligomeric and/or polymeric silanol precursor having hydrolyzable groups, or (only) the at least one silanol having hydrolyzable groups, or a combination of two or three of these silicon compound classes, for example a combination of the at least one oligomeric and/or polymeric silanol and/or silsesquioxane prepolymer, for example polysilsesquioxane prepolymer, and the at least one oligomeric and/or polymeric silanol precursor having hydrolyzable groups, or a combination of the at least one oligomeric and/or polymeric silanol and/or silsesquioxane prepolymer, for example polysilsesquioxane prepolymer, and the at least one silanol having hydrolyzable groups, or a combination of the at least one oligomeric and/or polymeric silanol and/or silsesquioxane prepolymer, for example polysilsesquioxane prepolymer, and the at least one oligomeric and/or polymeric silanol precursor having hydrolyzable groups, and the at least one silanol having hydrolyzable groups, or a combination of the at least one oligomeric and/or polymeric silanol precursor having hydrolyzable groups, and the at least one silanol having hydrolyzable groups.

In particular, the composite composition can comprise (only) the at least one oligomeric and/or polymeric silanol and/or silsesquioxane prepolymer, for example polysilsesquioxane prepolymer. This has proven to be particularly advantageous in the context of the present invention.

The at least one oligomeric and/or polymeric silanol and/or silsesquioxane prepolymer, for example polysilsesquioxane prepolymer, can be, for example, a (single) oligomeric or polymeric silanol and/or silsesquioxane prepolymer, for example polysilsesquioxane prepolymer, or a combination of two or more identical or different oligomeric and/or polymeric silanols and/or silsesquioxane prepolymer, for example polysilsesquioxane prepolymer. The at least one oligomeric and/or polymeric silanol precursor having hydrolyzable groups can be, for example, a (single) oligomeric or polymeric silanol precursor having hydrolyzable groups, or a combination of two or more identical or different oligomeric and/or polymeric silanol precursors having hydrolyzable groups. The at least one silanol having hydrolyzable groups can be, for example, a (single) silanol having hydrolyzable groups, or a combination of two or more identical or different silanols having hydrolyzable groups.

In a further embodiment of the present invention, the at least one oligomeric and/or polymeric silanol and/or silsesquioxane prepolymer, for example polysilsesquioxane prepolymer, and/or the at least one oligomeric and/or polymeric silanol precursor having hydrolyzable groups, and/or the at least one silanol having hydrolyzable groups, has an organic radical, in particular per silicon atom. The at least one oligomeric and/or polymeric silanol and/or silsesquioxane prepolymer, for example polysilsesquioxane prepolymer, and/or the at least one oligomeric and/or polymeric silanol precursor having hydrolyzable groups, and/or the at least one silanol having hydrolyzable groups, can in particular be easily substituted with an organic radical in particular per silicon atom. As a result of the organic radical, properties of the composite composition and/or of the composite formed therefrom can advantageously be modified, for example the elasticity can be adjusted, and/or microcracks can be prevented, and/or the adhesion can be improved. The organic radical can, for example, have a chain length of ≥1 atom or ≥2 atoms or ≥3 atoms or ≥4 or ≥5 or ≥6 atoms or ≥7 atoms. As a result of the chain length of the organic radical, the elasticity of the composite formed can optionally be adapted and/or for example microcracking can be avoided. For example, the organic radical can comprise or be an alkyl group, for example a methyl, ethyl or propyl group, and/or an aryl group, for example a phenyl group, and/or an alkylene chain, for example a methylene, ethylene or propylene chain, and/or an arylene group, for example a phenylene group and/or at least one functional group, for example an epoxy group and/or amino group and/or mercapto group and/or vinyl group.

According to an example embodiment of the present invention, the at least one oligomeric and/or polymeric silanol and/or silsesquioxane prepolymer, for example polysilsesquioxane prepolymer, and/or the at least one oligomeric and/or polymeric silanol precursor having hydrolyzable groups, and/or the at least one silanol having hydrolyzable groups, can be substituted, for example, in particular per silicon atom, with a (single) organic radical, for example with an alkyl group, for example with a methyl group, or with a (3-glycidyloxypropyl) group or with a 3-mercaptopropyl group, in particular with an alkyl group, for example with a methyl, ethyl or propyl group, for example with a methyl group, or can comprise a combination of two or more classes of silicon atoms, in each case substituted with a different organic radical, for example with a first chain length and/or with a first functional group and with a second chain length and/or with a second functional group.

By means of at least one functional group, i.e., reactive group, for example an epoxy group and/or amino group and/or mercapto group and/or vinyl group, in the organic radical, properties of the composite composition and/or of the composite formed therefrom can optionally also be modified, for example the adhesion of the composite composition and of the composite formed therefrom on certain substrates and optionally also to the at least one filler, for example a bonding of the in particular polymeric network, formed in particular by means of a condensation reaction, to a, for example metallic, substrate and/or optionally also to the at least one filler.

In one form of this embodiment of the present invention, however, the organic radical is an alkyl group. In this case, the organic radical can be, for example, a methyl, ethyl or propyl group, for example a methyl group. Alkylsilanes, such as methyl-, ethyl- or propylsilanes, can advantageously be comparatively easily obtainable and/or inexpensive. In addition, composites can advantageously be formed from composite compositions comprising alkylsilanols, for example methyl-, ethyl- or propylsilanols, in particular methylsilanols, which composites have hydrophobic properties and an associated low water absorption, withstand temperatures of up to 300° C., and have an adhesive strength on copper of about 8 MPa, and/or in particular also have a thermal conductivity of around and above 5 W/(m·K), a coefficient of thermal expansion of 6-10 ppm/K, very good insulation resistances, in particular also in the presence of moisture, and/or can exhibit no silver electromigration between silver conductor tracks. White fillers can advantageously be used to form white, for example snow-white, composites, which can remain color-stable even under temperature loading at temperatures of up to 300° C.

In a specific form of this embodiment of the present invention, the organic radical is a methyl group. This has proven to be particularly advantageous for achieving the above advantages. Advantageously, a methyl group as organic radical appears to intervene in a corrosion process hardly or not at all and/or possibly even to reduce or prevent this, since hydrophobicity can be achieved by means of the methyl group as an organic radical.

In principle, commercially available silsesquioxane formers, such as SLT-3A102 from Gelest, can also be used in the composite composition. However, the exact composition of commercially available silsesquioxane formers is unknown and/or in particular cannot be adjusted. In addition, commercially available silsesquioxane formers are often marketed in the form of aqueous solutions having a high water content, for example ≥70 wt. %, relative to the total weight of the solution.

Within the scope of the present invention, preparation methods explained in more detail below were therefore developed, in particular a preparation method for preparing an oligomeric and/or polymeric silanol and/or silsesquioxane prepolymer, for example polysilsesquioxane prepolymer, a preparation method for preparing an oligomeric and/or polymeric silanol precursor having hydrolyzable groups, and a preparation method for preparing a silanol having hydrolyzable groups, in order to be able to prepare these compounds with a composition that can be adjusted, in particular optimized, for use in a composite composition, and having a water content that is in particular as low as possible. These preparation methods build on one another, in particular step by step. For example, the preparation method for preparing a silanol having hydrolyzable groups can be the first method step of the preparation method for preparing an oligomeric and/or polymeric silanol precursor having hydrolyzable groups, or the first method step of the preparation method for preparing an oligomeric and/or polymeric silanol and/or silsesquioxane prepolymer, for example polysilsesquioxane prepolymer, or the preparation method for preparing an oligomeric and/or polymeric silanol precursor having hydrolyzable groups, the first or second method step of the preparation method for preparing an oligomeric and/or polymeric silanol and/or silsesquioxane prepolymer, for example polysilsesquioxane prepolymer.

The preparation method for preparing a silanol having hydrolyzable groups and thus in particular also the preparation method, based thereon, for preparing an oligomeric and/or polymeric silanol precursor having hydrolyzable groups, or the preparation method, based thereon, for preparing oligomeric and/or polymeric silanol and/or silsesquioxane prepolymer, for example polysilsesquioxane prepolymer, can in particular be based on an, in particular first, hydrolysis, in which at least one silane having three hydrolyzable groups is hydrolyzed, in particular partially, with a substoichiometric, for example half-stoichiometric or less than half-stoichiometric, in particular less than half-stoichiometric, for example up to quarter-stoichiometric amount of substance of water, relative to the amount of substance of the hydrolyzable groups of the at least one silane having three hydrolyzable groups. It is thus advantageously possible to obtain an in particular anhydrous, in particular partially hydrolyzed, in particular monomeric, silanol having hydrolyzable groups. Thus, the water content of the composite composition can advantageously be minimized and/or also the amount of the water eliminated during the curing of the composite composition can be reduced, whereby advantageously in turn a shrinkage of the composite during curing can be reduced, and/or the drying and/or the curing can be accelerated, and/or corrosion can be avoided.

An amount of substance of water that is substoichiometric relative to the amount of substance of the hydrolyzable groups of the at least one silane having three hydrolyzable groups, can be understood to mean in particular an amount of substance of water that is in a ratio of <3.00 to the amount of substance of the at least one silane having three hydrolyzable groups, for example <3.00 water can be used per 1 silane.

An amount of substance of water that is half-stoichiometric relative to the amount of substance of the hydrolyzable groups of the at least one silane having three hydrolyzable groups can be understood to mean in particular an amount of substance of water that is in a ratio of 1.50 to the amount of substance of the at least one silane having three hydrolyzable groups, for example 1.5 water can be used per 1 silane. An amount of substance of water that is less than half-stoichiometric relative to the amount of substance of the hydrolyzable groups of the at least one silane having three hydrolyzable groups, can be understood to mean in particular an amount of substance of water that is in a ratio of <1.50 to the amount of substance of the at least one silane having three hydrolyzable groups, for example <1.5 water can be used per 1 silane.

An amount of substance of water that is quarter-stoichiometric relative to the amount of substance of the hydrolyzable groups of the at least one silane having three hydrolyzable groups can be understood to mean in particular an amount of substance of water that is in a ratio of 0.75 to the amount of substance of the at least one silane having three hydrolyzable groups, for example 0.75 water can be used per 1 silane.

In a further embodiment of the present invention, the at least one oligomeric and/or polymeric silanol and/or silsesquioxane prepolymer, for example polysilsesquioxane prepolymer, and/or the at least one oligomeric and/or polymeric silanol precursor having hydrolyzable groups, and/or the at least one silanol having hydrolyzable groups, is therefore prepared by means of an, in particular first, hydrolysis, for example in the preparation method according to the present invention for preparing a silanol having hydrolyzable groups, from at least one silane having three hydrolyzable groups with an amount of substance of water that is substoichiometric, for example half-stoichiometric or less than half-stoichiometric, in particular less than half-stoichiometric, for example up to quarter-stoichiometric, relative to the amount of substance of the hydrolyzable groups of the at least one silane having three hydrolyzable groups.

By hydrolysis with an amount of substance of water that is substoichiometric relative to the amount of substance of the hydrolyzable groups of the at least one silane having three hydrolyzable groups, at least one, in particular anhydrous, in particular monomeric silanol having hydrolyzable groups can advantageously be prepared, in particular which has on average fewer than three hydroxy groups, for example two or fewer hydroxy groups, relative to the sum of all the silicon atoms of the at least one silanol having alkoxy groups. The anhydrous preparation can advantageously reduce the water content of the composite composition, in particular before curing, and thus the corrosion potential.

By hydrolysis with an amount of substance of water that is half-stoichiometric relative to the amount of substance of the hydrolyzable groups of the at least one silane having three hydrolyzable groups, at least one, in particular anhydrous, in particular monomeric silanol having hydrolyzable groups can advantageously be prepared, in particular which has on average one and a half hydroxy groups and one and a half hydrolyzable groups, relative to the sum of all the silicon atoms of the at least one silanol having hydrolyzable groups. Since such silanols have the same number of hydroxy groups and hydrolyzable groups, and hydroxy groups can condense with hydrolyzable groups, such silanols can advantageously condense completely upon curing, wherein in comparison with slightly substoichiometric hydrolyzed silanols and, in particular completely hydrolyzed, silanol triols, in addition to reducing the water content of the composite composition, in particular before curing, a reduction in the amount of water forming during curing can also be achieved and the corrosion potential can thus be reduced even further.

By hydrolysis with an amount of substance of water that is less than half-stoichiometric relative to the amount of substance of the hydrolyzable groups of the at least one silane having three hydrolyzable groups, at least one, in particular anhydrous, in particular monomeric silanol having hydrolyzable groups can advantageously be prepared, in particular which has on average less than one and a half hydroxy groups and one and a half or more hydrolyzable groups, relative to the sum of all the silicon atoms of the at least one silanol having hydrolyzable groups. By condensation of such silanols, oligomeric and/or polymeric silanol precursors having hydrolyzable groups can advantageously be prepared. In this case, the reaction solvent formed in the first condensation, in particular oligomerization and/or polymerization, can advantageously be removed before use in a composite composition, and thereby the water content of the composite composition and/or in particular the amount of reaction solvent eliminated during curing of the composite composition, for example the amount of alcohol in the case of alkoxy groups, and/or the amount of water, for example in the case of an, in particular second, hydrolysis, can be significantly reduced, and thereby also the curing shrinkage, the drying time, the curing time and the corrosion potential can be significantly reduced. The binder function during curing of the composite composition can be realized via the remaining hydrolyzable groups and/or via hydroxy groups formed in particular by an, in particular second, hydrolysis of the hydrolyzable groups.

The at least one silane having three hydrolyzable groups can have, for example, alkoxy groups and/or halogen atoms, for example chlorine atoms, as hydrolyzable groups. For example, the at least one silane having three hydrolyzable groups can comprise or be at least one trialkoxysilane and/or trihalosilane, for example trichlorosilane. In applications where the corrosion potential is insignificant, for example for casting free forms from the composite composition, the at least one silane having three hydrolyzable groups can have halogen atoms, for example chlorine atoms, as hydrolyzable groups.

In order to reduce the corrosion potential, the at least one silane having three hydrolyzable groups can, however, in particular have alkoxy groups as hydrolyzable groups. For example, the at least one silane having three hydrolyzable groups can have ethoxy groups and/or methoxy groups and/or propoxy groups and/or butoxy groups, in particular ethoxy groups, as hydrolyzable groups. In this case, the at least one silane having three hydrolyzable groups can in particular comprise or be a trialkoxysilane, for example triethoxysilane and/or trimethoxysilane and/or tripropoxysilane and/or tributoxysilane, for example triethoxysilane and/or trimethoxysilane, in particular triethoxysilane. This has proven particularly advantageous in particular for corrosion-sensitive applications, for example for potting electronics and/or electrics.

Furthermore, the at least one silane having three hydrolyzable groups can have an organic radical, in particular per silicon atom. The organic radical can be in the form explained above. For example, the at least one silane having three hydrolyzable groups can comprise or be at least one trialkoxyalkylsilane, for example at least one trimethoxyalkylsilane and/or triethoxyalkylsilane and/or tripropoxyalkylsilane and/or tributoxyalkylsilane, and/or at least one trialkoxyepoxysilane, for example at least one trimethoxyepoxysilane and/or triethoxyepoxysilane and/or tripropoxyepoxysilane and/or tributoxyepoxysilane and/or at least one trialkoxyaminosilane, for example at least one trimethoxyaminosilane and/or triethoxyaminosilane and/or tripropoxyaminosilane and/or tributoxyaminosilane, and/or at least one trialkoxymercaptosilane, for example at least one trimethoxymercaptosilane and/or triethoxymercaptosilane and/or tripropoxymercaptosilane and/or tributoxymercaptosilane, and/or at least one trialkoxyvinylsilane, for example at least one trimethoxyvinylsilane and/or triethoxyvinylsilane and/or tripropoxyvinylsilane and/or tributoxyvinylsilane. In particular, the at least one silane having three hydrolyzable groups can comprise or be at least one trialkoxyalkylsilane, for example at least one triethoxyalkylsilane and/or trimethoxyalkylsilane and/or tripropoxyalkylsilane and/or tributoxyalkylsilane, for example at least one triethoxymethylsilane and/or triethoxyethylsilane and/or triethoxypropylsilane and/or trimethoxymethylsilane and/or trimethoxyethylsilane and/or trimethoxypropylsilane and/or tripropoxymethylsilane and/or tripropoxyethylsilane and/or tripropoxypropylsilane, for example triethoxymethylsilane.

The amount of substance of water can in particular be substoichiometric, for example half-stoichiometric or less than half-stoichiometric, in particular less than half-stoichiometric, for example up to quarter-stoichiometric, relative to the amount of substance of the hydrolyzable groups, in particular in total, of the at least one silane having three hydrolyzable groups.

In a further embodiment of the present invention, the hydrolyzable groups are alkoxy groups, for example ethoxy groups and/or methoxy groups and/or propoxy groups and/or butoxy groups, and/or the at least one oligomeric and/or polymeric silanol precursor having hydrolyzable groups comprises or is at least one oligomeric and/or polymeric silanol precursor having alkoxy groups, for example ethoxy groups and/or methoxy groups and/or propoxy groups and/or butoxy groups, and/or the at least one silanol having hydrolyzable groups comprises or is at least one silanol having alkoxy groups, for example ethoxy groups and/or methoxy groups and/or propoxy groups and/or butoxy groups, and/or the at least one silane having three hydrolyzable groups comprises or is at least one trialkoxysilane, for example at least one triethoxysilane and/or at least one trimethoxysilane and/or at least one tripropoxysilane and/or at least one tributoxysilane. This can be particularly advantageous with regard to process management and handling, and with regard to a reduction, in particular minimization, of the corrosion potential, for example for electronic and/or electrical applications. During the, in particular first, hydrolysis, at least one in particular partially hydrolyzed, for example monomeric silanol having alkoxy groups, for example ethoxy groups and/or methoxy groups and/or propoxy groups and/or butoxy groups, can in particular be formed.

Compounds having alkoxy groups have proven to be advantageous with regard to good processability of the alcohol formed therefrom in the composite composition. During the hydrolysis of alkoxy groups, for example ethoxy groups and/or methoxy groups and/or propoxy groups and/or butoxy groups, for example instead of during the hydrolysis of halogen atoms, in which a hydrogen halide, for example hydrochloric acid, is formed, at least one alcohol, for example ethanol and/or methanol and/or propanol, is advantageously formed, which can have an advantageous effect on process management and handling. For example, in contrast to hydrogen halides, for example hydrochloric acid, measures for adjusting the pH can be omitted—for example there is no need for the addition of a base/alkaline solution and/or of a buffer, and/or safety measures are simplified. In addition, the at least one alcohol, for example ethanol and/or methanol and/or propanol, for example isopropanol and/or n-propanol, and/or butanol, for example tert-butanol and/or sec-butanol and/or isobutanol and/or n-butanol, can hardly interfere with process management and can possibly even have an advantageous effect thereon and on the processability.

In a further embodiment of the present invention, the hydrolyzable groups are ethoxy groups, and/or the at least one oligomeric and/or polymeric silanol precursor having hydrolyzable groups comprises or is at least one oligomeric and/or polymeric silanol precursor having ethoxy groups, and/or the at least one silanol having hydrolyzable groups comprises or is at least one silanol having ethoxy groups, and/or the at least one silane having three hydrolyzable groups comprises or is at least one triethoxysilane. During the, in particular first, hydrolysis, in particular at least one, in particular partially hydrolyzed, for example monomeric, silanol having ethoxy groups can be formed. Compounds having ethoxy groups have proven to be advantageous with regard to low toxicity, good processability of the alcohol formed therefrom in the composite composition and low preparation costs. During the hydrolysis of ethoxy groups, ethanol is advantageously formed, which can have an advantageous effect on process management and handling. For example, measures for adjusting the pH can be omitted, and/or safety measures can be greatly simplified. In addition, ethanol can hardly interfere with process management and can possibly even have an advantageous effect thereon and on processability.

During the, in particular first, hydrolysis of the at least one silane having three hydrolyzable groups with an amount of substance of water that is substoichiometric, for example half-stoichiometric or less than half-stoichiometric, in particular less than half-stoichiometric, for example up to quarter-stoichiometric, relative to the amount of substance of the hydrolyzable groups, for example in the context of the preparation method according to the present invention for preparing a silanol having hydrolyzable groups, in particular the at least one silanol having hydrolyzable groups can be prepared. For example, the, in particular first, hydrolysis or the preparation method according to the present invention for preparing a silanol having hydrolyzable groups can in principle be based on average on the following reaction equation relative to the sum of all the silicon atoms:

$$RSi {( X )}_{3} + x {H}_{2} O \to RSi {( X )}_{3 - x} {( OH )}_{x} + x XH$$

In this case and also in the following explanations, R can in particular stand for a or the organic radical. For example, R can stand for an organic radical having a chain length of ≥1 atom, for example ≥2 atoms or ≥3 atoms or ≥4 or ≥5 or ≥6 atoms or ≥7 atoms. For example, R can comprise or be an alkyl group, for example a methyl, ethyl or propyl group, and/or an alkylene chain, for example a methylene, ethylene or propylene chain, and/or an aryl group, for example a phenyl group, and/or an arylene group, for example a phenylene group, and/or a functional group, i.e., a reactive group, for example an epoxy group and/or amino group and/or mercapto group and/or vinyl group. In particular, R can be an alkyl group, for example a methyl group or ethyl group or propyl group, in particular a methyl group, and/or the at least one silane having three hydrolyzable groups can comprise or be at least one alkylsilane, for example methyl-, ethyl- or propylsilane, in particular methylsilane, and/or the at least one silanol having hydrolyzable groups can comprise or be at least one alkylsilanol having hydrolyzable groups, for example methyl-, ethyl- or propylsilanol, in particular methylsilanol, and/or can be prepared by hydrolysis of at least one alkyl trialkoxysilane, for example a methyl, ethyl and/or propyl trialkoxysilane, for example methyl, ethyl and/or propyl triethoxysilane and/or methyl, ethyl and/or propyl trimethoxysilane and/or methyl, ethyl and/or propyl tripropoxysilane and/or methyl, ethyl and/or propyl tributoxysilane, for example methyl triethoxysilane and/or methyl trimethoxysilane, and/or at least one alkyltrihalosilane, for example at least one alkyl trichlorosilane, for example methyl, ethyl and/or propyl trichlorosilane, for example methyl trichlorosilane.

In this case and also in the following explanations, X can in particular stand for a hydrolyzable group, for example an alkoxy group and/or a halogen atom, for example a chlorine atom. In particular, X can stand for an alkoxy group (OR′), for example an ethoxy group or methoxy group or propoxy group or butoxy group, in particular for an ethoxy group.

In this case and also in the following explanations, x can be in particular <3, in particular wherein x can also be even less than <3, as explained in more detail later. When water is used in an amount of substance that is substoichiometric relative to the amount of substance of the hydrolyzable groups X, x can in particular be <3.

In one embodiment of the present invention, X stands for an alkoxy group (OR′), for example an ethoxy group or methoxy group or propoxy group or butoxy group, and/or the at least one silane having three hydrolyzable groups comprises and/or is at least one trialkoxysilane. During the, in particular first, hydrolysis, at least one silanol having alkoxy groups can be prepared, in particular by hydrolysis of at least one trialkoxysilane with an amount of substance of water that is substoichiometric, for example half-stoichiometric or less than half-stoichiometric, in particular less than half-stoichiometric, for example up to quarter-stoichiometric, relative to the amount of substance of the alkoxy groups of the at least one trialkoxysilane. In this case, the, in particular first, hydrolysis, can be based on average on the following reaction equation relative to the sum of all the silicon atoms:

$${RSi ( {OR}^{′} )}_{3} + x {H}_{2} O \to {RSi ( {OR}^{′} )}_{3 - x} {( OH )}_{x} + x {R}^{′} OH .$$

In this case and also in the following explanations, R′ can for example stand for an alkyl group, for example a methyl group or ethyl group or propyl group or butyl group, in particular a methyl group.

In a specific embodiment of the present invention, X or OR′ stands for an ethoxy group (OEt), and/or the at least one silane having three hydrolyzable groups comprises and/or is at least one triethoxysilane. During the, in particular first, hydrolysis, in particular at least one silanol having ethoxy groups can be prepared, in particular by hydrolysis of at least one triethoxysilane with an amount of substance of water that is substoichiometric, for example half-stoichiometric or less than half-stoichiometric, in particular less than half-stoichiometric, for example up to quarter-stoichiometric, relative to the amount of substance of the ethoxy groups. In this case, the, in particular first, hydrolysis, can be based on average on the following reaction equation relative to the sum of all the silicon atoms:

$${RSi ( OEt )}_{3} + x {H}_{2} O \to {RSi ( OEt )}_{3 - x} {( OH )}_{x} + x EtOH .$$

In particular, the at least one silane having three hydrolyzable groups can comprise or be at least one triethoxysilane, for example at least one alkyl triethoxysilane, for example at least one methyl triethoxysilane and/or at least one ethyl triethoxysilane and/or at least one propyl triethoxysilane, in particular at least one methyl triethoxysilane, and/or the at least one silanol having hydrolyzable groups can comprise or be at least one silanol having ethoxy groups, for example alkylsilanol, for example methyl-, ethyl- or propylsilanol, in particular methylsilanol. This can be particularly advantageous with regard to process management and handling.

The, in particular first, hydrolysis, for example in the context of the preparation method according to the present invention for preparing a silanol having hydrolyzable groups, can in particular be carried out at a temperature of ≥60° C., for example of ≥70° C., in particular at a temperature in a range from ≥60° C., for example from ≥70° C., in particular to <100° C. The reactants can be mixed at such a temperature. The hydrolysis reaction can advantageously be accelerated by a temperature of ≥60° C., for example of ≥70° C. By limiting the temperature to below 100° C., premature condensation reactions can advantageously be avoided.

During the hydrolysis, the hydrolyzable groups of the at least one silane having three hydrolyzable groups can be partially hydrolyzed by the water with formation of hydroxy groups (instead of the hydrolyzable groups) on the silicon atom of the at least one silane. In the case of alkoxy groups as hydrolyzable groups, at least one alcohol can also be formed. As a result of the formation of the hydroxy groups, the in particular partially hydrolyzed, for example monomeric, silanol having hydrolyzable groups that forms in the process can dissolve in the at least one alcohol, which can be observed by means of a change from a two-phase system into a single-phase system. In addition, this advantageously makes it possible to use the in particular partially hydrolyzed, for example monomeric, silanol having alkoxy groups directly in the form of the formed alcoholic solution in the composite composition, wherein in this case the at least one alcohol that forms is preferably also not removed after completion of the, in particular first, hydrolysis.

By means of the, in particular first, hydrolysis, a silanol composition with a high alcohol content can be prepared, for example, in particular if the hydrolyzable groups are alkoxy groups. The silanol composition can advantageously be used both to provide the at least one silanol having hydrolyzable groups, in particular alkoxy groups, in the composite composition according to the present invention and/or as a composite composition additive and as such as casting compound for application on an, in particular metallic and/or ceramic, material, and/or with at least one, in particular ceramic and/or metallic, filler. For example, the silanol composition can be used as such as a casting compound for coating and/or for potting an, in particular metallic and/or ceramic, material, and/or at least one, in particular ceramic and/or metallic, filler. For example, a silanol composition prepared in this way can comprise, relative to the total weight of the silanol composition,
≥30 wt. % to ≤70 wt. % of at least one silanol having hydrolyzable groups, in particular alkoxy groups, for example ethoxy groups, and
≥30 wt. % to ≤70 wt. % of at least one alcohol, for example, in particular in total, of methanol and/or ethanol and/or propanol, for example isopropanol and/or n-propanol, and/or butanol, for example tert-butanol, sec-butanol and/or isobutanol and/or n-butanol, for example ethanol.

The, in particular first, hydrolysis can in particular be carried out in a closed system. It can thus advantageously be ensured that the water required for the reaction remains in the mixture until the reaction thereof. In the case of alkoxy groups as hydrolyzable groups, it can thus advantageously also be ensured that the at least one alcohol that forms remains in the mixture. If the selected temperature is above the boiling point of an alcohol that forms, the closed system can in particular be pressure-resistant and/or designed as an autoclave. After completion of the, in particular first, hydrolysis and, for example, before the beginning of an, in particular second, hydrolysis, which is explained later, preferably no further water is added.

The, in particular first, hydrolysis can take place in particular for a specific period of time. This specific period of time can in particular be dependent on the selected temperature. For example, this specific period of time can be in a range from 0.5 to 4 hours. At a temperature of 70° C., the, in particular first, hydrolysis can be carried out for at least 1 hour, for example. At higher temperatures, the specific period of time can possibly shorten corresponding to the applied temperature.

The, in particular first, hydrolysis can in particular be carried out only in the presence of the at least one silane having three hydrolyzable groups and water. This can thus advantageously be carried out without addition of a catalyst or in a catalyst-free manner and/or without addition of an (additional) organic solvent and/or without addition of a base/alkaline solution and/or without addition of further substances.

The at least one oligomeric and/or polymeric silanol precursor having hydrolyzable groups can be prepared, for example in the context of a preparation method according to the present invention for preparing an oligomeric and/or polymeric silanol precursor having hydrolyzable groups, in particular by means of an, in particular first, condensation of (the) at least one silanol having hydrolyzable groups. In this case, the at least one hydrolyzable silanol can be prepared, in particular by means of an or the, in particular first, hydrolysis, of at least one silane having three hydrolyzable groups, with an amount of substance of water that is substoichiometric, for example half-stoichiometric or less than half-stoichiometric, in particular less than half-stoichiometric, for example up to quarter-stoichiometric, amount of substance, relative to the amount of substance of the hydrolyzable groups of the at least one silane having three hydrolyzable groups, and/or in the context of the preparation method according to the present invention for preparing a silanol having hydrolyzable groups. In this way, an in particular anhydrous, in particular partially condensed, oligomeric and/or polymeric silanol precursor having hydrolyzable groups can advantageously be obtained. Thus, the water content of the composite composition can advantageously be minimized and/or in particular also the amount of the water eliminated during the curing of the composite composition can be reduced, whereby advantageously in turn a shrinkage of the composite during curing can be minimized, and/or the drying and/or the curing can be accelerated, and/or corrosion can be avoided.

The present invention is in particular based on the finding that water is eliminated during a condensation of silanols and is thus produced in situ, as a result of which further hydrolyzable groups can in turn be hydrolyzed, which can then in turn condense. For example, in a condensation of m silanol hydroxy groups, m/2 O-bridged Si units and m/2 water can be produced in situ. As a result of the m/2 water produced in situ, m/2 hydrolyzable groups can be hydrolyzed to form m/2 silanol hydroxy groups, for example with formation of m/2 alcohol (R′OH) and/or hydrogen halide, for example hydrochloric acid (HCl). In a further condensation of the newly produced m/2 silanol-hydroxy groups, m/4 O-bridged Si units and m/4 water can then again additionally form in situ, wherein m/4 hydrolyzable groups can then in turn be hydrolyzed by the m/4 water to form m/4 silanol hydroxy groups, in particular with formation of m/4 alcohol (R′OH) and/or hydrogen halide, for example hydrochloric acid (HCl), and so on and so on. Thus, during the, in particular first, condensation, m/2+m/4+m/8+m/16 etc. water can be produced in situ, which can lead to an additional hydrolysis of m/2+m/4+m/8+m/16 etc. hydrolyzable groups, and in particular to the formation of m/2+m/4+m/8+m/16 etc. O-bridged Si units and in particular to the formation of m/2+m/4+m/8+m/16 etc. alcohol (R′OH) and/or hydrogen halide, for example hydrochloric acid (HCl), which in total, in particular with regard to the very large number of molecules in a reaction, in particular rounded up, corresponds to a temporary in-situ formation of 1 m water, which in turn can lead to a reduction by, in particular rounded up, 1 m hydrolyzable groups and to the formation of, in particular rounded up, 1 m O-bridged Si units and, for example, of, in particular rounded up, 1 m alcohol molecules (R′OH) and/or hydrogen halide molecules, in particular hydrochloric acid molecules (HCl). Thus, as a result of the use of an amount of substance m of water in the, in particular first, hydrolysis and in particular first condensation, a total of 2 m hydrolyzable groups can be hydrolyzed, and 1 m O-bridged Si units can be formed, and for example also 2 m alcohol molecules (R′OH) and/or hydrogen halide molecules, in particular hydrochloric acid molecules (HCl), can be formed. This makes it possible to use water in an amount of substance that is half-stoichiometric or, as explained in more detail later, even less than half-stoichiometric, for example up to quarter-stoichiometric, relative to the amount of substance of the hydrolyzable groups of the at least one silane having three hydrolyzable groups.

During the, in particular first, condensation, in particular the at least one oligomeric and/or polymeric silanol precursor having hydrolyzable groups can be prepared, in particular by condensation of one or the at least one silanol having hydrolyzable groups.

Since, as explained above, the use of an amount of substance (m) of water means that in total twice the amount of substance (2 m) of hydrolyzable groups can be hydrolyzed and condensed by means of hydrolysis and condensation, the, in particular first, condensation or the preparation method according to the present invention for preparing an oligomeric and/or polymeric silanol precursor having hydrolyzable groups can on average be based for example on the following reaction equation, relative to the sum of all the silicon atoms:

$${RSi ( X )}_{3 - x} {( OH )}_{x} \to {[ {RSi ( X )}_{3 - 2 x} {( O )}_{2 x / 2} ]}_{n} + x X H .$$

In such oligomeric and/or polymeric structural formulas, the “(O)” can in particular stand for a bridge-forming or bridging oxygen atom, in particular which connects two silicon atoms.

In this case and also in the following explanations, n can stand in particular for the number of repeat units. In particular, it is possible for n≥2, for example n≥3 or 4 or 5, for example n≥10, optionally n>100.

R and X can in particular be in the form explained above. R can in particular stand for an alkyl group, for example a methyl, ethyl and/or propyl group, in particular a methyl group. The at least one oligomeric and/or polymeric silanol precursor having hydrolyzable groups can comprise or be at least one alkylsilanol precursor having hydrolyzable groups, for example methyl-, ethyl- or propylsilanol precursor, in particular methylsilanol precursor, and/or can be prepared by hydrolysis and condensation of at least one alkyl trialkoxysilane, for example a methyl, ethyl and/or propyl trialkoxysilane, for example methyl, ethyl and/or propyl triethoxysilane and/or methyl, ethyl and/or propyl trimethoxysilane and/or methyl, ethyl and/or propyl tripropoxysilane and/or methyl, ethyl and/or propyl tributoxysilane, for example methyl triethoxysilane and/or methyl trimethoxysilane, and/or at least one alkyl trihalosilane, for example at least one alkyl trichlorosilane, for example methyl, ethyl and/or propyl trichlorosilane, for example methyl trichlorosilane.

In one embodiment of the present invention, X stands for an alkoxy group (OR′), for example an ethoxy group or methoxy group or propoxy group or butoxy group. In this case, during the, in particular first, condensation, in particular an or the at least one oligomeric and/or polymeric silanol precursor having alkoxy groups, can be prepared, in particular by condensation of an or the at least one silanol having alkoxy groups, for example which was prepared by hydrolysis of at least one trialkoxysilane with an amount of substance of water that is substoichiometric, for example half-stoichiometric or less than half-stoichiometric, in particular less than half-stoichiometric, for example up to quarter-stoichiometric, relative to the amount of substance of the alkoxy groups of the at least one trialkoxysilane. In this case, the, in particular first, condensation, can be based on average on the following reaction equation relative to the sum of all the silicon atoms:

$${RSi ( {OR}^{′} )}_{3 - x} {( OH )}_{x} \to {[ {RSi ( {OR}^{′} )}_{3 - 2 x} {( O )}_{2 x / 2} ]}_{n} + x {R}^{′} OH .$$

For example, the at least one oligomeric and/or polymeric silanol precursor having alkoxy groups can comprise or be at least one oligomeric and/or polymeric silanol precursor having ethoxy groups and/or methoxy groups and/or propoxy groups and/or butoxy groups. This can be advantageous with regard to process management and handling.

In a specific embodiment of the present invention, X stands for an ethoxy group (OEt). In this case, during the, in particular first, condensation, in particular an or the at least one oligomeric and/or polymeric silanol precursor having ethoxy groups, can be prepared, in particular by condensation of an or the at least one silanol having ethoxy groups, for example which was prepared by hydrolysis of at least one triethoxysilane with an amount of substance of water that is substoichiometric, for example half-stoichiometric or less than half-stoichiometric, in particular less than half-stoichiometric, for example up to quarter-stoichiometric, relative to the amount of substance of the ethoxy groups of the at least one triethoxysilane. In this case, the, in particular first, condensation, can be based on average on the following reaction equation relative to the sum of all the silicon atoms:

$${RSi ( OEt )}_{3 - x} {( OH )}_{x} \to {[ {RSi ( OEt )}_{3 - 2 x} {( O )}_{2 x / 2} ]}_{n} + x EtOH .$$

For example, the at least one oligomeric and/or polymeric silanol precursor having ethoxy groups can comprise or be at least one alkylsilanol precursor having ethoxy groups, for example methyl-, ethyl- and/or propylsilanol precursor, in particular methylsilanol precursor. This can be particularly advantageous with regard to process management and handling.

The water produced in situ during the condensation reaction was not listed in the above reaction equations, since it reacts directly with hydrolyzable groups still present, as explained above. The above reaction equations illustrate that, after the, in particular first, hydrolysis and the, in particular first, condensation, in particular twice as many (mol) hydrolyzable groups, for example alkoxy groups and/or halogen atoms, for example chlorine atoms, have reacted, and for example twice as much (mol) alcohol (R′OH) and/or hydrogen halide, for example hydrochloric acid (HCl), has been produced as x (mol) of water were initially added. The present invention is therefore based on the finding that water can be used advantageously half-stoichiometrically (x=1.5) and particularly advantageously even less than half-stoichiometrically (x<1.5), as explained below, for example up to quarter-stoichiometrically, in particular relative to the number of the hydrolyzable groups, for example alkoxy groups and/or halogen atoms, for example chlorine atoms, of the at least one silane having three hydrolyzable groups, for example the at least one trialkoxysilane, and/or trihalosilane. In this way, the water content of the composite composition and/or in particular also the amount of water formed during the curing of the composite composition can advantageously be minimized, and thus the shrinkage of the composite composition can also be minimized, and/or the drying and/or curing can be further accelerated, and/or the corrosion potential can be minimized.

In a specific embodiment of the present invention, x can therefore in particular be ≤1.5. When water is used in an amount of substance that is half-stoichiometric (x=1.5) or less than half-stoichiometric (x<1.5) relative to the amount of substance of the hydrolyzable groups X, x can in particular be ≤1.5.

In a further embodiment of the present invention, the at least one silanol having hydrolyzable groups therefore has, relative to the sum of all the silicon atoms of the at least one silanol having hydrolyzable groups, on average one and a half (x=1.5) or fewer (x<1.5) hydroxy groups, in particular fewer than one and a half (x<1.5) hydroxy groups, per silicon atom. In this case, the at least one silanol having hydrolyzable groups can have, relative to the sum of all the silicon atoms of the at least one silanol having hydrolyzable groups, on average, for example, one and a half or more hydrolyzable groups, for example alkoxy groups, for example ethoxy groups, per silicon atom.

The, in particular first, condensation can be carried out, for example, at a temperature from ≥100° C., in particular from ≥110° C., for example from ≥120° C., for example from ≥130° C., for example to ≤250° C., in particular to ≤220° C., for example to ≤200° C., for example to ≤180° C., for example to ≤170° C. In particular, the, in particular first, condensation, for example in the context of the preparation method according to the present invention for preparing a silanol precursor having hydrolyzable groups, can be carried out in particular at a temperature in a range from ≥100° C. to ≤220° C., for example from ≥110° C. to ≤200° C., for example from ≥120° C. to ≤180° C., for example from ≥130° C. to ≤170° C., for example at approximately 150° C. This has proven to be advantageous for the, in particular first, condensation.

The, in particular first, condensation can be carried out, for example, in a closed system, in particular in a closed system equipped with an overpressure outlet. It can thus advantageously be ensured that water formed in situ remains substantially in the system.

The, in particular first, condensation can take place in particular for a specific period of time. This specific period of time can in particular be dependent on the selected temperature. For example, this specific period of time can be in a range from 0.5 to 10 hours. At a temperature of 150° C., the, in particular first, condensation can be carried out, for example, for at least half an hour, for example up to 10 hours, for example for approximately 4 hours. At higher temperatures, the specific period of time can possibly shorten corresponding to the applied temperature.

The, in particular first, condensation can advantageously likewise be carried out without addition of a catalyst or in a catalyst-free manner and/or without addition of an (additional) organic solvent and/or without addition of a base/alkaline solution and/or without addition of further substances.

The present invention is furthermore based on the finding that the amount of water formed during curing of the composite composition and in this way also the shrinkage of the composite composition can be minimized in that at least one oligomeric and/or polymeric silanol precursor and/or at least one oligomeric and/or polymeric silanol is added to the composite composition, which silanol precursor or silanol was substantially already condensed, for example oligomerized and/or polymerized, in particular outside the composite composition, and still has, for example, only a few hydrolyzable groups and/or hydroxy groups. This can be achieved particularly advantageously in that, during the, in particular first, hydrolysis, water is used in an amount of substance that is less than half-stoichiometric relative to the amount of substance of the hydrolyzable groups. Since the at least one silane having three hydrolyzable groups has three hydrolyzable groups, an amount of substance of water that is less than half-stoichiometric relative to the amount of substance of the hydrolyzable groups of the at least one silane having three hydrolyzable groups corresponds to an amount of substance of water that is in a ratio of <1.50 to the amount of substance of the at least one silane having three hydrolyzable groups, for example the at least one trialkoxysilane and/or trihalosilane, for example, it is possible for n(H₂O)/n(RSiX₃)<1.50 or x<1.50.

For example, the at least one oligomeric and/or polymeric silanol and/or silsesquioxane prepolymer, for example polysilsesquioxane prepolymer, and/or the at least one oligomeric and/or polymeric silanol precursor having hydrolyzable groups, and/or the at least one silanol having hydrolyzable groups, can be prepared in that, during the, in particular first, hydrolysis of the at least one silane having three hydrolyzable groups, for example the at least one trialkoxysilane and/or trihalosilane, water is used in an amount of substance that is in a ratio of <1.50, in particular in a ratio in a range of >0.00 to ≤1.50, for example in a range of ≥0.80 to <1.50, for example in a range of ≥0.80 or ≥0.87, in particular ≥0.90, to ≤1.50, in particular ≤1.45, for example ≤1.42 or ≤1.40 or ≤1.35 to the amount of substance of the at least one silane having three hydrolyzable groups, for example the at least one trialkoxysilane and/or trihalosilane. In the reaction equations, it is possible, for example, for x<1.50, in particular 0.00<x<1.50, for example 0.80≤x<1.50, for example 0.80≤ or 0.87≤, in particular 0.90≤, x<1.50, in particular ≤1.45, for example ≤1.42 or ≤1.40 or ≤1.35.

In the context of the present invention, it has been found that the degree of hydrolysis, which can be adjusted by the amount of substance of water used in the, in particular first, hydrolysis, and, for example, also a degree of condensation, dependent thereon, that can be achieved in the, in particular first, condensation, for example a degree of oligomerization and/or polymerization, can have an influence on parameters such as the amount of substances forming during curing, in particular water and/or alcohol, the curing shrinkage, the drying time, the curing time, and the flowability, and that, for example, the mass, in particular the composite composition, can have a lower curing shrinkage and/or greater drying and/or curing acceleration and/or lower corrosion potential, but can also be more viscous, the greater the degree of hydrolysis, in particular in the first hydrolysis, and thus also the greater the degree of condensation, in particular in the first condensation.

Within the scope of the tests carried out, it was found that, although in principle a reduced curing shrinkage and/or accelerated drying and/or curing and/or reduced corrosion potential and a suitable flowability can already be achieved in the range of ≥0.80 to <1.50, this range can be divided into two subranges, specifically into a subrange where x≤1.10 and into a subrange where x>1.10, in order, for example, to focus either on an optimum with respect to the flowability (x≤1.10) or on an optimum with respect to reduced curing shrinkage and/or accelerated drying and/or curing and/or reduced corrosion potential (x>1.10).

In a specific embodiment of the present invention, the at least one oligomeric and/or polymeric silanol and/or silsesquioxane prepolymer, for example polysilsesquioxane prepolymer, and/or the at least one oligomeric and/or polymeric silanol precursor having hydrolyzable groups, and/or the at least one silanol having hydrolyzable groups, is therefore prepared in that, during the, in particular first, hydrolysis of the at least one silane having three hydrolyzable groups, for example the at least one trialkoxysilane and/or trihalosilane, water is used in an amount of substance that is in a ratio in a range of ≥0.80 to ≤1.10, for example in a range of ≥0.80, for example ≥0.87, in particular ≥0.90, to ≤1.10, to the amount of substance of the at least one silane having three hydrolyzable groups, for example the at least one trialkoxysilane and/or trihalosilane. In the reaction equations, it is possible, for example, for 0.80≤x≤1.10, for example 0.87≤x≤1.10, in particular 0.90≤x≤1.10. Composite compositions with a reduced water content and/or reduced amount of water that forms during curing and thus reduced shrinkage during curing, and at the same time particularly advantageous flow properties, for example during application, in particular before curing, can advantageously be realized by means of such amounts of substance or by means of associated degrees of hydrolysis and/or degrees of condensation.

In another specific embodiment of the present invention, however, the at least one oligomeric and/or polymeric silanol and/or silsesquioxane prepolymer, for example polysilsesquioxane prepolymer, and/or the at least one oligomeric and/or polymeric silanol precursor having hydrolyzable groups, and/or the at least one silanol having hydrolyzable groups, is prepared in that, during the, in particular first, hydrolysis of the at least one silane having three hydrolyzable groups, for example the at least one trialkoxysilane and/or trihalosilane, water is used in an amount of substance that is in a ratio in a range of >1.10 to <1.50, for example in a range of ≥1.12, for example ≥1.13 or ≥1.14, for example ≥1.15, to ≤1.50, in particular ≤1.45, for example ≤1.42 or ≤1.40 or ≤1.35 to the amount of substance of the at least one silane having three hydrolyzable groups, for example the at least one trialkoxysilane and/or trihalosilane. In the reaction equations, it is possible, for example, for 1.10<x<1.50, for example 1.12≤, for example 1.13≤ or 1.14≤, for example 1.15≤, x<1.50, in particular ≤1.45, for example ≤1.42 or ≤1.40 or ≤1.35. Composite compositions with an even more reduced water content and/or with an even more reduced amount of water forming during curing and thus with an even more reduced shrinkage during curing can advantageously be realized by means of such amounts of substance or by means of associated degrees of hydrolysis and/or degrees of condensation.

By means of the amounts of substance of water explained above, the at least one silanol having hydrolyzable groups according to the following embodiments can be prepared, for example by means of the, in particular first, hydrolysis, for example in the context of the preparation method according to the present invention for preparing a silanol having hydrolyzable groups, and/or the at least one silanol precursor having hydrolyzable groups according to the following embodiments can be prepared, for example by means of the, in particular first, hydrolysis, and the, in particular first, condensation, for example in the context of the preparation method according to the present invention for preparing an oligomeric and/or polymeric silanol precursor having hydrolyzable groups.

In a further embodiment of the present invention, the at least one silanol having hydrolyzable groups has, relative to the sum of all the silicon atoms, on average >0.00 to <1.50, for example ≥0.80 or ≥0.87, in particular ≥0.90, to <1.50, in particular ≤1.45, for example ≤1.42 or ≤1.40 or ≤1.35, hydroxy groups per silicon atom and/or ≥1.50 to ≤3, for example ≥1.50, in particular ≥1.55, for example ≥1.58 or ≥1.60 or ≥1.65, to <3, for example ≤2.20 or ≤2.13, in particular ≤2.10, hydrolyzable groups, for example alkoxy groups and/or halogen atoms, for example chlorine atoms, for example alkoxy groups, in particular ethoxy groups, per silicon atom.

As already explained, this range can be divided into two subranges, specifically into a subrange where x≤1.10 and into a subrange where x>1.10, in order, for example, to focus either on an optimum with respect to the flowability (x≤1.10) or on an optimum with respect to a reduced curing shrinkage and/or accelerated drying and/or curing and/or reduced corrosion potential (x>1.10).

In a specific form (x≤1.10) of this embodiment of the present invention, the at least one silanol having hydrolyzable groups, for example alkoxy groups and/or halogen atoms, for example chlorine atoms, has, for example, relative to the sum of all the silicon atoms, on average ≥0.80 to ≤1.10, for example ≥0.87 to ≤1.10, in particular ≥0.90 to ≤1.10, hydroxy group per silicon atom and/or ≥1.90 to ≤2.20, for example ≥1.90 to ≤2.13, in particular ≥1.90 to ≤2.10, hydrolyzable groups, for example alkoxy groups and/or halogen atoms, for example chlorine atoms, for example alkoxy groups, in particular ethoxy groups, per silicon atom.

In another specific form (x>1.10) of this embodiment of the present invention, the at least one silanol having hydrolyzable groups has, for example, relative to the sum of all the silicon atoms, on average >1.10 to <1.50, for example from ≥1.12, for example ≥1.13 or ≥1.14, for example ≥1.15, to <1.50, in particular ≤1.45, for example ≤1.42 or ≤1.40 or ≤1.35, hydroxy group per silicon atom and/or ≥1.50 to ≤1.90, for example ≥1.50, in particular ≥1.55, for example ≥1.58 or ≥1.60 or ≥1.65, to ≤1.90, for example ≤1.88, for example ≤1.87 or ≤1.86, for example ≤1.85, hydrolyzable groups, for example alkoxy groups and/or halogen atoms, for example chlorine atoms, for example alkoxy groups, in particular ethoxy groups, per silicon atom.

In a further additional or alternative form of this embodiment of the present invention, the at least one silanol having hydrolyzable groups is based on average on the following general chemical formula, relative to the sum of all the silicon atoms:

RSi(X)₃₋ₓ(OH)ₓ.

R and X can in particular be in the form explained above.

In this case, it is possible, for example, for 0.00<x<1.50, for example 0.80≤x<1.50, for example 0.80≤ or 0.87≤, in particular 0.90≤, x<1.50, in particular ≤1.45, for example ≤1.42 or ≤1.40 or ≤1.35.

In a specific embodiment thereof, the following applies: 0.80≤x≤1.10, for example 0.87≤x≤1.10, in particular 0.90≤x≤1.10.

In another specific embodiment thereof, the following applies: 1.10<x<1.50, for example 1.12≤, for example 1.13≤ or 1.14≤, for example 1.15≤, x<1.50, in particular ≤1.45, for example ≤1.42 or ≤1.40 or ≤1.35.

In a specific form of this embodiment of the present invention, the at least one silanol having hydrolyzable groups comprises or is at least one silanol having alkoxy groups, which on average is based on the chemical formula, relative to the sum of all the silicon atoms:

RSi(OR′)₃₋ₓ(OH)ₓ.

R′ can in particular be in the form explained above.

In a more specific form of this embodiment of the present invention, the at least one silanol having hydrolyzable groups comprises or is at least one silanol having ethoxy groups, which on average is based on the chemical formula, relative to the sum of all the silicon atoms:

RSi(OEt)₃₋ₓ(OH)ₓ

In a further embodiment of the present invention, the at least one oligomeric and/or polymeric silanol precursor having hydrolyzable groups, has, relative to the sum of all the silicon atoms, on average >0.00 to <1.50, for example >0.00, in particular ≥0.10, for example ≥0.16 or ≥0.20 or ≥0.30, to <1.50, in particular ≤1.40, for example ≤1.26, for example ≤1.20, hydrolyzable groups, for example alkoxy groups and/or halogen atoms, for example chlorine atoms, for example alkoxy groups, in particular ethoxy groups, per silicon atom. For example, the at least one oligomeric and/or polymeric silanol precursor having hydrolyzable groups can have, relative to the sum of all the silicon atoms, on average ≥0.10 to ≤1.40, for example ≥0.16 to ≤1.26, for example ≥0.20 to ≤1.20, hydrolyzable groups, for example alkoxy groups and/or halogen atoms, for example chlorine atoms, for example alkoxy groups, in particular ethoxy groups, per silicon atom.

As explained above, this range can be divided into two subranges, specifically into a subrange where x≤1.10 and into a subrange where x>1.10, in order, for example, to focus either on an optimum with respect to the flowability (x≤1.10) or on an optimum with respect to a reduced curing shrinkage and/or accelerated drying and/or curing and/or reduced corrosion potential (x>1.10).

In a specific form (x≤1.10) of this embodiment of the present invention, the at least one oligomeric and/or polymeric silanol precursor having hydrolyzable groups has, relative to the sum of all the silicon atoms, on average ≥0.80 to ≤1.40, for example ≤1.26, in particular ≤1.20, hydrolyzable groups, for example alkoxy groups and/or halogen atoms, for example chlorine atoms, for example alkoxy groups, in particular ethoxy groups, per silicon atom.

In another specific form (x>1.10) of this embodiment of the present invention, the at least one oligomeric and/or polymeric silanol precursor having hydrolyzable groups, for example alkoxy groups and/or halogen atoms, for example chlorine atoms, has, relative to the sum of all the silicon atoms, on average >0.00 to ≤0.80, for example >0.00, in particular ≥0.10, for example ≥0.16 or ≥0.20 or ≥0.30, to <0.80, in particular ≤0.76, for example ≤0.74 or ≤0.72, for example ≤0.70, hydrolyzable groups, for example alkoxy groups and/or halogen atoms, for example chlorine atoms, for example alkoxy groups, in particular ethoxy groups, per silicon atom.

In a further additional or alternative form of this embodiment of the present invention, the at least one oligomeric and/or polymeric silanol precursor having hydrolyzable groups is based on average on the chemical formula, relative to the sum of all the silicon atoms:

[RSi(X)₃₋₂ₓ(O)_{2x/2}]ₙ.

In this case, it is possible, for example, for 0.00<x<1.50, for example 0.80≤x<1.50, for example 0.80≤ or 0.87≤, in particular 0.90≤, x<1.50, in particular ≤1.45, for example ≤1.42 or ≤1.40 or ≤1.35.

In a specific embodiment thereof, the following applies: 0.80≤x≤1.10, for example 0.87≤x≤1.10, in particular 0.90≤x≤1.10.

In another specific embodiment thereof, the following applies: 1.10<x<1.50, for example 1.12≤, for example 1.13≤ or 1.14≤, for example 1.15≤, x<1.50, in particular ≤1.45, for example ≤1.42 or ≤1.40 or ≤1.35.

R, X and n can in particular be in the form explained above.

In a specific form of this embodiment of the present invention, the at least one oligomeric and/or polymeric silanol precursor having hydrolyzable groups comprises or is at least one oligomeric and/or polymeric silanol precursor having alkoxy groups, which on average is based on the following general chemical formula, relative to the sum of all the silicon atoms:

[RSi(OR′)₃₋₂ₓ(O)_{2x/2}]ₙ

R′ can in particular be in the form explained above.

In an even more specific form of this embodiment of the present invention, the at least one oligomeric and/or polymeric silanol precursor having hydrolyzable groups comprises or is at least one oligomeric and/or polymeric silanol precursor having ethoxy groups, which on average is based on the following general chemical formula, relative to the sum of all the silicon atoms:

[RSi(OEt)₃₋₂ₓ(O)_{2x/2}]ₙ

During the curing of the composite composition to form the composite, oligomeric and/or polymeric silanol precursors of this kind or prepared in this way can condense, for example, directly with OH groups, for example on material surfaces, for example of the filler and/or of a substrate, and/or other components of the composite composition and/or hydrolyze and condense indirectly first with water, for example in the form of (residual) moisture in another component of the composite composition, for example in the at least one filler, and/or in the form of a small water admixture, for example with water in an, in particular small, amount of substance, which can be stoichiometric or substoichiometric, in particular up to half-stoichiometric, relative to the hydrolyzable groups, and/or with atmospheric humidity.

In particular, however, the hydrolyzable groups of such oligomeric and/or polymeric silanol precursors having hydrolyzable groups can already be hydrolyzed beforehand, in particular outside the composite composition, for example in an, in particular second, hydrolysis with an (additional), in particular small, amount of substance of water, in particular which can be stoichiometric or substoichiometric, for example up to half-stoichiometric, relative to the (remaining) hydrolyzable groups, to form at least one oligomeric and/or polymeric silanol and/or silsesquioxane prepolymer, for example polysilsesquioxane prepolymer.

The at least one oligomeric and/or polymeric silanol and/or silsesquioxane prepolymer, for example polysilsesquioxane prepolymer, can therefore be prepared in particular by means of an, in particular second, hydrolysis, for example in the context of a preparation method according to the present invention for preparing an oligomeric and/or polymeric silanol and/or silsesquioxane prepolymer, for example polysilsesquioxane prepolymer, from (the) at least one oligomeric and/or polymeric silanol precursor having hydrolyzable groups with an (additional) amount of substance (y) of water that (y) is stoichiometric (y=3-2x) or substoichiometric (y<3-2x), for example up to half-stoichiometric (3-2x)/2 y) relative to the amount of substance of the hydrolyzable groups of the at least one oligomeric and/or polymeric silanol precursor (3-2x). In this way, it is advantageously possible to obtain an, in particular anhydrous, in particular partially hydrolyzed, oligomeric and/or polymeric silanol and/or silsesquioxane prepolymer, for example polysilsesquioxane prepolymer, having hydrolyzable groups. This has proven to be particularly advantageous in the context of the present invention.

For example, the, in particular second, hydrolysis of the at least one silanol precursor having hydrolyzable groups to form the at least one oligomeric and/or polymeric silanol and/or silsesquioxane prepolymer, for example polysilsesquioxane prepolymer, for example in the context of the preparation method according to the present invention for preparing an oligomeric and/or polymeric silanol and/or silsesquioxane prepolymer, for example polysilsesquioxane prepolymer, can on average be based on the following reaction equation, relative to the sum of all the silicon atoms:

$${{{[ {RSi ( X )}_{3 - 2 x} {( O )}_{2 x / 2} ]}_{n} + y {H}_{2} O \to [ RSi ( OH )}_{y} {( X )}_{3 - 2 x - y} {( O )}_{2 x / 2} ]}_{n} + y X H$$

In this case, it is possible, for example, for 0.00<x<1.50, for example 0.80≤x<1.50, for example 0.80≤ or 0.87≤, in particular 0.90≤, x<1.50, in particular ≤1.45, for example ≤1.42 or ≤1.40 or ≤1.35.

In a specific embodiment thereof, the following applies: 0.80≤x≤1.10, for example 0.87≤x≤1.10, in particular 0.90≤x≤1.10.

In another specific embodiment thereof, the following applies: 1.10<x<1.50, for example 1.12≤, for example 1.13≤ or 1.14≤, for example 1.15≤, x<1.50, in particular ≤1.45, for example ≤1.42 or ≤1.40 or ≤1.35.

R, X and n can in particular be in the form explained above. R can in particular stand for an alkyl group, for example a methyl, ethyl or propyl group, in particular a methyl group. The at least one oligomeric and/or polymeric silanol and/or silsesquioxane prepolymer can comprise or be, for example, at least one oligomeric and/or polymeric alkylsilanol and/or alkyl silsesquioxane prepolymer, for example polyalkyl silsesquioxane prepolymer, for example methyl-, ethyl-, and/or propylsilanol, and/or methyl, ethyl, and/or propyl silsesquioxane prepolymer, for example polymethyl, polyethyl and/or polypropyl silsesquioxane prepolymer, in particular methylsilanol and/or methyl silsesquioxane prepolymer, for example polymethyl silsesquioxane prepolymer.

In one embodiment of the present invention in which X stands for an alkoxy group (OR′), for example an ethoxy group or methoxy group or propoxy group or butoxy group, the at least one oligomeric and/or polymeric silanol and/or silsesquioxane prepolymer, for example polysilsesquioxane prepolymer, can be prepared by the, in particular second, hydrolysis of at least one silanol precursor having alkoxy groups. In this case, the, in particular second, hydrolysis can for example be based on average on the following reaction equation relative to the sum of all the silicon atoms:

$${[ {RSi ( {OR}^{′} )}_{3 - 2 x} {( O )}_{2 x / 2} ]}_{n} + y {H}_{2} O \to {[ {RSi ( OH )}_{y} {( {OR}^{′} )}_{3 - 2 x - y} {( O )}_{2 x / 2} ]}_{n} + y {R}^{′} OH$$

R′ can in particular be in the form explained above.

In a specific embodiment of the present invention in which X stands for an ethoxy group (OEt), the at least one oligomeric and/or polymeric silanol and/or silsesquioxane prepolymer, for example polysilsesquioxane prepolymer, can be prepared by the, in particular second, hydrolysis, of at least one silanol precursor having ethoxy groups. In this case, the, in particular second, hydrolysis can be based for example on the following reaction equation, relative to the sum of all the silicon atoms:

$${[ RSi ( {{OEt}_{3 - 2 x} ( O )}_{2 x / 2} ]}_{n} + y {H}_{2} O \to {[ {RSi ( OH )}_{y} {( OEt )}_{3 - 2 x - y} {( O )}_{2 x / 2} ]}_{n} + y EtOH$$

y can in particular be ≤3-2x, i.e., stoichiometric (y=3-2x) or substoichiometric (y<3-2x) relative to the hydrolyzable groups.

Since, on the one hand, a condensation reaction of hydroxy groups with hydrolyzable groups, for example with alkoxy groups (OR′), for example ethoxy, methoxy, propoxy or butoxy groups, for example with elimination of an alcohol, and/or with halogen atoms, for example chlorine atoms (Cl), in particular with elimination of a hydrogen halide, for example hydrochloric acid (HCl), is also possible and, on the other hand, as explained above in the context of the, in particular first, condensation, only half as much, i.e., m/2 (mol), water is required in a combined hydrolysis and condensation for the hydrolysis of m (mol), here 3-2x, hydrolyzable groups, the at least one oligomeric and/or polymeric silanol precursor having hydrolyzable groups can possibly also be reacted with an amount of substance of water that is up to half-stoichiometric ((3-2x)/2≤y) relative to the amount of substance of the hydrolyzable groups of the at least one oligomeric and/or polymeric silanol precursor having hydrolyzable groups in the, in particular second, hydrolysis. In particular, it is thus possible for (3-2x)/2≤y≤3-2x, i.e., greater than or equal to half-stoichiometric up to stoichiometric relative to the hydrolyzable groups.

As a result of (3-2x)/2≤y, the water content of the composite composition and the amount of water produced during curing of the composite composition to form the composite can advantageously be reduced further, and thus the corrosion potential can minimized further, and/or the curing can be accelerated further. If y=(3-2x)/2, the, in particular second, hydrolysis of the at least one silanol precursor having hydrolyzable groups to form the at least one oligomeric and/or polymeric silanol and/or silsesquioxane prepolymer, for example polysilsesquioxane prepolymer, can on average be based for example on the following reaction equation, relative to the sum of all the silicon atoms:
[RSi(X)₃₋₂ₓ(O)_{2x/2}]ₙ+(3-2x)/2H₂O→[RSi(OH_{(3-2x)/2} (X)_{(3-2x)/2}(O)_{2x/2}]ₙ+(3-2x)/2 XH, for example
[RSi(OR′)₃₋₂ₓ(O)_{2x/2}]ₙ+(3-2x)/2H₂O→[RSi(OH)_{(3-2x)/2} (OR′)_{(3-2x)/2}(O)_{2x/2}]ₙ+(3-2x)/2 R′ OH, for example
[RSi(OEt)₃₋₂ₓ(O)_{2x/2}]ₙ+(3-2x)/2H₂O→[RSi(OH)_{(3-2x)/2} (OEt)_{(3-2x)/2}(O)_{2x/2}]ₙ+(3-2x)/2 EtOH.

As a result of y=3-2x, all the hydrolyzable groups (X) can advantageously be hydrolyzed during the, in particular second, hydrolysis. This has proven to be particularly advantageous since hydroxy groups can have a higher condensation reactivity than hydrolyzable groups. If y=3-2x, the, in particular second, hydrolysis of the at least one silanol precursor having hydrolyzable groups to form the at least one oligomeric and/or polymeric silanol and/or silsesquioxane prepolymer, for example polysilsesquioxane prepolymer, can on average be based for example on the following reaction equation, relative to the sum of all the silicon atoms:
[RSi(X)₃₋₂ₓ(O)_{2x/2}]ₙ+3-2x H₂O→[RSi(OH)₃₋₂ₓ(O)_{2x/2}]ₙ+3-2x XH, for example
[RSi(OR′)₃₋₂ₓ(O)_{2x/2}]ₙ+3-2x H₂O→[RSi(OH)₃₋₂ₓ(O)_{2x/2}]ₙ+3-2x R′OH, for example
[RSi(OEt)₃₋₂ₓ(O)_{2x/2}]ₙ+3-2x H₂O→[RSi(OH)₃₋₂ₓ(O)_{2x/2}]ₙ+3-2x EtOH.

The, in particular second, hydrolysis, for example in the context of the preparation method according to the present invention for preparing an oligomeric and/or polymeric silanol and/or silsesquioxane prepolymer, for example polysilsesquioxane prepolymer, can be carried out for example at a temperature of ≥60° C., for example of ≥70° C., in particular at a temperature in a range from ≥60° C., for example from ≥70° C., in particular to <100° C. In this case, (only) the at least one oligomeric and/or polymeric silanol precursor having hydrolyzable groups and water can be mixed at such a temperature. The hydrolysis reaction can advantageously be accelerated by a temperature of ≥60° C., for example of ≥70° C. By limiting the temperature to below 100° C., premature condensation reactions can advantageously be avoided.

During the hydrolysis, the hydrolyzable groups of the at least one oligomeric and/or polymeric silanol precursor can be hydrolyzed partially or completely, for example completely, with formation of hydroxy groups instead of the hydrolyzable groups on the silicon atom of the at least one oligomeric and/or polymeric silanol precursor having hydrolyzable groups, wherein at least one alcohol is also formed in the case of alkoxy groups as hydrolyzable groups. As a result of the formation of the hydroxy groups, the oligomeric and/or polymeric silanol and/or silsesquioxane prepolymer, for example polysilsesquioxane prepolymer, formed in the process can dissolve in the at least one alcohol that forms in the case of alkoxy groups as hydrolyzable groups, which can be observed by a change from a two-phase system into a single-phase system and additionally advantageously allows the oligomeric and/or polymeric silanol to be used directly in the form of the formed alcoholic solution in the composite composition.

The, in particular second, hydrolysis can be carried out, for example, in a closed system or possibly in a closed system with an overpressure outlet. If the selected temperature is above the boiling point of an alcohol that forms, the system can in particular be a pressure-resistant, closed system and/or an autoclave. After completion of the, in particular second, hydrolysis and, for example, before the beginning of an, in particular second, condensation, which is explained later, for example in the context of curing the composite composition, preferably no further water is added.

The, in particular second, hydrolysis can take place in particular for a specific period of time. This specific period of time can in particular be dependent on the selected temperature. For example, this specific period of time can be in a range of 10 to 30 hours. At a temperature of 70° C., the, in particular second, hydrolysis can be carried out, for example, for at least 10 hours, for example up to 30 hours, for example for approximately 24 hours. At higher temperatures, the specific period of time can possibly shorten corresponding to the applied temperature.

The, in particular second, hydrolysis can in particular be carried out only in the presence of the at least one oligomeric and/or polymeric silanol precursor having hydrolyzable groups and water. This can thus advantageously be carried out without addition of a catalyst or in a catalyst-free manner and/or without addition of an (additional) organic solvent and/or without addition of a base/alkaline solution and/or without addition of further substances.

By means of the, in particular second, hydrolysis, in particular if the hydrolyzable groups are alkoxy groups, an oligomeric and/or polymeric silanol composition with a low to moderate alcohol content can be prepared for example, which composition can advantageously be used both for providing the at least one oligomeric and/or polymeric silanol and/or silsesquioxane prepolymer, for example polysilsesquioxane prepolymer, in the composite composition according to the present invention and/or as a composite composition additive and as such as a casting compound for application on an, in particular metallic and/or ceramic, material, and/or with at least one, in particular ceramic and/or metallic, filler. For example, the oligomeric and/or polymeric silanol composition can be used as such as a casting compound for coating and/or for potting an, in particular metallic and/or ceramic, material, and/or at least one, in particular ceramic and/or metallic, filler. For example, an oligomeric and/or polymeric silanol composition prepared in this way can comprise, relative to the total weight of the silanol composition,
≥50 wt. % to ≤95 wt. %, in particular ≥60 wt. % to ≤95 wt. %, of at least one oligomeric and/or polymeric silanol and/or silsesquioxane prepolymer, for example polysilsesquioxane prepolymer, and
≥5 wt. % to ≤50 wt. %, in particular ≥5 wt. % to ≤40 wt. %, of at least one alcohol, for example in particular in total, of methanol and/or ethanol and/or propanol, for example isopropanol and/or n-propanol, and/or butanol, for example tert-butanol sec-butanol and/or isobutanol and/or n-butanol.

Using the amount of substance (x) of water mentioned within the scope of the, in particular first, hydrolysis and condensation, the at least one oligomeric and/or polymeric silanol and/or silsesquioxane prepolymer, for example polysilsesquioxane prepolymer, according to the following embodiment can be prepared, for example by means of the, in particular second, hydrolysis.

In a further embodiment of the present invention, in particular based on (3-2x)/2≤y≤3-2x, the at least one oligomeric and/or polymeric silanol and/or silsesquioxane prepolymer, for example polysilsesquioxane prepolymer, has, relative to the sum of all the silicon atoms, on average >0.00 to <1.50, for example >0.00, in particular ≥0.10, for example ≥0.16 or ≥0.20 or ≥0.30, to <1.50, in particular ≤1.40, for example ≤1.26, for example ≤1.20, hydroxy groups and/or hydrolyzable groups, for example alkoxy groups and/or halogen atoms, for example chlorine atoms, for example alkoxy groups, in particular in total, per silicon atom. For example, the at least one oligomeric and/or polymeric silanol and/or silsesquioxane prepolymer, for example polysilsesquioxane prepolymer, can have, relative to the sum of all the silicon atoms, on average ≥0.10 to ≤1.40, for example ≥0.16 to ≤1.26, for example ≥0.20, to ≤1.20, hydroxy groups and/or hydrolyzable groups, for example alkoxy groups and/or halogen atoms, for example chlorine atoms, for example alkoxy groups, in particular in total, per silicon atom. At most half, for example less than half, possibly none, can be hydrolyzable groups, for example alkoxy groups and/or halogen atoms, for example chlorine atoms, for example alkoxy groups, in particular ethoxy groups, and at least half, for example more than half, possibly all, can be hydroxy groups. In other words, the oligomeric and/or polymeric silanol and/or silsesquioxane prepolymer can have, relative to the sum of all the silicon atoms, on average ≥0.00 to ≤0.70, for example ≥0.00 to ≤0.60, hydrolyzable groups, for example alkoxy groups and/or halogen atoms, for example chlorine atoms, for example alkoxy groups, in particular ethoxy groups, per silicon atom.

In one form of this embodiment of the present invention, in particular based on y=3-2x, the at least one oligomeric and/or polymeric silanol and/or silsesquioxane prepolymer, has, relative to the sum of all the silicon atoms, on average >0.00 to ≤1.50, for example >0.00, in particular ≥0.10, for example ≥0.16 or ≥0.20 or ≥0.30, to <1.50, in particular ≤1.40, for example ≤1.26, for example ≤1.20, hydroxy groups per silicon atom. For example, the at least one oligomeric and/or polymeric silanol and/or silsesquioxane prepolymer can have, relative to the sum of all the silicon atoms, on average ≥0.10 to ≤1.40, for example ≥0.16 to ≤1.26, for example ≥0.20, to ≤1.20, hydroxy groups per silicon atom. The at least one oligomeric and/or polymeric silanol and/or silsesquioxane prepolymer can in particular be substantially free of hydrolyzable groups, for example alkoxy groups and/or halogen atoms, for example chlorine atoms, for example alkoxy groups, in particular ethoxy groups, per silicon atom.

As explained above, this range can be divided into two subranges, specifically into a subrange where y=3-2x and x≤1.10 and into a subrange where y=3-2x and x>1.10, in order, for example, to focus either on an optimum with regard to flowability (y=3-2x and x≤1.10) or on an optimum with regard to reduced curing shrinkage and/or accelerated drying and/or curing and/or reduced corrosion potential (y=3-2x and x>1.10).

In a specific form (y=3-2x and x≤1.10) of this embodiment of the present invention, the at least one oligomeric and/or polymeric silanol and/or silsesquioxane prepolymer has, relative to the sum of all the silicon atoms, on average ≥0.80 to ≤1.40, for example ≤1.26, in particular ≤1.20, hydroxy groups per silicon atom.

In another specific form (y=3-2x and x>1.10) of this embodiment of the present invention, the at least one oligomeric and/or polymeric silanol and/or silsesquioxane prepolymer has, relative to the sum of all the silicon atoms, on average >0.00 to <0.80, for example >0.00, in particular ≥0.10, for example ≥0.16 or ≥0.20 or ≥0.30, to <0.80, in particular ≤0.76, for example ≤0.74 or ≤0.72, for example ≤0.70, hydroxy groups per silicon atom.

In a further, additional or alternative form of this embodiment of the present invention, the at least one oligomeric and/or polymeric silanol and/or silsesquioxane prepolymer comprises or is at least one oligomeric and/or polymeric silanol and/or silsesquioxane prepolymer, for example polysilsesquioxane prepolymer, which optionally has hydrolyzable groups, for example alkoxy groups and/or halogen atoms, for example chlorine atoms, for example alkoxy groups, in particular ethoxy groups, and is based, in particular on average relative to the sum of all the silicon atoms, on the chemical formula:
[RSi(OH)_{y}(X)_{3-2x-y}(O)_{2x/2}]ₙ, for example
[RSi(OH)_{y}(OR′)_{3-2x-y}(O)_{2x/2}]ₙ, for example
[RSi(OH)_{y}(OEt)_{3-2x-y}(O)_{2x/2}]ₙ.

R, X, n and R′ can in particular be in the form explained above.

In particular, R can stand for an alkyl group, for example a methyl, ethyl or propyl group, for example a methyl group. The at least one oligomeric and/or polymeric silanol and/or silsesquioxane prepolymer, for example polysilsesquioxane prepolymer, can comprise or be in particular at least one oligomeric and/or polymeric alkylsilanol and/or alkyl silsesquioxane prepolymer, for example alkyl polysilsesquioxane prepolymer, for example methyl-, ethyl-, and/or propylsilanol, and/or methyl, ethyl, and/or propyl silsesquioxane prepolymer, for example methyl, ethyl, and/or propyl polysilsesquioxane prepolymer, for example methylsilanol and/or methyl silsesquioxane prepolymer, for example methyl polysilsesquioxane prepolymer, and/or can be prepared by hydrolysis of at least one alkylsilanol precursor having hydrolyzable groups, for example methyl-, ethyl- and/or propylsilanol precursor, for example methylsilanol precursor.

y can in particular be ≤3-2x, i.e., stoichiometric or substoichiometric relative to the hydrolyzable groups. In particular, it is possible for (3-2x)/2≤y≤3-2x, i.e., greater than or equal to half-stoichiometric up to stoichiometric relative to the hydrolyzable groups.

In this case, it is possible, for example, for 0.00<x<1.50, for example 0.80≤x<1.50, for example 0.80≤ or 0.87≤, in particular 0.90≤, x<1.50, in particular ≤1.45, for example ≤1.42 or ≤1.40 or ≤1.35.

In a specific embodiment thereof, the following applies: 0.80≤x≤1.10, for example 0.87≤x≤1.10, in particular 0.90≤x≤1.10.

In another specific embodiment thereof, the following applies: 1.10<x<1.50, for example 1.12≤, for example 1.13≤ or 1.14≤, for example 1.15≤, x<1.50, in particular ≤1.45, for example ≤1.42 or ≤1.40 or ≤1.35.

In a further specific form of this embodiment of the present invention, in particular based on y=3-2x, the at least one oligomeric and/or polymeric silanol and/or silsesquioxane prepolymer, for example polysilsesquioxane prepolymer, comprises or is at least one oligomeric and/or polymeric silanol and/or silsesquioxane prepolymer, for example which is based on average on the following general chemical formula, relative to the sum of all the silicon atoms:

[RSi(OH)₃₋₂ₓ(O)_{2x/2}]ₙ

This has proven to be particularly advantageous since hydroxy groups can have a higher condensation reactivity than hydrolyzable groups. R and n can in particular be in the form explained above. The at least one oligomeric and/or polymeric silanol and/or silsesquioxane prepolymer, for example polysilsesquioxane prepolymer, can be in particular free of hydrolyzable groups and/or alkoxy groups and/or halogen atoms and/or ethoxy groups.

In a further specific form of this embodiment of the present invention, in particular based on y=(3-2x)/2, the at least one oligomeric and/or polymeric silanol and/or silsesquioxane prepolymer, for example silsesquioxane prepolymer, comprises or is at least one oligomeric and/or polymeric silanol and/or silsesquioxane prepolymer, for example polysilsesquioxane prepolymer, which is based on average, for example, on the following general chemical formula, relative to the sum of all the silicon atoms:
[RSi(OH_{(3-2x)/2} (X)_{(3-2x)/2}(O)_{2x/2}]ₙ, for example
[RSi(OH_{(3-2x)/2}(OR′)_{(3-2x)/2}(O)_{2x/2}]ₙ, for example
[RSi(OH_{(3-2x)/2}(OEt)_{(3-2x)/2}(O)_{2x/2}]ₙ.

The amount of water that forms during curing can thus advantageously be reduced further. R, X, n, R′ and x can in particular be in the form explained above. The at least one oligomeric and/or polymeric silanol and/or silsesquioxane prepolymer, for example silsesquioxane prepolymer, can still have a small proportion of hydrolyzable groups, for example alkoxy groups and/or halogen atoms, for example chlorine atoms, for example alkoxy groups, in particular ethoxy groups.

The at least one oligomeric and/or polymeric silanol and/or silsesquioxane prepolymer, for example silsesquioxane prepolymer, can condense to form at least one silsesquioxane, for example polysilsesquioxane, in an, in particular second, condensation, for example during curing of the composite composition to form the composite, for example in the context of the method according to the present invention for preparing a composite and/or silsesquioxane. For example, this can be based on average on the following reaction equation, relative to the sum of all the silicon atoms:
[RSi(OH)_{y}(X)_{3-2x-y}(O)_{2x/2}]ₙ→[RSi(O)_{1,5}]ₙ+y−(3-2x)/2H₂O+3-2x-y XH, for example
[RSi(OH)_{y}(OR′)_{3-2x-y}(O)_{2x/2}]ₙ→[RSi(O)_{1,5}]_{n′}+y−(3-2x)/2H₂O+3-2x-y R′OH, for example
[RSi(OH)_{y}(OEt)_{3-2x-y}(O)_{2x/2}]ₙ→[RSi(O)_{1,5}]_{n′}+y−(3-2x)/2H₂O+3-2x-y EtOH.

R, X, n, R′, x and y can in particular be in the form explained above. n′ can in particular stand for the number of repeat units and in particular be greater than n.

As a result of (3-2x)/2 y, the water content of the composite composition and the amount of water produced during curing of the composite composition to form the composite can advantageously be reduced further, and thus the corrosion potential can minimized further, and/or the curing can be accelerated further. If y=(3-2x)/2, the, in particular second, condensation of the at least one oligomeric and/or polymeric silanol and/or silsesquioxane prepolymer, for example polysilsesquioxane prepolymer, can on average be based for example on the following reaction equation, relative to the sum of all the silicon atoms:
[RSi(OH)_{(3-2x)/2} (X)_{(3-2x)/2}(O)_{2x/2}]ₙ→[RSi(O)_{1,5}]_{n′}+(3-2x)/2 XH, for example
[RSi(OH_{(3-2x)/2} (OR′)_{(3-2x)/2}(O)_{2x/2}]ₙ[RSi(O)_{1,5}]_{n′}+(3-2x)/2 R′ OH, for example
[RSi(OH_{(3-2x)/2} (OEt) (3-2x)/2(O)_{2x/2}]ₙ→[RSi(O)_{1,5}]_{n′}+(3-2x)/2 EtOH.

As a result of y=3-2x, the, in particular second, condensation can advantageously be carried out in a particularly simple and reliable manner, for example in an open system. If y=3-2x, the, in particular second, condensation of the at least one oligomeric and/or polymeric silanol and/or silsesquioxane prepolymer, for example polysilsesquioxane prepolymer, can on average be based for example on the following reaction equation, relative to the sum of all the silicon atoms:

$${[ {RSi ( OH )}_{3 - 2 x} {( O )}_{2 x / 2} ]}_{n} \to {[ {RSi ( O )}_{1 , 5} ]}_{{n}^{′}} + ( 3 - 2 x ) / 2 {H}_{2} O$$

During the, in particular second, condensation or during curing of the composite composition to form the composite, for example in the context of the method according to the present invention for preparing a composite and/or silsesquioxane, in particular at least one alkyl silsesquioxane, for example alkyl polysilsesquioxane, in particular having the general chemical formula [RSi(O)_{1,5}]_{n′}, can be formed, wherein R stands for an alkyl group. For example, at least one methyl, ethyl, and/or propyl silsesquioxane, for example methyl, ethyl, and/or propyl polysilsesquioxane, in particular having the general chemical formula [RSi(O)_{1,5}]_{n′}, can be formed, wherein R stands for a methyl, ethyl, and/or propyl group. For example, a methyl silsesquioxane, for example methyl polysilsesquioxane, in particular having the general chemical formula [MeSi(O)_{1,5}]_{n′}, can be formed.

The, in particular second, condensation or the curing of the composite composition to form the composite, for example in the context of the preparation method according to the present invention for preparing a composite and/or silsesquioxane, can be carried out, for example, at a temperature from ≥100° C., in particular from ≥110° C., for example from ≥120° C., for example from ≥130° C., for example to ≤250° C., in particular to ≤220° C., for example to ≤200° C., for example to ≤180° C., for example to ≤170° C. In particular, the, in particular second, condensation or the curing of the composite composition to form the composite can be carried out at a temperature in a range from ≥100° C. to ≤220° C., for example from ≥110° C. to ≤200° C., for example from ≥120° C. to ≤180° C., for example ≥130° C. to ≤170° C., for example at approximately 150° C. This has proven to be advantageous for the, in particular second, condensation or for curing the composite composition to form the composite.

The, in particular second, condensation or curing of the composite composition to form the composite can be carried out, for example, in an open system. Process management can advantageously be simplified by an open system.

The, in particular second, condensation or the curing of the composite composition to form the composite can in particular take place for a specific period of time. This specific period of time can in particular be dependent on the selected temperature. For example, this specific period of time can be in a range from 0.5 to 16 hours, in particular to 10 hours. At a temperature of 150° C., the, in particular second, condensation or the curing of the composite composition to form the composite can, for example, be carried out for at least half an hour, preferably at least 5 hours, in particular up to 16 hours, for example up to 10 hours, for example for approximately 5 hours. At higher temperatures, the specific period of time can possibly shorten corresponding to the applied temperature.

The, in particular second, condensation or the curing of the composite composition to form the composite can advantageously likewise be carried out without addition of a catalyst or in a catalyst-free manner and/or without addition of an (additional) organic solvent and/or without addition of a base/alkaline solution and/or without addition of further substances.

In a further embodiment of the present invention, the at least one oligomeric and/or polymeric silanol and/or silsesquioxane prepolymer, for example polysilsesquioxane prepolymer, is an oligomeric and/or polymeric silanol and/or silsesquioxane prepolymer, for example polysilsesquioxane prepolymer, prepared by a preparation method according to the present invention and/or an oligomeric and/or polymeric silanol and/or silsesquioxane prepolymer, for example polysilsesquioxane prepolymer, according to the present invention.

In a further, alternative or additional embodiment of the present invention, the at least one oligomeric and/or polymeric silanol precursor having hydrolyzable groups is an oligomeric and/or polymeric silanol precursor having hydrolyzable groups prepared by a preparation method according to the present invention and/or an oligomeric and/or polymeric silanol precursor according to the present invention having hydrolyzable groups.

In a further, alternative or additional embodiment of the present invention, the at least one silanol having hydrolyzable groups is a silanol having hydrolyzable groups prepared by a preparation method according to the present invention and/or a silanol according to the present invention having hydrolyzable groups.

In a further, alternative or additional embodiment of the present invention, the composite composition is prepared by a method according to the present invention.

In the case of the direct and sole use of at least one oligomeric and/or polymeric silanol precursor having hydrolyzable groups in the composite composition, the composite composition can possibly contain a specific small amount of substance of water, for example which can be stoichiometric to half-stoichiometric, relative to the amount of substance of the hydrolyzable groups of the at least one oligomeric and/or polymeric silanol precursor having hydrolyzable groups. This can be provided partially in the form of (residual) moisture in the at least one filler and/or other components of the composite composition and/or in the form of atmospheric humidity.

In order to reduce, in particular minimize, shrinkage during curing of the composite composition in the case of direct use of at least one oligomeric and/or polymeric silanol precursor having hydrolyzable groups in the composite composition, it can in particular be advantageous to use the at least one oligomeric and/or polymeric silanol precursor having hydrolyzable groups in combination with at least one at least one oligomeric and/or polymeric silanol and/or silsesquioxane prepolymer, for example polysilsesquioxane prepolymer, and/or with at least one silanol having hydrolyzable groups, in particular with at least one oligomeric and/or polymeric silanol and/or silsesquioxane prepolymer, for example polysilsesquioxane prepolymer, in the composite composition. This can take place in particular in such a way that the sum of the amount of substance of the hydroxy groups of the at least one oligomeric and/or polymeric silanol and/or silsesquioxane prepolymer, for example polysilsesquioxane prepolymer, and/or of the at least one silanol having hydrolyzable groups, in particular of the at least one oligomeric and/or polymeric silanol and/or silsesquioxane prepolymer, for example polysilsesquioxane prepolymer, is greater than or equal to the sum of the amount of substance of the hydrolyzable groups of the at least one oligomeric and/or polymeric silanol precursor having hydrolyzable groups and/or of the at least one silanol having hydrolyzable groups in the composite composition. Thus, a complete condensation of the hydrolyzable groups of the at least one oligomeric and/or polymeric silanol precursor can advantageously be achieved, in particular even in an at least substantially anhydrous composite composition, for example with a water content of <0.1 wt. %, for example <0.01 wt. %, relative to the total weight of the composite composition.

In the context of the present invention, the lowest possible water content has proven to be particularly advantageous. On the one hand, this is because, due to the lowest possible water content of the composite composition, the shrinkage thereof during curing can advantageously be minimized and the drying and curing thereof can be realized more quickly and more energy-efficiently. On the other hand, the action time of the water during which substrates to be equipped, for example electronics and/or electrics, for example power electronics, which can possibly be water-sensitive, are in contact, can thus be minimized and thereby the substrate to be equipped can be protected and/or corrosion can be avoided.

If at least one oligomeric and/or polymeric silanol and/or silsesquioxane prepolymer, for example polysilsesquioxane prepolymer, and/or at least one silanol having hydrolyzable groups are used, the composite composition can advantageously be at least substantially anhydrous.

In a specific embodiment of the present invention, the composite composition therefore has, relative to the total weight of the composite composition, only <0.1 wt. %, for example <0.01 wt. %, of water. The shrinkage during curing of the composite composition can thus advantageously be reduced further, in particular minimized, and its drying and curing can be realized more quickly and more energy-efficiently, and/or the corrosion potential thereof can be reduced.

Since oligomeric and/or polymeric silanols and/or silsesquioxane prepolymers, for example polysilsesquioxane prepolymers, can also condense completely in the absence of water and other compounds, and additionally are already oligomerized and/or polymerized, in particular before addition to the composite composition, as a result of which the amount of water forming during curing of the composite composition, and thereby also the shrinkage and/or the corrosion potential, is significantly reduced, in particular minimized, and/or also the drying and/or curing can be made much faster and more energy-efficient, the composite composition comprises, in a specific embodiment (only) at least one oligomeric and/or polymeric, silanol and/or silsesquioxane prepolymer, for example polysilsesquioxane prepolymer, in particular at least polymeric silanol and/or silsesquioxane prepolymer, for example polysilsesquioxane prepolymer.

The at least one filler can in principle be a (single) filler or a combination of two or more fillers. As explained above, the at least one filler can in particular have a surface having OH groups. Ceramic and/or metallic fillers generally have at least a small proportion of OH groups on their surface. A ceramic filler can in particular be understood to mean a non-metallic inorganic filler. As already explained, this can be the case, for example in ceramic, for example oxidic and/or siliceous, fillers due to an oxygen-containing composition of the filler as such, for example in the case of aluminum oxide, silicon dioxide, et cetera. In other ceramic fillers, for example nitride fillers, and/or in metallic fillers, for example based on copper, silver, gold, nickel, aluminum, iron et cetera, the surface can likewise have OH groups. This can be based, for example, on an oxide shell that is produced natively on air contact and can be formed, for example, by reaction with atmospheric humidity and/or by targeted thermally assisted treatment with oxygen and water.

In a further embodiment of the present invention, the at least one filler therefore comprises or is at least one ceramic and/or metallic filler. For certain applications in which the properties of metallic fillers are advantageous, for example in order to prepare an electrically conductive and/or catalytically active and optionally also thermally conductive composite, the at least one filler can, for example, comprise or be at least one metallic filler. For other applications in which the properties of ceramic fillers are advantageous, for example in order to prepare an electrically insulating and/or thermally conductive composite, the at least one filler can in particular comprise or be at least one ceramic filler. Due to electrical insulation properties, ceramic fillers have proven to be particularly advantageous for application of the composite composition to electrics and/or electronics, for example power electronics.

In a further embodiment of the present invention, the at least one filler therefore comprises or is at least one ceramic filler.

In a further embodiment of the present invention, the at least one filler comprises at least one oxidic and/or nitridic and/or carbidic and/or siliceous filler. In particular, the at least one filler can be at least one oxidic and/or nitridic and/or carbidic and/or siliceous filler. Oxidic and/or nitridic and/or carbidic and/or siliceous fillers can advantageously be both thermally conductive and electrically insulating and additionally have advantageous coefficients of thermal expansion. For this reason, oxidic and/or nitridic and/or carbidic and/or siliceous fillers can be used particularly advantageously for the application of the composite composition to electronics and/or electrics. Oxidic and/or nitridic and/or carbidic and/or siliceous fillers can in particular also provide electrical insulation (high-voltage insulation, electrical dielectric strength) in the case of high voltages and short distances between different electrical potentials. For this reason, oxidic and/or nitridic and/or carbidic and/or siliceous fillers can in particular be used particularly advantageously for the application of the composite composition to power electronics.

In particular, the at least one filler can be free of alkali ions and halide ions for application of the composite composition to electronics and/or electrics, in particular power electronics. The electrical insulation and the service life of the electrics and/or electronics can thus advantageously be improved further.

In one embodiment of the present invention, the at least one filler comprises or is at least one oxidic and/or siliceous filler. Due to the oxygen-containing composition of the filler as such, oxidic and/or siliceous fillers advantageously have a particularly high proportion of OH groups. A particularly high degree of bonding of the at least one filler in the composite can thus advantageously be achieved, whereby a high mechanical stability and/or thermal conductivity of the composite can in turn be achieved.

In a further embodiment of the present invention, the at least one filler comprises or is aluminum oxide (Al₂O₃) and/or silicon dioxide (SiO₂) and/or magnesium oxide (MgO) and/or zinc oxide (ZnO) and/or zirconium oxide (ZrO₂) and/or titanium dioxide (TiO₂) and/or forsterite (Mg₂SiO₄) and/or boron nitride (BN) and/or aluminum nitride (AlN) and/or silicon nitride (Si₃N₄). With regard to their high thermal conductivity, their high electrical insulation capacity, in particular which is also suitable for high-voltage insulation, and their coefficients of thermal expansion, these fillers have proven to be particularly advantageous for the application of the composite composition to electronics and/or electrics, in particular power electronics.

In particular, the at least one filler can comprise or be aluminum oxide and/or silicon dioxide and/or magnesium oxide and/or zirconium oxide and/or forsterite. A particularly high degree of bonding of the at least one filler in the composite can thus advantageously be achieved, whereby a high mechanical stability and/or thermal conductivity of the composite can in turn be achieved.

In a specific embodiment of the present invention, the at least one filler comprises or is aluminum oxide. For example, the at least one filler can comprise or be aluminum oxide, for example aluminum oxide free of alkali ions and halide ions, for example high-purity aluminum oxide. Aluminum oxide advantageously has a high thermal conductivity, a high electrical insulation capacity, in particular which is also suitable for high-voltage insulation, and a coefficient of thermal expansion suitable for electronics and/or electrics, in particular power electronics, and a high proportion of OH groups on the surface in order to achieve a high degree of bonding, and is also advantageously comparatively inexpensive.

The at least one filler can, for example, have a D50 value (or median of the grain sizes) in a range from ≥0.1 μm to ≤110 μm and/or a granulation band, in particular between the smallest and the largest grain, in a range from ≥0.05 μm to ≤200 μm and/or a maximum particle size of ≤200 μm.

In a further embodiment of the present invention, the at least one filler comprises at least one coarse filler and at least one fine filler. In this case, gaps between particles of the at least one coarse filler can advantageously be filled up by the at least one fine filler. Thus, a particularly high filling level can advantageously be achieved and thereby properties of the composite formed from the composite composition, such as the mechanical stability and/or the thermal expansion coefficient and/or the thermal conductivity and/or the electrical insulation capacity, can be further improved, and the shrinkage during curing of the composite composition to form the composite can be further minimized.

In a specific form of this embodiment of the present invention, the at least one coarse filler has a granulation band, in particular between the smallest and the largest grain, in a range from ≥1 μm to ≤200 μm, and/or a D50 value (or median of the grain sizes) in a range from ≥5 μm to ≤110 μm, for example in a range from ≥10 μm to ≤60 μm, possibly in a range from ≥10 μm to ≤40 μm.

In a further specific, alternative or additional, in particular additional, form of this embodiment of the present invention, the at least one fine filler has a granulation band, in particular between the smallest and the largest grain, in a range from ≥0.05 μm to ≤1 μm, and/or a D50 value (or median of the grain sizes) in a range from ≥0.1 μm to ≤0.9 μm, for example in a range from ≥0.1 μm to ≤0.2 μm. This has proven to be particularly advantageous for achieving a high filling level and for improving properties of the composite formed from the composite composition, such as the mechanical stability and/or the thermal expansion coefficient and/or the thermal conductivity and/or the electrical insulation capacity, and for minimizing shrinkage during curing of the composite composition to form the composite.

In a further embodiment of the present invention, the composite composition comprises, relative to the total weight of the composite composition, ≥60 wt. % to ≤90 wt. % of the at least one coarse filler and ≥0 wt. % to ≤8 wt. % of the at least one fine filler. This has proven to be particularly advantageous for achieving a high filling level and for improving properties of the composite formed from the composite composition, such as the mechanical stability and/or the thermal expansion coefficient and/or the thermal conductivity and/or the electrical insulation capacity, and for minimizing shrinkage during curing of the composite composition to form the composite. By a combination with the embodiments explained above, the packing density and thereby the filling level and the advantages achievable thereby can advantageously be optimized further.

Furthermore, the composite composition can comprise, for example, at least one organic solvent and/or at least one wetting agent and/or at least one defoamer and/or at least one silicone resin.

The presence and/or the addition of at least one organic solvent can have an advantageous effect on the processing of the composite composition. The flow properties of the composite composition can advantageously be adjusted by the at least one organic solvent, for example for use as a potting compound for electronics and/or electrics. If the at least one silanol is added to the composite composition in the form of a silanol composition prepared according to the present invention, the at least one organic solvent can comprise or be at least one alcohol, in particular formed during preparation.

In one embodiment of the present invention, the at least one organic solvent comprises or is at least one alcohol. In particular, the at least one organic solvent can comprise or be at least one alcohol, in particular formed during the preparation of the at least one silanol. In addition, removal of the at least one alcohol that forms can thus be omitted during preparation, and as a result the preparation method can also be simplified. For example, the at least one alcohol can comprise or be ethanol and/or methanol and/or propanol, for example isopropanol and/or n-propanol, and/or butanol, for example tert-butanol sec-butanol and/or isobutanol and/or n-butanol. These alcohols can advantageously have a low viscosity and can be particularly advantageous for forming composite composition with a low viscosity, in particular even at high filling levels, for example of over 60 wt. % and in particular even over 90 wt. %. In principle, the at least one alcohol of the composite composition can comprise methanol, and/or the hydrolyzable groups can comprise or be methoxy groups. However, ethanol and/or propanol, for example isopropanol and/or n-propanol, and/or butanol, for example tert-butanol and/or sec-butanol and/or isobutanol and/or n-butanol, have the advantages over methanol of lower toxicity and a higher boiling point, which has proven to be advantageous in particular with regard to the processing and handling of the composite composition. For example, the at least one alcohol can therefore comprise or be ethanol and/or propanol, for example isopropanol and/or n-propanol, and/or butanol, for example tert-butanol sec-butanol and/or isobutanol and/or n-butanol, for example ethanol and/or propanol, for example isopropanol and/or n-propanol. Ethanol has proven to be particularly advantageous, since it has a low toxicity, is inexpensive, and also forms an azeotrope with water, which also makes it possible to remove even low water fractions in a simple and energy-efficient manner during drying of the composite composition. In particular, the at least one alcohol can therefore comprise or be ethanol.

In another, additional or alternative embodiment of the present invention, the at least one organic solvent comprises at least one other, in particular non-alcoholic, organic solvent, for example with a low boiling point, for example ethyl acetate. By adding this to the composite composition, for example, slip flow properties of the composite composition can be adjusted, for example further improved. This can be advantageous in particular in the case of a high degree of oligomerization and/or polymerization of the at least one silanol and/or silanol precursor. Ethyl acetate can advantageously have a faster evaporation behavior than ethanol and in this way further accelerate the curing of the composite composition.

For example, the composite composition can comprise, relative to the total weight of the composite composition, ≥1 wt. % to ≤25 wt. %, for example ≥2 wt. % to ≤20 wt. %, of the at least one organic solvent, in particular of at least one alcohol and/or the at least one other, in particular non-alcoholic, organic solvent, in particular in total. Advantageous slip flow properties can thus be achieved.

A wetting agent can in particular be understood to mean an additive that can contribute to improved wetting of the composite composition on a metallic and/or ceramic substrate and of liquid components of the composite composition on the filler surfaces. The at least one wetting agent can, for example, comprise and/or be based on and/or be at least one polycarboxylate ether. By means of the at least one wetting agent, the wetting of the at least one filler and also, for example, materials, for example a substrate that is to be potted with the composite composition, for example, can advantageously be improved.

By means of the at least one defoamer, a bursting of rising bubbles during curing can advantageously be facilitated and thereby, for example, the formation of holes or pores can be avoided.

By adding at least one polysiloxane resin, further properties of the composite composition and/or of the composite formed therefrom can advantageously be adjusted, for example the modulus of elasticity and/or the thermal expansion can be adapted.

If the at least one organic solvent and/or the at least one wetting agent and/or the at least one defoamer and/or the at least one polysiloxane resin contains water or is added in the form of an aqueous solution/suspension/dispersion of the composite composition, it will be advantageous to ensure that the total water content of the composite composition remains low, in particular at least below 10 wt. %, preferably at least below 3 wt. %, particularly preferably around 0 wt. %. In particular, the at least one organic solvent and/or the at least one wetting agent and/or the at least one defoamer and/or the at least one silicone resin can therefore be dry, preferably anhydrous.

For example, the composite composition can (furthermore) comprise, relative to the total weight of the composite composition,
≥0 wt. % to ≤2.5 wt. % of the at least one wetting agent, and/or
≥0 wt. % to ≤0.2 wt. % of the at least one defoamer, and/or
≥0 wt. % to ≤10 wt. % of the at least one, in particular crosslinkable, polysiloxane resin or silicone resin.

The composite composition can furthermore be, for example, in particular substantially free of silane triols.

With regard to further technical features and advantages of the composite composition according to the present invention, reference is hereby explicitly made to the explanations in connection with the other subjects according to the present invention and to the exemplary embodiments.

The present invention also relates to a preparation method for preparing a silanol having hydrolyzable groups, in which method at least one silane having three hydrolyzable groups is partially hydrolyzed with an amount of substance of water that is substoichiometric, for example half-stoichiometric or less than half-stoichiometric, in particular less than half-stoichiometric, for example up to quarter-stoichiometric, relative to the amount of substance of the hydrolyzable groups of the at least one silane having three hydrolyzable groups, in an, in particular first, hydrolysis to form (the) at least one, in particular monomeric, silanol having hydrolyzable groups. In particular, the at least one silane having three hydrolyzable groups can be partially hydrolyzed with an amount of substance of water that is less than half-stoichiometric, for example up to quarter-stoichiometric, relative to the amount of substance of the hydrolyzable groups of the at least one silane having three hydrolyzable groups, in a/the, in particular first, hydrolysis, to form (the) at least one, in particular monomeric, silanol having hydrolyzable groups.

Advantageously, an, in particular anhydrous, in particular partially hydrolyzed, for example monomeric, silanol having hydrolyzable groups can thus be obtained. In this way, the water content of the composite composition can advantageously be minimized and/or in particular even the amount of the water eliminated during the curing of the composite composition can be reduced, whereby advantageously in turn a shrinkage of the composite during curing can be minimized, and/or the drying and/or the curing can be accelerated, and/or corrosion can be avoided.

The preparation method for preparing a silanol having hydrolyzable groups can in particular be designed for preparing a silanol according to the present invention and/or as a constituent, for example process step, of a preparation method according to the present invention for preparing an oligomeric and/or polymeric silanol precursor having hydrolyzable groups and/or for preparing an oligomeric and/or polymeric silanol precursor according to the present invention having hydrolyzable groups and/or as a constituent, for example method step, of a preparation method according to the present invention for preparing an oligomeric and/or polymeric silanol and/or silsesquioxane prepolymer, for example a polysilsesquioxane prepolymer, and/or for preparing an oligomeric and/or polymeric silanol and/or silsesquioxane prepolymer, for example a polysilsesquioxane prepolymer, according to the present invention, in particular for a composite composition according to the present invention.

In one embodiment of the present invention, the, in particular first, hydrolysis, is carried out at a temperature of ≥60° C., for example of ≥70° C., in particular at a temperature in a range from ≥60° C., for example from ≥70° C., in particular to ≤100° C. The reactants can be mixed at such a temperature. The hydrolysis reaction can advantageously be accelerated by a temperature of ≥60° C., for example of ≥70° C. By limiting the temperature to below 100° C., premature condensation reactions can advantageously be avoided.

In a further embodiment of the present invention, the, in particular first, hydrolysis, is carried out in a closed system. It can thus advantageously be ensured that the water required for the reaction remains in the mixture (until the reaction thereof). If necessary, the closed system can be pressure-resistant and/or designed as an autoclave. After completion of the, in particular first, hydrolysis and, for example, before the beginning of an, in particular second, hydrolysis, which is explained later, preferably no further water is added.

The, in particular first, hydrolysis can take place in particular for a specific period of time. For example, the, in particular first, hydrolysis, can take place for at least half an hour, for example for at least one hour, for example for a specific period of time in a range from 0.5 to 4 hours.

The, in particular first, hydrolysis can in particular be carried out only in the presence of the at least one silane having three hydrolyzable groups and water. This can thus be carried out in particular without addition of a catalyst or in a catalyst-free manner and/or without addition of an organic solvent and/or without addition of bases/alkaline solutions and/or without addition of further substances.

The hydrolyzable groups can, for example, comprise or be alkoxy groups and/or halogen atoms, for example chlorine atoms. In this case, the at least one silane having three hydrolyzable groups can, for example, comprise or be at least one trialkoxysilane and/or at least one trihalosilane, for example at least trichlorosilane, and/or can be partially hydrolyzed with an amount of substance of water that is substoichiometric, for example half-stoichiometric or less than half-stoichiometric, in particular less than half-stoichiometric, for example up to quarter-stoichiometric, relative to the amount of substance of the alkoxy groups and/or halogen atoms, for example chlorine atoms, of the at least one trialkoxysilane and/or trihalosilane, for example trichlorosilane, to form at least one, in particular monomeric, silanol having alkoxy groups and/or halogen atoms, for example chlorine atoms.

In one embodiment of the present invention, the hydrolyzable groups comprise or are alkoxy groups, for example ethoxy groups and/or methoxy groups and/or propoxy groups and/or butoxy groups, for example ethoxy groups, and/or the at least one silane having three hydrolyzable groups comprises or is at least one trialkoxysilane, for example triethoxysilane and/or trimethoxysilane and/or tripropoxysilane and/or tributoxysilane, for example triethoxysilane, and/or is partially hydrolyzed with an amount of substance of water that is substoichiometric, for example half-stoichiometric or less than half-stoichiometric, in particular less than half-stoichiometric, for example up to quarter-stoichiometric, relative to the amount of substance of the alkoxy groups, for example ethoxy groups and/or methoxy groups and/or propoxy groups and/or butoxy groups, for example ethoxy groups, of the at least one trialkoxysilane, for example triethoxysilane to form at least one, in particular monomeric, silanol having alkoxy groups, for example ethoxy groups and/or methoxy groups and/or propoxy groups and/or butoxy groups, for example ethoxy groups, in particular monomeric, silanol. This has proven to be particularly advantageous in the context of the present invention.

By means of the, in particular first, hydrolysis, for example, in particular if the hydrolyzable groups are alkoxy groups, a silanol composition having a high alcohol content can be prepared, which are advantageously used both for providing the at least one silanol having hydrolyzable groups, in particular alkoxy groups, in the composite composition according to the present invention and/or as a composite composition additive and as such as casting compound for application on an, in particular metallic and/or ceramic, material, and/or with at least one, in particular ceramic and/or metallic, filler. For example, the silanol composition can be used as such as a casting compound for coating and/or for potting an, in particular metallic and/or ceramic, material, and/or at least one, in particular ceramic and/or metallic, filler. For example, a silanol composition prepared in this way can comprise, relative to the total weight of the silanol composition,
≥30 wt. % to ≤70 wt. % of at least one silanol having hydrolyzable groups, in particular alkoxy groups, for example ethoxy groups, and
≥30 wt. % to ≤70 wt. % of at least one alcohol, for example, in particular in total, of methanol and/or ethanol and/or propanol, for example isopropanol and/or n-propanol, and/or butanol, for example tert-butanol, sec-butanol and/or isobutanol and/or n-butanol, for example of ethanol.

The at least one silane having three hydrolyzable groups and/or the at least one silanol having hydrolyzable groups can, for example, furthermore, have an organic radical or be monosubstituted by an organic radical, in particular per silicon atom. The organic radical can, for example, have a chain length of ≥1 atom or ≥2 atoms or ≥3 atoms or ≥4 or ≥5 or ≥6 atoms or ≥7 atoms. For example, the organic radical can comprise or be an alkyl group, for example a methyl, ethyl or propyl group, and/or an aryl group, for example a phenyl group, and/or an alkylene chain, for example a methylene, ethylene or propylene chain, and/or an arylene group, for example a phenylene group and/or at least one functional group, for example an epoxy group and/or amino group and/or mercapto group and/or vinyl group.

In a specific embodiment of the present invention, the organic radical is an alkyl group, for example a methyl, ethyl or propyl group, in particular a methyl group, and/or the at least one silane having three hydrolyzable groups comprises or is at least one alkylsilane, for example at least one methyl-, ethyl-, and/or propylsilane, in particular at least one methylsilane, having three hydrolyzable groups, and/or the at least one silanol having hydrolyzable groups comprises or is at least one alkylsilanol having hydrolyzable groups, for example methyl-, ethyl- and/or propylsilanol, in particular methylsilanol.

Composites can advantageously be formed from composite compositions comprising alkylsilanols, for example methyl-, ethyl- or propylsilanols, in particular methylsilanols, which composites have hydrophobic properties and an associated low water absorption, withstand temperatures of up to 300° C., and have an adhesive strength on copper of about 8 MPa, and/or in particular also have a thermal conductivity of around and above 5 W/(m·K), a coefficient of thermal expansion of 6-10 ppm/K, very good insulation resistances, in particular even in the presence of moisture, and/or can exhibit no silver electromigration between silver conductor tracks. White fillers can advantageously be used to form white, for example snow-white, composites, which remained color-stable even under temperature loading at temperatures of up to 300° C.

For example, the at least one silane having three hydrolyzable groups can comprise or be at least one alkyl trialkoxysilane, for example at least one methyl, ethyl, and/or propyl trialkoxysilane, for example at least one methyl trialkoxysilane, in particular at least one alkyl triethoxysilane, for example at least one methyl, ethyl, and/or propyl triethoxysilane, for example at least one methyl triethoxysilane, and/or the at least one silanol having hydrolyzable groups can comprise or be at least one alkyl alkoxysilanol, for example at least one methyl, ethyl, and/or propyl alkoxysilanol, for example at least one methyl alkoxysilanol, in particular at least one alkyl ethoxysilanol, for example at least one methyl, ethyl, and/or propyl ethoxysilanol, for example at least one methyl ethoxysilanol.

In a specific embodiment of the present invention, water is used in the, in particular first, hydrolysis in an amount of substance that is in a ratio of <1.50, in particular in a ratio in a range from >0.00 to <1.50, for example in a range from ≥0.80 to <1.50, for example in a range from ≥0.80 or ≥0.87, in particular ≥0.90, to <1.50, in particular ≤1.45, for example ≤1.42 or ≤1.40 or ≤1.35 relative to the amount of substance of the at least one silane having three hydrolyzable groups. By means of such a ratio of amounts of substance, composite compositions with a reduced water content and/or reduced amount of water forming during curing and thus reduced shrinkage and/or process time during curing and/or advantageous flow properties, for example during application, in particular before curing, can advantageously be realized.

As explained above, this range can be divided into two subranges, specifically into a subrange where x≤1.10 and into a subrange where x>1.10, in order, for example, to focus either on an optimum with respect to flowability (x≤1.10) or on an optimum with respect to a reduced curing shrinkage and/or accelerated drying and/or curing and/or reduced corrosion potential (x>1.10).

In a specific embodiment (x≤1.10) of the present invention, water is used in the, in particular first, hydrolysis in an amount of substance that is in a ratio in a range from ≥0.80 to ≤1.10, for example in a range from ≥0.87 to ≤1.10, for example in a range from ≥0.90, to ≤1.10 relative to the amount of substance of the at least one silane having three hydrolyzable groups.

In another specific embodiment (x>1.10) of the present invention, water is used in the, in particular first, hydrolysis in an amount of substance that is in a ratio in a range from >1.10 to <1.50, for example in a range from ≥1.12, for example 1.13 or ≥1.14, for example ≥1.15, to <1.50, in particular ≤1.45, for example ≤1.42 or ≤1.40 or ≤1.35 relative to the amount of substance of the at least one silane having three hydrolyzable groups. For example, in the, in particular first, hydrolysis, water can be used in an amount of substance that is in a ratio in a range from ≥1.12, for example ≥1.13 or ≥1.14, for example ≥1.15, to ≤1.45, for example ≤1.40 or ≤1.35 relative to the amount of the at least one silane having three hydrolyzable groups.

Via this preparation method, an, in particular monomeric, silanol having hydrolyzable groups and/or a silanol composition, in particular containing an, in particular monomeric, silanol having hydrolyzable groups can advantageously be prepared.

With regard to further technical features and advantages of the preparation method according to the present invention for preparing an, in particular monomeric, silanol having hydrolyzable groups, reference is hereby explicitly made to the explanations in connection with the composite composition according to the present invention and the other subjects according to the present invention and to the exemplary embodiments.

The present invention also relates to an, in particular monomeric, silanol having hydrolyzable groups and/or a silanol composition containing at least one, in particular monomeric, silanol having hydrolyzable groups. The, in particular monomeric, silanol having hydrolyzable groups and/or the silanol composition containing at least one, in particular monomeric, silanol having hydrolyzable groups, can, for example, be designed or used for a composite composition according to the present invention, and/or for the preparation according to the present invention of an oligomeric and/or polymeric silanol precursor having alkoxy groups, and/or for the preparation according to the present invention of an oligomeric and/or polymeric silanol and/or silsesquioxane prepolymer, for example a polysilsesquioxane prepolymer, and/or for forming a silsesquioxane, in particular a polysilsesquioxane, and/or can be prepared by a preparation method according to the present invention for preparing an, in particular monomeric, silanol having hydrolyzable groups.

In one embodiment of the present invention, the, in particular monomeric, silanol having hydrolyzable groups is based on average in particular on the following general chemical formula, relative to the sum of all the silicon atoms:

RSi(X)₃₋ₓ(OH)ₓ.

For example, R can stand for an organic radical, for example having a chain length of ≥1 atom or ≥2 atoms or ≥3 atoms or ≥4 or ≥5 or ≥6 atoms or ≥7 atoms. For example, R can comprise or be an alkyl group, for example a methyl, ethyl or propyl group, and/or an alkylene chain, for example a methylene, ethylene or propylene chain, and/or an aryl group, for example a phenyl group, and/or an arylene group, for example a phenylene group, and/or at least one functional group, for example an epoxy group and/or amino group and/or mercapto group and/or vinyl group.

In one embodiment of the present invention, R stands for an alkyl group. For example, R can stand for a methyl, ethyl or propyl group.

In a specific embodiment of the present invention, R stands for a methyl group.

Alkylsilanes, such as methyl-, ethyl- or propylsilanes, can be comparatively easily obtainable and/or inexpensive. In addition, composites can advantageously be formed from composite compositions comprising alkylsilanols, for example methyl-, ethyl- or propylsilanols, in particular methylsilanols, which composites have hydrophobic properties and an associated low water absorption, withstand temperatures of up to 300° C., and have an adhesive strength on copper of about 8 MPa, and/or in particular also have a thermal conductivity of around and above 5 W/(m·K), a coefficient of thermal expansion of 6-10 ppm/K, very good insulation resistances, in particular even in the presence of moisture, and/or can exhibit no silver electromigration between silver conductor tracks. White fillers can advantageously be used to form white, for example snow-white, composites, which can remain color-stable even under temperature loading at temperatures of up to 300° C.

X can in particular stand for a hydrolyzable group, for example an alkoxy group (OR′) and/or a halogen atom, for example chlorine atom (Cl).

In a further embodiment of the present invention, X stands for an alkoxy group (OR′). For example, X can stand for an ethoxy group or methoxy group or propoxy group or butoxy group. In the hydrolysis of alkoxysilanes and/or alkoxysilanol, at least one alcohol can advantageously be formed, which can have an advantageous effect on process management and/or handling.

In a specific embodiment of the present invention, X stands for an ethoxy group. In the hydrolysis of alkoxysilanes and/or alkoxysilanol, ethanol can advantageously be formed, which can have a particularly advantageous effect on process management and/or handling.

x can in particular be 0<x<1.50. A reduced curing shrinkage and/or accelerated drying and/or curing and/or reduced corrosion potential and a suitable flowability can thus advantageously be achieved.

In a further embodiment of the present invention, 0.80≤x<1.50. For example, it is possible for 0.80≤ or 0.87≤, in particular 0.90≤, x<1.50, in particular ≤1.45, for example ≤1.42 or ≤1.40 or ≤1.35. For example, it is possible for 0.90≤x≤1.45, for example ≤1.42 or ≤1.40 or ≤1.35.

In a specific embodiment of the present invention, 0.80≤x≤1.10, for example 0.87≤x≤1.10, in particular 0.90≤x≤1.10. The flowability can thus advantageously be optimized, and at the same time reduced curing shrinkage and/or accelerated drying and/or curing and/or a reduced corrosion potential can be achieved.

In another specific embodiment of the present invention, 1.10<x<1.50, for example 1.12≤, for example 1.13≤ or 1.14≤, for example 1.15≤, x<1.50, in particular ≤1.45, for example ≤1.42 or ≤1.40 or ≤1.35, for example 1.15≤x<1.50, in particular ≤1.45, for example ≤1.42 or ≤1.40 or ≤1.35. An even more reduced curing shrinkage and/or an even more accelerated drying and/or curing and/or an even more reduced corrosion potential can thus advantageously be achieved.

In a specific form of this embodiment of the present invention, the silanol having hydrolyzable groups is based on average in particular on the following chemical formula, relative to the sum of all the silicon atoms:

RSi(OR′)₃₋ₓ(OH)ₓ.

In this case, R′ can for example stand for an alkyl group, for example a methyl group or ethyl group or propyl group or butyl group, in particular an ethyl group.

In a more specific form of this embodiment of the present invention, the silanol having hydrolyzable groups is based on average on the following chemical formula, relative to the sum of all the silicon atoms:

RSi(OEt)₃₋ₓ(OH)ₓ.

The silanol composition containing at least one, in particular monomeric, silanol having hydrolyzable groups can advantageously be used both to provide the at least one silanol having hydrolyzable groups in the composite composition according to the present invention and/or as a composite composition additive and as such as a casting compound for application on an, in particular metallic and/or ceramic, material, and/or with at least one, in particular ceramic and/or metallic, filler. For example, the silanol composition can be used as such as a casting compound for coating and/or for potting an, in particular metallic and/or ceramic, material, and/or at least one, in particular ceramic and/or metallic, filler. For example, such a silanol composition can comprise, relative to the total weight of the silanol composition,
≥30 wt. % to ≤70 wt. % of at least one silanol having hydrolyzable groups, in particular alkoxy groups, for example ethoxy groups, and
≥30 wt. % to ≤70 wt. % of at least one alcohol, for example, in particular in total, of methanol and/or ethanol and/or propanol, for example isopropanol and/or n-propanol, and/or butanol, for example tert-butanol, sec-butanol and/or isobutanol and/or n-butanol, for example ethanol.

With regard to further technical features and advantages of the, in particular monomeric, silanol according to the present invention having hydrolyzable groups and/or of the silanol composition containing at least one silanol having hydrolyzable groups, reference is hereby explicitly made to the explanations in connection with the composite composition according to the present invention and the other subjects according to the present invention and to the exemplary embodiments.

The present invention also relates to a preparation method for preparing an oligomeric and/or polymeric silanol precursor having hydrolyzable groups, in which method at least one silanol having hydrolyzable groups prepared by a preparation method according to the present invention for preparing a silanol having hydrolyzable groups, and/or at least one silanol according to the present invention having hydrolyzable groups, is partially condensed in an, in particular first, condensation to form (the) at least one oligomeric and/or polymeric silanol precursor having hydrolyzable groups, and/or in which method at least one silane having three hydrolyzable groups is partially hydrolyzed and condensed with an amount of substance of water that is substoichiometric, in particular half-stoichiometric or less than half-stoichiometric, in particular less than half-stoichiometric, for example up to quarter-stoichiometric, relative to the amount of substance of the hydrolyzable groups of the at least one silane having three hydrolyzable groups in a combined, in particular first, hydrolysis and condensation to form (the) at least one oligomeric and/or polymeric silanol precursor having hydrolyzable groups.

In the preparation method according to the present invention for preparing an oligomeric and/or polymeric silanol precursor having hydrolyzable groups, the at least one silane having three hydrolyzable groups can be partially hydrolyzed, in particular with an amount of substance of water that is less than half-stoichiometric, in particular up to quarter-stoichiometric, relative to the amount of substance of the hydrolyzable groups of the at least one silane having three hydrolyzable groups, or partially hydrolyzed and condensed in the combined, in particular first, hydrolysis and condensation.

In this way, an oligomeric and/or polymeric silanol precursor having hydrolyzable groups can advantageously be prepared, which makes it possible to reduce the water content of the composite composition and/or in particular also to reduce the amount of water eliminated during the curing of the composite composition, whereby in turn a shrinkage of the composite during curing advantageously can be minimized and/or the drying and/or the curing can be accelerated.

The preparation method for preparing an oligomeric and/or polymeric silanol precursor having hydrolyzable groups can in particular be designed for preparing an oligomeric and/or polymeric silanol precursor according to the present invention having hydrolyzable groups, and/or as a constituent, for example method step, of a preparation method according to the present invention for preparing an oligomeric and/or polymeric silanol and/or silsesquioxane prepolymer, for example a polysilsesquioxane prepolymer, in particular for a composite composition according to the present invention.

In one embodiment, the, in particular first, condensation and/or the combined, in particular first, hydrolysis and condensation is carried out at a temperature from ≥100° C., in particular from ≥110° C., for example from ≥120° C., for example from ≥130° C., for example to ≤250° C., in particular to ≤220° C., for example to ≤200° C., for example to ≤180° C., for example to ≤170° C. In particular, the, in particular first, condensation and/or the combined, in particular first, hydrolysis and condensation can be performed at a temperature in a range from ≥100° C. to ≤220° C., for example from ≥110° C. to ≤200° C., for example from ≥120° C. to ≤180° C., for example ≥130° C. to ≤170° C., for example at approximately 150° C. This has proven to be advantageous in the context of the present invention.

In a further embodiment of the present invention, the, in particular first, condensation and/or the combined, in particular first, hydrolysis and condensation is carried out in a closed system, in particular in a closed system equipped with an overpressure outlet, or possibly in an autoclave. It can thus advantageously be ensured that water formed in situ remains substantially in the system. If a system is equipped with an overpressure outlet, volatile reaction products, for example alcohol, that are gradually formed during the reaction and build up an overpressure, can optionally partially gradually escape from the system via the overpressure outlet.

The, in particular first, condensation or the combined, in particular first, hydrolysis and condensation can in particular take place for a specific period of time. For example, the, in particular first, condensation or the combined, in particular first, hydrolysis and condensation can take place for at least half an hour, for example up to 10 hours, for example for a specific period of time in a range from 0.5 to 10 hours, for example for approximately 4 hours.

The, in particular first, condensation or the combined, in particular first, hydrolysis and condensation can advantageously likewise be carried out only in the presence of the at least one silanol having hydrolyzable groups and/or of the at least one silane having three hydrolyzable groups and water. This can thus advantageously be carried out without addition of a catalyst or in a catalyst-free manner and/or without addition of an (additional) organic solvent and/or without addition of a base/alkaline solution and/or without addition of further substances.

The hydrolyzable groups can, for example, comprise or be alkoxy groups and/or halogen atoms, for example chlorine atoms. In this case, the at least one silanol having hydrolyzable groups can comprise or be at least one, in particular monomeric, silanol having alkoxy groups and/or halogen atoms, for example chlorine atoms, and/or the at least one silane having three hydrolyzable groups can, for example, comprise or be at least one trialkoxysilane and/or at least one trihalosilane, for example at least trichlorosilane, and/or can be partially hydrolyzed and condensed with an amount of substance of water that is substoichiometric, for example half-stoichiometric or less than half-stoichiometric, in particular less than half-stoichiometric, for example up to quarter-stoichiometric, relative to the amount of substance of the alkoxy groups and/or halogen atoms, for example chlorine atoms, of the at least one trialkoxysilane and/or trihalosilane, for example trichlorosilane, to form at least one oligomeric and/or polymeric silanol precursor having alkoxy groups and/or halogen atoms, for example chlorine atoms.

In one embodiment of the present invention, the hydrolyzable groups comprise or are alkoxy groups, for example ethoxy groups and/or methoxy groups and/or propoxy groups and/or butoxy groups, for example ethoxy groups, and/or the at least one silanol having hydrolyzable groups comprises or is at least one silanol having alkoxy groups, for example ethoxy groups and/or methoxy groups and/or propoxy groups and/or butoxy groups, for example ethoxy groups, and/or the at least one silane having three hydrolyzable groups comprises or is at least one trialkoxysilane, for example triethoxysilane and/or trimethoxysilane and/or tripropoxysilane and/or tributoxysilane, for example at least one triethoxysilane, and/or is partially hydrolyzed and condensed with an amount of substance of water that is substoichiometric, for example half-stoichiometric or less than half-stoichiometric, in particular less than half-stoichiometric, for example up to quarter-stoichiometric, relative to the amount of substance of the alkoxy groups, for example ethoxy groups and/or methoxy groups and/or propoxy groups and/or butoxy groups, for example ethoxy groups, of the at least one trialkoxysilane, for example triethoxysilane and/or trimethoxysilane and/or tripropoxysilane and/or tributoxysilane, for example triethoxysilane, to form at least one oligomeric and/or polymeric silanol precursor silanol having alkoxy groups, for example ethoxy groups and/or methoxy groups and/or propoxy groups and/or butoxy groups, for example ethoxy groups, in particular monomeric, silanol. This has proven to be particularly advantageous in the context of the present invention.

In a further embodiment of the present invention, in particular after the specific time period has elapsed, by-products formed during the condensation, in particular alcohol and/or hydrogen halide, for example ethanol, are removed, for example by a gas stream and/or by evaporation and/or under vacuum. An oligomeric and/or polymeric silanol precursor having hydrolyzable groups can thus advantageously be obtained, which at least no longer contains any significant amounts of by-products formed during the condensation, such as alcohol and/or hydrogen halide, for example ethanol, and, for example, can be anhydrous and alcohol-free, for example ethanol-free, and/or hydrogen halide-free.

The at least one silanol having hydrolyzable groups and/or the at least one silane having three hydrolyzable groups and/or the at least one oligomeric and/or polymeric silanol precursor having hydrolyzable groups can also, for example, have an organic radical or be monosubstituted by an organic radical, in particular per silicon atom. The organic radical can, for example, have a chain length of ≥1 atom or ≥2 atoms or ≥3 atoms or ≥4 or ≥5 or ≥6 atoms or ≥7 atoms. For example, the organic radical can comprise or be an alkyl group, for example a methyl, ethyl or propyl group, and/or an aryl group, for example a phenyl group, and/or an alkylene chain, for example a methylene, ethylene or propylene chain, and/or an arylene group, for example a phenylene group and/or at least one functional group, for example an epoxy group and/or amino group and/or mercapto group and/or vinyl group.

In one specific embodiment of the present invention, the organic radical is an alkyl group, for example a methyl, ethyl or propyl group, in particular a methyl group, and/or the at least one silanol having hydrolyzable groups comprises or is at least one alkylsilanol having hydrolyzable groups, for example methyl-, ethyl- and/or propylsilanol, in particular methylsilanol, and/or the at least one silane having three hydrolyzable groups comprises or is at least one alkylsilane, for example at least one methyl-, ethyl-, and/or propylsilane, in particular at least one methylsilane, having three hydrolyzable groups, and/or the at least one oligomeric and/or polymeric silanol precursor having hydrolyzable groups comprises or is at least one alkylsilanol precursor having hydrolyzable groups, for example methyl-, ethyl-, and/or propylsilanol precursor, in particular methylsilanol precursor. For example, the at least one silanol having hydrolyzable groups can comprise or be at least one alkyl alkoxysilanol, for example at least one methyl, ethyl, and/or propyl alkoxysilanol, for example at least one methyl alkoxysilanol, in particular at least one alkyl ethoxysilanol, for example at least one methyl, ethyl, and/or propyl ethoxysilanol, for example at least one methyl ethoxysilanol, and/or the at least one silane having three hydrolyzable groups can comprise or be at least one alkyl trialkoxysilane, for example at least one methyl, ethyl and/or propyl trialkoxysilane, for example at least one methyl trialkoxysilane, in particular at least one alkyl triethoxysilane, for example at least one methyl, ethyl, and/or propyl triethoxysilane, for example at least one methyl triethoxysilane, and/or the at least one oligomeric and/or polymeric silanol precursor having hydrolyzable groups can comprise or is at least one alkylsilanol precursor having alkoxy groups, for example ethoxy groups, for example methyl-, ethyl- and/or propylsilanol precursor, for example methylsilanol precursor. Alkylsilanes and alkylsilanols, such as methyl-, ethyl- or propylsilanes and methyl-, ethyl- or propylsilanols, can be comparatively easily obtainable and/or inexpensive. In addition, composites can advantageously be formed from composite compositions comprising alkylsilanols, for example methyl-, ethyl- or propylsilanols, in particular methylsilanols, which composites have hydrophobic properties and an associated low water absorption, withstand temperatures of up to 300° C., and have an adhesive strength on copper of about 8 MPa, and/or in particular also have a thermal conductivity of around and above 5 W/(m·K), a coefficient of thermal expansion of 6-10 ppm/K, very good insulation resistances, in particular even in the presence of moisture, and/or can exhibit no silver electromigration between silver conductor tracks. White fillers can advantageously be used to form white, for example snow-white, composites, which can remain color-stable even under temperature loading at temperatures of up to 300° C.

In the combined, in particular first, hydrolysis and condensation, water can be used, for example, in an amount of substance that is in a ratio of <1.50, in particular in a ratio in a range from >0.00 to ≤1.50, for example in a range from ≥0.80 to <1.50, for example in a range from ≥0.80 or ≥0.87, in particular ≥0.90, to <1.50, in particular ≤1.45, for example ≤1.42 or ≤1.40 or ≤1.35 relative to the amount of substance of the at least one silane having three hydrolyzable groups.

As already explained, this range can be divided into two subranges, specifically into a subrange where x≤1.10 and into a subrange where x>1.10, in order, for example, to focus either on an optimum with respect to flowability (x≤1.10) or on an optimum with respect to a reduced curing shrinkage and/or accelerated drying and/or curing and/or reduced corrosion potential (x>1.10).

In a specific embodiment (x≤1.10) of the present invention, water is used in the combined, in particular first, hydrolysis and condensation in an amount of substance that is in a ratio in a range from ≥0.80 to ≤1.10, for example in a range from ≥0.87 to ≤1.10, for example in a range from ≥0.90, to ≤1.10 relative to the amount of substance of the at least one silane having three hydrolyzable groups.

In another specific embodiment (x>1.10) of the present invention, water is used in the combined, in particular first, hydrolysis and condensation in an amount of substance that is in a ratio in a range from >1.10 to <1.50, for example in a range from ≥1.12, for example ≥1.13 or ≥1.14, for example ≥1.15, to <1.50, in particular ≤1.45, for example ≤1.42 or ≤1.40 or 1.35 relative to the amount of substance of the at least one silane having three hydrolyzable groups. For example, in the, in particular first, hydrolysis, water can be used in an amount of substance that is in a ratio in a range from ≥1.12, for example ≥1.13 or ≥1.14, for example ≥1.15, to ≤1.45, for example ≤1.40 or ≤1.35 relative to the amount of the at least one silane having three hydrolyzable groups.

Via this preparation method, an oligomeric and/or polymeric silanol precursor composition having hydrolyzable groups and/or a silanol precursor composition containing at least one oligomeric and/or polymeric silanol precursor having hydrolyzable groups can advantageously be prepared.

With regard to further technical features and advantages of the preparation method according to the present invention for preparing an oligomeric and/or polymeric silanol precursor having hydrolyzable groups, reference is hereby explicitly made to the explanations in connection with the composite composition according to the present invention and the other subjects according to the present invention and to the exemplary embodiments.

The present invention thus also relates to an oligomeric and/or polymeric silanol precursor having hydrolyzable groups and/or to a silanol precursor composition containing at least one oligomeric and/or polymeric silanol precursor having hydrolyzable groups.

The oligomeric and/or polymeric silanol precursor having hydrolyzable groups and/or the silanol precursor composition containing at least one oligomeric and/or polymeric silanol precursor having hydrolyzable groups can, for example, be designed or used for a composite composition according to the present invention and/or for the preparation according to the present invention of an oligomeric and/or polymeric silanol and/or silsesquioxane prepolymer, for example a polysilsesquioxane prepolymer, and/or for forming a silsesquioxane, in particular a polysilsesquioxane, and/or can be prepared by a preparation method according to the present invention for preparing an oligomeric and/or polymeric silanol precursor having hydrolyzable groups.

In one embodiment of the present invention, the oligomeric and/or polymeric silanol precursor having hydrolyzable groups is based in particular on average on the following chemical formula, relative to the sum of all the silicon atoms:

[RSi(X)₃₋₂ₓ(O)_{2x/2}]ₙ.

n can in particular stand for the number of repeat units. In particular, it is possible for n≥2, for example n≥3 or 4 or 5, for example n≥10, possibly n>100.

For example, R can stand for an organic radical, for example having a chain length of ≥1 atom or ≥2 atoms or ≥3 atoms or ≥4 or ≥5 or ≥6 atoms or ≥7 atoms. For example, R can comprise or be an alkyl group, for example a methyl, ethyl or propyl group, and/or an alkylene chain, for example a methylene, ethylene or propylene chain, and/or an aryl group, for example a phenyl group, and/or an arylene group, for example a phenylene group, and/or at least one functional group, for example an epoxy group and/or amino group and/or mercapto group and/or vinyl group.

In one embodiment of the present invention, R stands for an alkyl group. For example, R can stand for a methyl, ethyl or propyl group.

In a specific embodiment of the present invention, R stands for a methyl group.

Alkylsilanes, such as methyl-, ethyl- or propylsilanes, can be comparatively easily obtainable and/or inexpensive. In addition, composites can advantageously be formed from composite compositions comprising alkylsilanols, for example methyl-, ethyl- or propylsilanols, in particular methylsilanols, which composites have hydrophobic properties and an associated low water absorption, withstand temperatures of up to 300° C., and have an adhesive strength on copper of about 8 MPa, and/or in particular also have a thermal conductivity of around and above 5 W/(m·K), a coefficient of thermal expansion of 6-10 ppm/K, very good insulation resistances, in particular even in the presence of moisture, and/or can exhibit no silver electromigration between silver conductor tracks. White fillers can advantageously be used to form white, for example snow-white, composites, which can remain color-stable even under temperature loading at temperatures of up to 300° C.

X can in particular stand for a hydrolyzable group, for example an alkoxy group (OR′) and/or a halogen atom, for example chlorine atom (Cl).

In a further embodiment of the present invention, X stands for an alkoxy group (OR′). For example, X can stand for an ethoxy group or methoxy group or propoxy group or butoxy group. In the hydrolysis of alkoxysilanes and/or alkoxysilanol, at least one alcohol can advantageously be formed, which can have an advantageous effect on process management and/or handling.

In a specific embodiment of the present invention, X stands for an ethoxy group. In the hydrolysis of alkoxysilanes and/or alkoxysilanol, ethanol can advantageously be formed, which can have a particularly advantageous effect on process management and/or handling.

x can in particular be 0<x<1.50. A reduced curing shrinkage and/or accelerated drying and/or curing and/or reduced corrosion potential and a suitable flowability can thus advantageously be achieved.

In a further embodiment of the present invention, 0.80≤x<1.50. For example, it is possible for 0.80≤ or 0.87≤, in particular 0.90≤, x<1.50, in particular ≤1.45, for example ≤1.42 or ≤1.40 or ≤1.35. For example, it is possible for 0.90≤x≤1.45, for example ≤1.42 or ≤1.40 or ≤1.35.

In a specific embodiment of the present invention, 0.80≤x≤1.10, for example 0.87≤x≤1.10, in particular 0.90≤x≤1.10. The flowability can thus advantageously be optimized, and at the same time reduced curing shrinkage and/or accelerated drying and/or curing and/or a reduced corrosion potential can be achieved.

In another specific embodiment of the present invention, 1.10<x<1.50, for example 1.12≤, for example 1.13≤ or 1.14≤, for example 1.15≤, x<1.50, in particular ≤1.45, for example ≤1.42 or ≤1.40 or ≤1.35, for example 1.15≤x<1.50, in particular ≤1.45, for example ≤1.42 or ≤1.40 or ≤1.35. An even more reduced curing shrinkage and/or an even more accelerated drying and/or curing and/or an even more reduced corrosion potential can thus advantageously be achieved.

In a specific form of this embodiment of the present invention, the oligomeric and/or polymeric silanol precursor having hydrolyzable groups is based on average on the following general chemical formula, relative to the sum of all the silicon atoms:

[RSi(OR′)₃₋₂ₓ(O)_{2x/2}]ₙ

In this case, R′ can for example stand for an alkyl group, for example a methyl group or ethyl group or propyl group or butyl group, in particular an ethyl group.

In an even more specific form of this embodiment of the present invention, the oligomeric and/or polymeric silanol precursor having hydrolyzable groups is based on average on the following general chemical formula, relative to the sum of all the silicon atoms:

[RSi(OEt)₃₋₂ₓ(O)_{2x/2}]ₙ

With regard to further technical features and advantages of the oligomeric and/or polymeric silanol precursor according to the present invention having hydrolyzable groups and/or silanol precursor composition, reference is hereby explicitly made to the explanations in connection with the composite composition according to the present invention and the other subjects according to the present invention and to the exemplary embodiments.

The present invention also relates to a preparation method for preparing an oligomeric and/or polymeric silanol and/or silsesquioxane prepolymer, for example polysilsesquioxane prepolymer, in which method at least one oligomeric and/or polymeric silanol precursor having hydrolyzable groups, prepared by a preparation method according to the present invention for preparing an oligomeric and/or polymeric silanol precursor having hydrolyzable groups, and/or at least one oligomeric and/or polymeric silanol precursor according to the present invention having hydrolyzable groups is hydrolyzed, for example partially or completely, with an amount of substance of water that is stoichiometric or substoichiometric, for example up to half-stoichiometric, relative to the amount of substance of the hydrolyzable groups of the at least one oligomeric and/or polymeric silanol precursor having hydrolyzable groups, in an, in particular second, hydrolysis, to form (the) at least one oligomeric and/or polymeric silanol and/or silsesquioxane prepolymer, for example polysilsesquioxane prepolymer.

In this way, an, in particular anhydrous, for example partially hydrolyzed, oligomeric and/or polymeric silanol and/or silsesquioxane prepolymer, for example polysilsesquioxane prepolymer, can advantageously be obtained. In this way, the water content of the composite composition can advantageously be minimized and/or in particular also the amount of the water eliminated during the curing of the composite composition can be reduced, whereby advantageously in turn a shrinkage of the composite during curing can be minimized, and/or the drying and/or the curing can be accelerated, and/or corrosion can be avoided.

The preparation method for preparing an oligomeric and/or polymeric silanol and/or silsesquioxane prepolymer can be designed in particular for preparing an oligomeric and/or polymeric silanol according to the present invention and/or silsesquioxane prepolymer, for example a polysilsesquioxane prepolymer, and/or for preparing an oligomeric and/or polymeric silanol and/or silsesquioxane prepolymer, for example a polysilsesquioxane prepolymer, in particular for a composite composition according to the present invention, and/or for forming a silsesquioxane, in particular a polysilsesquioxane.

In one embodiment of the present invention, the, in particular second, hydrolysis, is carried out at a temperature of ≥60° C., for example of ≥70° C., in particular at a temperature in a range from ≥60° C., for example from ≥70° C., in particular to ≤100° C. The reactants can be mixed at such a temperature. The hydrolysis reaction can advantageously be accelerated by a temperature of ≥60° C., for example of ≥70° C. By limiting the temperature to below 100° C., premature condensation reactions can advantageously be avoided.

In one embodiment of the present invention, the, in particular second, hydrolysis is carried out in a closed system or possibly in a closed system with an overpressure outlet. If the selected temperature is above the boiling point of an alcohol that forms, the system can possibly be a pressure-resistant, closed system and/or an autoclave. After completion of the, in particular second, hydrolysis and, for example, before the beginning of an, in particular second, condensation, which is explained later, for example in the context of curing the composite composition, preferably no further water is added.

The, in particular second, hydrolysis can take place in particular for a specific period of time. This specific period of time can in particular be dependent on the selected temperature. For example, this specific period of time can be in a range from 10 to 30 hours. At a temperature of 70° C., the, in particular second, hydrolysis can be carried out, for example, for at least 10 hours, for example up to 30 hours, for example for approximately 24 hours. At higher temperatures, the specific period of time can possibly shorten corresponding to the applied temperature.

The, in particular second, hydrolysis can in particular be carried out only in the presence of the oligomeric and/or polymeric silanol precursor having hydrolyzable groups and water. This can thus advantageously be carried out without addition of a catalyst or in a catalyst-free manner and/or without addition of an (additional) organic solvent and/or without addition of a base/alkaline solution and/or without addition of further substances.

The hydrolyzable groups can, for example, comprise or be alkoxy groups and/or halogen atoms, for example chlorine atoms. The at least one oligomeric and/or polymeric silanol precursor having hydrolyzable groups can comprise or be at least one oligomeric and/or polymeric silanol precursor having alkoxy groups and/or halogen atoms, for example chlorine atoms, and/or can be hydrolyzed with an amount of substance of water that is stoichiometric or substoichiometric, for example up to half-stoichiometric, relative to the amount of substance of the alkoxy groups and/or halogen atoms, for example chlorine atoms, of the at least one oligomeric and/or polymeric silanol precursor having alkoxy groups and/or halogen atoms, for example chlorine atoms.

In one embodiment of the present invention, the hydrolyzable groups comprise or are alkoxy groups, for example ethoxy groups and/or methoxy groups and/or propoxy groups and/or butoxy groups, in particular ethoxy groups, and/or the at least one oligomeric and/or polymeric silanol precursor having hydrolyzable groups comprises or is at least one oligomeric and/or polymeric silanol precursor having alkoxy groups, for example ethoxy groups and/or methoxy groups and/or propoxy groups and/or butoxy groups, in particular ethoxy groups, and/or is hydrolyzed with an amount of substance of water that is stoichiometric or substoichiometric, for example up to half-stoichiometric, relative to the amount of substance of the alkoxy groups, for example ethoxy groups and/or methoxy groups and/or propoxy groups and/or butoxy groups, in particular ethoxy groups, of the at least one silanol precursor having alkoxy groups, for example ethoxy groups and/or methoxy groups and/or propoxy groups and/or butoxy groups, in particular ethoxy groups. This has proven to be particularly advantageous in the context of the present invention.

The at least one oligomeric and/or polymeric silanol precursor having hydrolyzable groups and/or the at least one oligomeric and/or polymeric silanol and/or silsesquioxane prepolymer, for example polysilsesquioxane prepolymer, can also, for example, have an organic radical or be monosubstituted by an organic radical, in particular per silicon atom. The organic radical can, for example, have a chain length of ≥1 atom or ≥2 atoms or ≥3 atoms or ≥4 or ≥5 or ≥6 atoms or ≥7 atoms. For example, the organic radical can comprise or be an alkyl group, for example a methyl, ethyl or propyl group, and/or an aryl group, for example a phenyl group, and/or an alkylene chain, for example a methylene, ethylene or propylene chain, and/or an arylene group, for example a phenylene group and/or at least one functional group, for example an epoxy group and/or amino group and/or mercapto group and/or vinyl group.

In a specific embodiment of the present invention, the organic radical is an alkyl group, for example a methyl, ethyl or propyl group, in particular a methyl group, and/or the at least one silanol precursor having hydrolyzable groups comprises or is at least one alkylsilanol precursor having hydrolyzable groups, for example methyl-, ethyl- and/or propylsilanol precursor, in particular methylsilanol precursor, and/or the at least one oligomeric and/or polymeric silanol and/or silsesquioxane prepolymer comprises or is at least one oligomeric and/or polymeric alkylsilanol, for example methyl-, ethyl-, and/or propylsilanol, in particular methylsilanol, and/or alkyl silsesquioxane prepolymer, for example alkyl polysilsesquioxane prepolymer, for example methyl, ethyl, and/or propyl silsesquioxane prepolymer, for example methyl, ethyl, and/or propyl polysilsesquioxane prepolymer, in particular methyl silsesquioxane prepolymer, for example methyl polysilsesquioxane prepolymer. Alkylsilanes and alkylsilanols, such as methyl-, ethyl- or propylsilanes and methyl-, ethyl- or propylsilanols, can be comparatively easily obtainable and/or inexpensive. Composites can also advantageously be formed from composite compositions comprising alkylsilanol precursors such as methyl-, ethyl- or propylsilanol precursors, in particular methylsilanols, which composites have hydrophobic properties and an associated low water absorption, withstand temperatures of up to 300° C., and have an adhesive strength on copper of about 8 MPa, and/or in particular also have a thermal conductivity of around and above 5 W/(m·K), a coefficient of thermal expansion of 6-10 ppm/K, very good insulation resistances, in particular even in the presence of moisture, and/or can exhibit no silver electromigration between silver conductor tracks. White fillers can advantageously be used to form white, for example snow-white, composites, which can remain color-stable even under temperature loading at temperatures of up to 300° C.

Via this preparation method, an oligomeric and/or polymeric silanol and/or silsesquioxane prepolymer, for example polysilsesquioxane prepolymer, and/or a silanol composition containing at least one oligomeric and/or polymeric silanol and/or silsesquioxane prepolymer, for example polysilsesquioxane prepolymer, can advantageously be prepared. If the hydrolyzable groups are alkoxy groups, in particular an oligomeric and/or polymeric silanol composition having a moderate to low alcohol content can be prepared, which are advantageously used both for providing the at least one oligomeric and/or polymeric silanol and/or silsesquioxane prepolymer, for example polysilsesquioxane prepolymer, in the composite composition according to the present invention, and/or as a composite composition additive and as such as a casting compound for application on an, in particular metallic and/or ceramic, material, and/or with at least one, in particular ceramic and/or metallic, filler. For example, the oligomeric and/or polymeric silanol composition can be used as such as a casting compound for coating and/or for potting an, in particular metallic and/or ceramic, material, and/or at least one, in particular ceramic and/or metallic, filler. For example, such a silanol composition containing at least one oligomeric and/or polymeric silanol and/or silsesquioxane prepolymer, for example polysilsesquioxane prepolymer, can comprise, relative to the total weight of the silanol composition,
≥50 wt. % to ≤95 wt. %, in particular ≥60 wt. % to ≤95 wt. %, of at least one oligomeric and/or polymeric silanol and/or silsesquioxane prepolymer, for example polysilsesquioxane prepolymer, and
≥5 wt. % to ≤50 wt. %, in particular ≥5 wt. % to ≤40 wt. %, of at least one alcohol, for example in particular in total, of methanol and/or ethanol and/or propanol, for example isopropanol and/or n-propanol, and/or butanol, for example tert-butanol sec-butanol and/or isobutanol and/or n-butanol, in particular ethanol.

With regard to further technical features and advantages of the preparation method according to the present invention for preparing an oligomeric and/or polymeric silanol and/or silsesquioxane prepolymer, for example polysilsesquioxane prepolymer, reference is hereby explicitly made to the explanations in connection with the composite composition according to the present invention and the other subjects according to the present invention and to the exemplary embodiments.

The present invention also relates to an oligomeric and/or polymeric silanol and/or silsesquioxane prepolymer, for example polysilsesquioxane prepolymer, and/or a silanol composition containing at least one oligomeric and/or polymeric silanol and/or silsesquioxane prepolymer, for example polysilsesquioxane prepolymer.

The oligomeric and/or polymeric silanol and/or silsesquioxane prepolymer, for example polysilsesquioxane prepolymer, and/or the silanol composition containing at least one oligomeric and/or polymeric silanol and/or silsesquioxane prepolymer, for example polysilsesquioxane prepolymer, can, for example, be designed or used for a composite composition according to the present invention and/or for forming a silsesquioxane, in particular a polysilsesquioxane, and/or can be prepared by a preparation method according to the present invention for preparing an oligomeric and/or polymeric silanol and/or silsesquioxane prepolymer, for example polysilsesquioxane prepolymer.

In one embodiment, the oligomeric and/or polymeric silanol and/or silsesquioxane prepolymer is based on average in particular on the following chemical formula, relative to the sum of all the silicon atoms:

[RSi(OH)_{y}(X)_{3-2x-y}(O)_{2x/2}]ₙ.

n can in particular stand for the number of repeat units. In particular, it is possible for n≥2, for example n≥3 or 4 or 5, for example n≥10, possibly n>100.

R can stand, for example, for an organic radical, for example having a chain length of ≥1 atom or ≥2 atoms or ≥3 atoms or ≥4 or ≥5 or ≥6 atoms or ≥7 atoms. For example, R can comprise or be an alkyl group, for example a methyl, ethyl or propyl group, and/or an alkylene chain, for example a methylene, ethylene or propylene chain, and/or an aryl group, for example a phenyl group, and/or an arylene group, for example a phenylene group, and/or at least one functional group, for example an epoxy group and/or amino group and/or mercapto group and/or vinyl group.

In one embodiment of the present invention, R stands for an alkyl group. For example, R can stand for a methyl, ethyl or propyl group.

In a specific embodiment of the present invention, R stands for a methyl group.

Alkylsilanes, such as methyl, ethyl or propyl silanes, can be comparatively easily obtainable and/or inexpensive. In addition, composites can advantageously be formed from composite compositions comprising alkylsilanols, for example methyl-, ethyl- or propylsilanols, in particular methylsilanols, which composites have hydrophobic properties and an associated low water absorption, withstand temperatures of up to 300° C., and have an adhesive strength on copper of about 8 MPa, and/or in particular also have a thermal conductivity of around and above 5 W/(m·K), a coefficient of thermal expansion of 6-10 ppm/K, very good insulation resistances, in particular even in the presence of moisture, and/or can exhibit no silver electromigration between silver conductor tracks. White fillers can advantageously be used to form white, for example snow-white, composites, which can remain color-stable even under temperature loading at temperatures of up to 300° C.

X can in particular stand for a hydrolyzable group, for example an alkoxy group (OR′) and/or a halogen atom, for example chlorine atom (Cl).

In a further embodiment of the present invention, X stands for an alkoxy group (OR′). For example, X can stand for an ethoxy group or methoxy group or propoxy group or butoxy group. In the hydrolysis of alkoxysilanes and/or alkoxysilanol, at least one alcohol can advantageously be formed, which can have an advantageous effect on process management and/or handling.

In a specific embodiment of the present invention, X stands for an ethoxy group. In the hydrolysis of alkoxysilanes and/or alkoxysilanol, ethanol can advantageously be formed, which can have a particularly advantageous effect on process management and/or handling.

x can in particular be 0<x<1.50. A reduced curing shrinkage and/or accelerated drying and/or curing and/or reduced corrosion potential and a suitable flowability can thus advantageously be achieved.

In a further embodiment of the present invention, 0.80≤x<1.50. For example, it is possible for 0.80≤ or 0.87≤, in particular 0.90≤, x<1.50, in particular ≤1.45, for example 1.42 or ≤1.40 or ≤1.35. For example, it is possible for 0.90≤x≤1.45, for example ≤1.42 or ≤1.40 or ≤1.35.

In a specific embodiment of the present invention, 0.80≤x≤1.10, for example 0.87≤x≤1.10, in particular 0.90≤x≤1.10. The flowability can thus advantageously be optimized, and at the same time reduced curing shrinkage and/or accelerated drying and/or curing and/or a reduced corrosion potential can be achieved.

In another specific embodiment of the present invention, 1.10<x<1.50, for example 1.12≤, for example 1.13≤ or 1.14≤, for example 1.15≤, x<1.50, in particular ≤1.45, for example ≤1.42 or ≤1.40 or ≤1.35, for example 1.15≤x<1.50, in particular ≤1.45, for example ≤1.42 or ≤1.40 or ≤1.35. An even more reduced curing shrinkage and/or an even more accelerated drying and/or curing and/or an even more reduced corrosion potential can thus advantageously be achieved.

y can in particular be ≤3-2x, i.e., stoichiometric or substoichiometric relative to the hydrolyzable groups. For example, it is possible for (3-2x)/2≤y≤3-2x, i.e., greater than or equal to half-stoichiometric up to stoichiometric relative to the hydrolyzable groups.

In a further form of this embodiment of the present invention, the oligomeric and/or polymeric silanol and/or silsesquioxane prepolymer are based on average on the following chemical formula, relative to the sum of all the silicon atoms:

[RSi(OH)_{y}(OR′)_{3-2x-y}(O)_{2x/2}]ₙ

In this case, R′ can for example stand for an alkyl group, for example for a methyl group or ethyl group or propyl group or butyl group, in particular ethyl group.

In a specific form of this embodiment of the present invention, the oligomeric and/or polymeric silanol and/or silsesquioxane prepolymer are based on average on the following chemical formula, relative to the sum of all the silicon atoms:

[RSi(OH)_{y}(OEt)_{3-2x-y}(O)_{2x/2}]ₙ

In a further specific form of this embodiment of the present invention, in particular on the basis of y=3-2x, the oligomeric and/or polymeric silanol and/or silsesquioxane prepolymer are based on average on the following chemical formula, relative to the sum of all the silicon atoms:

[RSi(OH)₃₋₂ₓ(O)_{2x/2}]ₙ

This has proven to be particularly advantageous.

In a further specific form of this embodiment of the present invention, in particular on the basis of y=(3-2x)/2, the oligomeric and/or polymeric silanol and/or silsesquioxane prepolymer are based on average on the following chemical formula, relative to the sum of all the silicon atoms:
[RSi(OH)_{(3-2x)/2} (X)_{(3-2x)/2}(O)_{2x/2}]ₙ, for example [RSi(OH)_{(3-2x)/2} (OR′)_{(3-2x)/2}(O)_{2x/2}]ₙ, in particular [RSi(OH)_{(3-2x)/2} (OEt)_{(3-2x)/2}(O)_{2x/2}]ₙ.

With regard to further technical features and advantages of the oligomeric and/or polymeric silanol and/or silsesquioxane prepolymer, for example polysilsesquioxane prepolymer, according to the present invention and/or of the silanol composition according to the present invention containing at least one oligomeric and/or polymeric silanol and/or silsesquioxane prepolymer, for example polysilsesquioxane prepolymer, reference is hereby explicitly made to the explanations in connection with the composite composition according to the present invention and the other subjects according to the present invention and to the exemplary embodiments of the present invention.

The present invention also relates to a method for preparing a composite composition according to the present invention. In the method, in particular at least one filler and at least one oligomeric and/or polymeric silanol and/or silsesquioxane prepolymer, for example polysilsesquioxane prepolymer, for example at least one oligomeric and/or polymeric silanol and/or silsesquioxane prepolymer, polysilsesquioxane prepolymer according to the present invention and/or prepared according to the present invention, and/or at least one oligomeric and/or polymeric silanol precursor having hydrolyzable groups, for example at least one oligomeric and/or polymeric silanol precursor according to the present invention and/or prepared according to the present invention and having hydrolyzable groups, and/or at least one silanol having hydrolyzable groups, for example at least one silanol according to the present invention and/or prepared according to the present invention and having hydrolyzable groups, can be mixed. In particular, the following can be used, relative to the total weight of the composite composition to be prepared,
≥10 wt. % to ≤95 wt. % of at least one filler and
≥1 wt. % to ≤20 wt. % of at least one oligomeric and/or polymeric silanol and/or silsesquioxane prepolymer, in particular polysilsesquioxane prepolymer, and/or
≥1 wt. % to ≤20 wt. % of at least one oligomeric and/or polymeric silanol precursor having hydrolyzable groups, and/or
≥1 wt. % to ≤20 wt. % of at least one silanol having hydrolyzable groups.

Advantageously, the composite composition prepared in this way can have a long pot life and, for example, can be storable until processing, in particular under rotation (against settling of the coarse particles), for at least one day, possible also for over a week.

In one embodiment of the present invention, at least one organic solvent, for example at least one alcohol, for example ethanol, and/or at least one non-alcoholic, organic solvent, for example ethyl acetate, is also added to the mixture. The flowability of the composite composition to be prepared can thus advantageously be adjusted. In particular, the at least monomeric and/or oligomeric and/or polymeric silanol can be used in the form of an alcoholic solution, for example in the form of a silanol composition according to the present invention and/or prepared according to the present invention. The at least one filler can be added to the alcoholic solution. The at least one silanol and the at least one filler can thus advantageously be homogenized in a simple manner.

The mixing can take place for example by stirring, for example under a, for example moderate, vacuum, for example of 80 mbar (absolute). The composite composition can thus advantageously be degassed or deaerated and at the same time even solvents, for example the at least one alcohol, can be at least partially removed, as a result of which, on the one hand, holes in the composite to be formed can be avoided and, on the other hand, drying can also be accelerated after application of the composite composition and in particular before curing of the composite composition.

For example, the following can be used, relative to the total weight of the composite composition,
≥2 wt. % to ≤20 wt. %, for example ≥5 wt. % to ≤20 wt. %, for example ≥5 wt. % to ≤15 wt. %, for example ≥10 wt. % to ≤15 wt. %, of the at least one oligomeric and/or polymeric silanol and/or silsesquioxane prepolymer, in particular polysilsesquioxane prepolymer, and/or
≥2 wt. % to ≤20 wt. %, for example ≥5 wt. % to ≤20 wt. %, for example ≥5 wt. % to ≤15 wt. %, for example ≥10 wt. % to ≤15 wt. %, of the at least one oligomeric and/or polymeric silanol precursor having hydrolyzable groups, and/or
≥2 wt. % to ≤20 wt. %, for example ≥5 wt. % to ≤20 wt. %, for example ≥5 wt. % to ≤15 wt. %, for example ≥10 wt. % to ≤15 wt. %, of the at least one silanol having hydrolyzable groups.

In particular, ≥1 wt. % to ≤20 wt. %, for example ≥2 wt. % to ≤20 wt. %, for example ≥5 wt. % to ≤20 wt. %, for example ≥5 wt. % to ≤15 wt. %, for example ≥10 wt. % to ≤15 wt. %, of the at least one oligomeric and/or polymeric silanol and/or silsesquioxane prepolymer, in particular polysilsesquioxane prepolymer, and/or of the at least one oligomeric and/or polymeric silanol precursor having hydrolyzable groups, and/or of the at least one silanol having hydrolyzable groups, can be used in total, relative to the total weight of the composite composition.

In particular, ≥60 wt. % to ≤95 wt. %, for example ≥61 wt. % or ≥62 wt. % or ≥63 wt. % or ≥64 wt. % or ≥65 wt. % or ≥66 wt. % or ≥67 wt. % or ≥68 wt. % or ≥69 wt. %, for example ≥70 wt. % or ≥71 wt. % or ≥72 wt. % oder ≥73 wt. % or ≥74 wt. % or ≥75 wt. % or ≥76 wt. % or ≥77 wt. % or ≥78 wt. % or ≥79 wt. %, for example ≥80 wt. % or ≥81 wt. % or ≥82 wt. % or ≥83 wt. % or ≥84 wt. % or ≥85 wt. %, possibly ≥86 wt. % or ≥87 wt. %, to ≤95 wt. %, for example to ≤94 wt. % or ≤93 wt. %, for example to ≤92 wt. %, possibly to ≤91 wt. % or ≤90 wt. %, of the at least one filler can be used, relative to the total weight of the composite composition.

With regard to further technical features and advantages of the method according to the present invention for preparing a composite composition according to the present invention, reference is hereby explicitly made to the explanations in connection with the composite composition according to the present invention and the other subjects according to the present invention and to the exemplary embodiments of the present invention.

The present invention also relates to a method for forming a composite and/or a silsesquioxane, for example a polysilsesquioxane, for example in the form of a potting, for example a volume potting or volumetric potting, and/or casting and/or a coating and/or a solid structure, in which method a composite composition according to the present invention and/or prepared according to the present invention and/or at least one oligomeric and/or polymeric silanol and/or silsesquioxane prepolymer, for example polysilsesquioxane prepolymer, according to the present invention and/or prepared according to the present invention, and/or an oligomeric and/or polymeric silanol composition according to the present invention and/or prepared according to the present invention, and/or at least one silanol precursor according to the present invention and/or prepared according to the present invention and having hydrolyzable groups, and/or a silanol precursor composition according to the present invention and/or prepared according to the present invention and/or at least one silanol according to the present invention and/or prepared according to the present invention and having hydrolyzable groups, and/or a silanol composition according to the present invention and/or prepared according to the present invention, is cured at a temperature from ≥100° C., in particular from ≥110° C., for example from ≥120° C., for example from ≥130° C., for example to ≤250° C., in particular to ≤220° C., for example to ≤200° C., for example to ≤180° C., for example to ≤170° C., for example at a temperature in a range from ≥100° C. to ≤220° C., for example from ≥110° C. to ≤200° C., for example from ≥120° C. to ≤180° C., for example from ≥130° C. to ≤170° C., for example at approximately 150° C.

Curing can in particular be carried out over a specific period of time, for example from at least half an hour, for example up to sixteen hours, in particular up to ten hours, for example over a specific period of time in a range from 0.5 to 16 hours, in particular up to 10 hours, for example for approximately five hours.

During curing, at least one silsesquioxane, for example polysilsesquioxane, can in particular be formed. For example, at least one alkyl silsesquioxane, for example polyalkyl silsesquioxane, in particular methyl silsesquioxane, for example polymethyl silsesquioxane, can be formed during curing.

In particular, the composite composition according to the present invention and/or prepared according to the present invention, and/or the at least one oligomeric and/or polymeric silanol and/or silsesquioxane prepolymer, for example polysilsesquioxane prepolymer, according to the present invention and/or prepared according to the present invention, and/or the oligomeric and/or polymeric silanol composition according to the present invention and/or prepared according to the present invention, and/or the at least one silanol precursor according to the present invention and/or prepared according to the present invention and having hydrolyzable groups, and/or the silanol precursor composition according to the present invention and/or prepared according to the present invention, and/or the at least one silanol according to the present invention and/or prepared according to the present invention and having hydrolyzable groups, and/or the silanol composition according to the present invention and/or prepared according to the present invention, can be cast initially or before curing.

Advantageously, such compounds can be made so flowable that they can distribute themselves even between small structures, for example electronic structures, under the influence of gravity and the displacement of air. The casting can thus take place under vacuum only optionally. However, the casting can advantageously be carried out in particular without a vacuum. The casting can take place, for example, by means of a dispenser.

In principle, free shapes, in particular without a substrate, can also advantageously be cast by the method. In particular, however, casting can take place onto a, for example ceramic and/or metallic, substrate. The substrate can, for example, comprise or be at least one electronic and/or electrical component and/or at least one electronic and/or electrical assembly, for example at least one chip, for example at least one silicon and/or silicon carbide and/or gallium nitride chip, in particular at least one electronic module, such as a frame module, and/or at least one printed circuit board, for example a ceramic printed circuit board, for example, on the basis of aluminum oxide and/or with at least one aluminum and/or copper layer, for example DBC (direct bonded copper), AMB (active metal brazed), LTCC (low-temperature co-fired ceramic), et cetera, and/or a metallic printed circuit board, for example a circuit board, and/or at least one wire, for example at least one bonding wire and/or at least one coil winding, and/or at least one solder, for example, tin solder. During casting, structures can in particular be potted and/or encased. Advantageously, a volume potting and/or a voluminous encasing can thus also be realized.

A drying step can in particular be carried out before curing, in particular after casting and before curing. Solvents such as alcohols, for example ethanol, and/or water, can thus advantageously be removed. The drying can take place for example even at room temperature, for example even at 24° C., but in particular at an elevated temperature, for example at approximately 50° C., and/or using a temperature ramp, for example in a temperature range from room temperature and above, for example to <100° C. The drying can in particular be carried out over a specific period of time, for example from at least half an hour, for example for up to six hours, in particular for approximately four hours. The drying can be followed by curing at a temperature in a range from ≥100° C. to ≤250° C.

With regard to further technical features and advantages of the method according to the present invention for forming a composite and/or a silsesquioxane, for example a polysilsesquioxane, reference is hereby explicitly made to the explanations in connection with the composite composition according to the present invention and the other subjects according to the present invention and to the exemplary embodiments of the present invention.

The present invention also relates to a composite, for example an electronics and/or electrics composite, in particular a power electronics composite, for example an electronics and/or electrics composite potting, in particular a power electronics composite potting, and/or a silsesquioxane, for example polysilsesquioxane, for example polyalkyl silsesquioxane, in particular methyl silsesquioxane, for example polymethyl silsesquioxane, for example in the form of a potting and/or a casting and/or an encasing and/or a coating and/or a solid structure, which is prepared by a method according to the present invention.

With regard to further technical features and advantages of the composite and/or silsesquioxane, for example polysilsesquioxane, according to the present invention, reference is hereby explicitly made to the explanations in connection with the composite composition according to the present invention and the other subjects according to the present invention and to the exemplary embodiments of the present invention.

The present invention further relates to the use of a composite composition according to the present invention and/or prepared according to the present invention, and/or of an oligomeric and/or polymeric silanol and/or silsesquioxane prepolymer, for example polysilsesquioxane prepolymer, according to the present invention and/or prepared according to the present invention, and/or of an oligomeric and/or polymeric silanol composition according to the present invention and/or prepared according to the present invention, and/or of a silanol precursor according to the present invention and/or prepared according to the present invention and having hydrolyzable groups, and/or of a silanol precursor composition according to the present invention and/or prepared according to the present invention, and/or of a silanol according to the present invention and/or prepared according to the present invention and having hydrolyzable groups, and/or of a silanol composition according to the present invention and/or prepared according to the present invention, as a potting compound and/or casting compound and/or encasing compound and/or coating agent and/or as, for example, for electrics and/or electronics, in particular power electronics. In this way, conventional potting compounds and/or casting compounds and/or encasing compound and/or coating agents, for example agents conventionally used in electronics and/or electrics, such as conventional potting compounds and/or casting compounds and/or silicone gels and/or so-called conformal coatings (printed circuit board lacquer/insulating lacquer) and/or other coating agents, can advantageously be replaced.

The compositions and/or compounds according to the present invention can be used, for example, as a potting compound for potting semiconductor components, for example, for the frame potting of modules containing Si, SiC and/or GaN semiconductor elements, and/or of other components, for example of, for example flat, passive electronic components.

An efficient heat dissipation can advantageously be achieved by the composite composition according to the present invention and/or prepared according to the present invention or by the composite according to the present invention and/or prepared according to the present invention. In addition, the composite according to the present invention and/or prepared according to the present invention can advantageously be heat-resistant and retain its properties even at high (operating) temperatures. The composite composition according to the present invention and/or prepared according to the present invention and/or the composite according to the present invention and/or prepared according to the present invention can therefore be used particularly advantageously for potting and/or encasing or as potting compound and/or encasing compound for power electronics, in particular with high operating temperatures. In this case, the composite composition according to the present invention and/or prepared according to the present invention and/or the composite according to the present invention and/or prepared according to the present invention can be particularly suitable for use on DBC (direct bonded copper), AMB (active metal brazed) and/or MLC (multilayer ceramic) substrates, in particular since a coefficient of thermal expansion close to the coefficient of thermal expansion of these substrate technologies can be achieved thereby, and thermal stresses can be avoided in this way, for example in contrast to epoxy mold compounds.

The compositions and/or compounds according to the present invention can advantageously also be applied directly and/or on unpackaged and/or uninsulated, electronic and/or electrical components, for example chips, for example unpackaged and/or uninsulated power electronics, for example so-called bare dies (unpackaged semiconductor chips), for example which are mounted on a printed circuit board, for example on a ceramic printed circuit board or on an organically bonded printed circuit board or a so-called leadframe. In this case, both an application on active electronic components and an application on passive electronic components, for example chokes, can advantageously be possible. The compositions and/or compounds according to the present invention can advantageously also be used as packaging for so-called discretes, in particular small semiconductor components, which are then only applied later to a printed circuit board.

By means of the compositions and/or compounds according to the present invention, hard pottings can advantageously be realized, whereby the robustness of electronic and/or electrical components can be improved and/or these can be better protected from environmental influences, for example from moisture. Due to their hydrophobic properties, compounds having alkyl groups, for example methyl groups, have proven particularly advantageous here.

The compositions and/or compounds according to the present invention can advantageously be used for potting not only voluminous components but also assemblies and flat components and assemblies. In addition, the composite composition can of course also be used for potting insulated electronic and/or electrical components, for example the winding of a choke coil, for example an EMC choke coil, and/or already encased packages. The compositions and/or compounds according to the present invention can particularly advantageously be used for potting power electronics, in particular under high thermal loading, for example for high voltages and/or currents. The compositions and/or compounds according to the present invention can also advantageously be used for potting other types of electronics, for example for control electronics.

In addition, the compositions and/or compounds according to the present invention can advantageously also be used for mold casting, for example in a silicone mold, for example which is subsequently removed.

The compositions and/or compounds according to the present invention can also advantageously be used as binders. For example, the compositions and/or compounds according to the present invention can be used as binders in the applications explained above.

Compositions, compounds and/or composites according to the present invention can advantageously be detected by means of element analysis, FTIR spectroscopy and/or other methods characterizing binding structure and/or by means of SEM analysis and/or other microstructure-representing methods and/or by means of EDX analysis and/or other methods identifying binding phase in addition to fillers in the composite.

With regard to further technical features and advantages of the use according to the present invention, reference is hereby explicitly made to the explanations in connection with the composite composition according to the present invention and the other subjects according to the present invention and to the exemplary embodiments.

### BRIEF DESCRIPTION OF THE DRAWING

Further advantages and advantageous embodiments of the subjects according to the present invention are illustrated by the FIGURE and the exemplary embodiments of the present invention and explained in the following description. It should be noted that the FIGURE and the exemplary embodiments are only descriptive in character and are not intended to limit the present invention in any way.

FIG. 1 is a schematic cross-section through an embodiment of an electronics composite potting according to the present invention.

### DETAILED DESCRIPTION OF EXAMPLE EMBODIMENTS

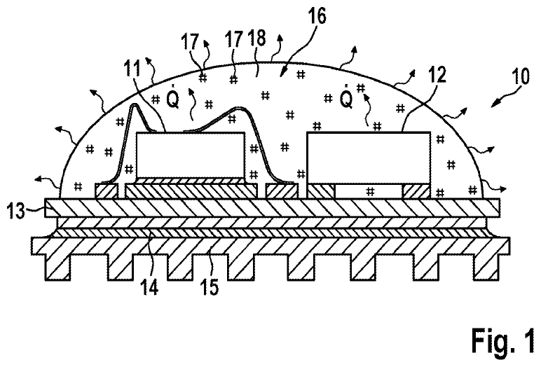

FIG. 1 shows an electronics composite potting 10, which comprises an active component 11 in the form of a semiconductor chip, for example on the basis of silicon and/or silicon carbide and/or silicon nitride, with bonding wires and a passive component 12, for example a capacitor. The two components 11, 12 are arranged on a ceramic printed circuit board 13, for example DCB, AMB, et cetera, which 13 in turn is arranged on a heat conducting paste 14 applied to a cooler 15.

FIG. 1 shows that the components 11, 12 and their periphery, such as the bonding wires, and the upper side of the printed circuit board 13 are potted with a composite potting 16, which comprises filler particles 17. In this case, the surfaces of the filler particles 17 are connected via chemical bonds (not shown) to a three-dimensional Si—O—Si—O network 18, wherein the three-dimensional Si—O—Si—O-network 18 in turn is connected via chemical bonds (not shown) to the surface of the components 11, 12, to the periphery thereof, and to the upper side of the printed circuit board 13. Such a composite potting 16 or electronics composite potting can advantageously be prepared from a composite composition according to the present invention that comprises ≥10 wt. % to ≤95 wt. % of at least one filler and ≥1 wt. % to ≤20 wt. % of at least one oligomeric and/or polymeric silanol and/or silsesquioxane prepolymer, in particular polysilsesquioxane prepolymer, and/or ≥1 wt. % to ≤20 wt. % of at least one oligomeric and/or polymeric silanol precursor having hydrolyzable groups, and/or ≥1 wt. % to ≤20 wt. % of at least one silanol having hydrolyzable groups, and by means of a preparation method according to the present invention.

FIG. 1 shows that the composite composition according to the present invention can be so flowable that it can distribute itself even between such small structures without pressure under the influence of gravity and the displacement of air.

The curved arrows and \dot{Q} in FIG. 1 indicate that a good thermal conductivity and thereby a temperature spreading and temperature dissipation in the volume can thus be ensured.

### Exemplary Embodiments 1a to 4a: Preparation of Ethoxymethylsilanols (1st Hydrolysis) and Oligomeric and/or Polymeric Ethoxymethylsilanol Precursors (1st Condensation)

In exemplary embodiments 1a to 4a, methyl triethoxysilane (MeSi(OEt)₃) was first partially hydrolyzed in a first hydrolysis with water in the amounts indicated in Table 1. Less than 3 mol of water were added to one mole of methyl triethoxysilane. In this case, water was thus used in an amount of substance that was substoichiometric relative to the amount of substance of the ethoxy groups of the methyl triethoxysilane. In particular, water was used in this case in an amount of substance that was less than half-stoichiometric relative to the amount of substance of the ethoxy groups of the methyl triethoxysilane, and/or in an amount of substance that was in a ratio (x) of <1.50 relative to the amount of substance of the methyl triethoxysilane. It was thereby ensured that only a portion, determined by the amount of substance of water, of the ethoxy groups of the methyl triethoxysilane was hydrolyzed and reacted with water to form hydroxy groups.

TABLE 1
amounts in the first hydrolysis (1st hydrolysis) and
first condensation (1st condensation) of methyl triethoxysilane
according to exemplary embodiments 1a to 1d

| | MeSi (OEt)₃ | | | [MeSi (OEt)₃₋₂ₓ (O)_{2x/2}] | EtOH |
|---|---|---|---|---|---|
| No. | [mmol] | H₂O [mmol] | x | [wt. %] | [wt. % ] |
| 1a | 86.26 | 86.26 | 1.00 | 53.05 | 46.95 |
| 1b | 59.17 | 73.96 | 1.25 | 42.61 | 57.39 |
| 1c | 560.85 | 757.15 | 1.35 | 38.57 | 61.43 |
| 1d | 448.68 | 650.59 | 1.45 | 34.61 | 65.39 |

During the first hydrolysis, only methyl triethoxysilane and water were stirred at a temperature of 70° C. No catalyst, no additional organic solvent, no base/alkaline solution and/or no other additives were added. Only methyl triethoxysilane and water were mixed or reacted with one another. The first hydrolysis was carried out in a closed vessel for approximately one hour. Methyl triethoxysilane is not soluble in water; the mixture is initially a two-phase system. However, as a result of the hydrolysis of the ethoxy groups to hydroxy groups, the mixture becomes a single-phase system, in the form of a clear, in particular transparent, solution, in particular without turbidity, which makes it possible to determine the completion of the first hydrolysis by a visual inspection. It has thus surprisingly been found that the hydrolysis can obviously be carried out in a very simple manner, in acceptable times, in particular even without addition of a catalyst and/or solvent and/or a base/alkaline solution and/or other additives.

In this way, methylsilanols having ethoxy groups were prepared initially by the first hydrolysis, in particular in accordance with the following reaction equation:

$${MeSi ( OEt )}_{3} + x {H}_{2} O \to {MeSi ( OEt )}_{3 - x} {( OH )}_{x} + x EtOH .$$

In principle, such silanols having hydrolyzable groups can already be used as binders, in particular in a composite composition, since both the hydroxy groups and the hydrolyzable ethoxy groups can condense directly both amongst one another and with OH groups on material surfaces, for example of fillers and/or substrates, and/or hydroxy groups of other components, for example of other composite composition components, with elimination of alcohol, in particular ethanol. By using such silanols having hydrolyzable groups, for example as binders, in particular in a composite composition, a reduction in the curing shrinkage and/or an acceleration of the drying and/or curing and/or a reduction in corrosion can advantageously already be achieved, in particular in comparison with aqueous silanol solutions. In order to improve this further, however, it has proven advantageous to condense, in particular to oligomerize and/or polymerize, the silanols having hydrolyzable groups.

After 1 h of the first hydrolysis, in particular at a temperature of 70° C., the temperature was increased to 150° C. and stirred at 150° C. for 4 h for this purpose. In this case, the methylsilanols having ethoxy groups formed in the partial first hydrolysis were partially condensed, in particular oligomerized and/or polymerized, by means of a first condensation, which can in particular be a polycondensation, with elimination of water to form oligomeric and/or polymeric methylsilanol precursors having ethoxy groups. Here too, no catalyst, no additional organic solvent, no base/alkaline solution and/or no other additives were added.

It was found that water produced in situ during the condensation can hydrolyze further ethoxy groups of the methylsilanol having ethoxy groups to form hydroxy groups and ethanol. This ultimately led to a situation in which twice as many moles of ethoxy groups react after the first hydrolysis and the first condensation, in particular first to form hydroxy groups, and the hydroxy groups then condense, in particular oligomerize and/or polymerize, to form silicon-oxygen bonds, and twice as many moles of ethanol can be formed than moles of water added at the beginning.

In this way, oligomeric and/or polymeric methylsilanol precursors having ethoxy groups were prepared by the first condensation, in particular in accordance with the following reaction equation:

$${MeSi ( OEt )}_{3 - x} {( OH )}_{x} \to {[ {RSi ( OEt )}_{3 - 2 x} {( O )}_{2 x / 2} ]}_{n} + x EtOH .$$

The water formed in situ in the first condensation has not been included in the above reaction equation, since it can react in situ directly with ethoxy groups still present, as explained above.

After the 4 h of the first condensation, ethanol produced was evaporated out of the warm mixture by a gas stream, for example nitrogen. Oligomeric and/or polymeric methylsilanol precursors having ethoxy groups could thus advantageously be obtained, which did not contain any significant amounts of ethanol and water and were storage-stable over several days.

Table 1 illustrates that as ratio x increases, the amount of alcohol formed, in particular ethanol, and thus also the degree of condensation, in particular degree of oligomerization and/or polymerization, of the oligomeric and/or polymeric silanol precursor having ethoxy groups increases. This amount of alcohol formed, in particular ethanol, can be removed after the first condensation, for example before use in a composite composition. In this way, the curing shrinkage of the composite composition is the more reduced, the more alcohol is formed in the first condensation, wherein the more alcohol is formed, the higher is the ratio x. Because the ratio x<1.5 is selected, it can advantageously be ensured that the oligomeric and/or polymeric silanol precursors prepared in this way still have a remainder of hydrolyzable ethoxy groups, for example 0.1 hydrolyzable ethoxy group (x=1.45) to 1 hydrolyzable ethoxy group (x=1.00) per silicon atom, via which a binder function can be achieved in the composite composition. In principle, such oligomeric and/or polymeric silanol precursors can already be used as binders, in particular in a composite composition, since the remaining hydrolyzable ethoxy groups can condense directly with OH groups on material surfaces, for example of fillers and/or substrates, and/or hydroxy groups of other components, for example from other composite composition components, with elimination of alcohol, in particular ethanol, and/or hydrolyze in the presence of water, for example in the form of (residual) moisture, for example of fillers, substrates and/or other composite composition components, and/or a very small amount of substance of water, for example that is stoichiometric to half-stoichiometric relative to the amount of substance of the hydrolyzable ethoxy groups, and then condense. However, hydroxy groups can be more reactive than hydrolyzable groups. In order to further accelerate the curing and/or to avoid complex hydroxy group estimations, calculations and/or determinations and/or a subsequent addition of water, and since the hydrolyzed product has a lower volatility than the unhydrolyzed product, which can have an advantageous effect on curing, it has been found advantageous, however, to hydrolyze the remaining hydrolyzable ethoxy groups of the oligomeric and/or polymeric methylsilanol precursors having ethoxy groups before use as a binder, in particular in a composite composition, to form more reactive hydroxy groups.

### Exemplary Embodiments 2a to 2d: Preparation of Oligomeric and/or Polymeric Methylsilanols and/or (Poly)Methyl Silsesquioxane Prepolymers (2nd Hydrolysis)

In exemplary embodiments 2a to 2d, the oligomeric and/or polymeric methylsilanol precursors having ethoxy groups as prepared in exemplary embodiments 1a to 1d were hydrolyzed in a second hydrolysis with a further amount of substance y of water in the amounts indicated in Table 2. In this case, water was used in an amount of substance y that was stoichiometric (y=3-2x) relative to the amount of substance of the ethoxy groups of the methylsilanol precursor (3-2x). For the reasons already explained, however, it is also possible in principle to use an amount of substance y of water that is up to half-stoichiometric (y=(3-2x)/2) relative to the amount of substance of the ethoxy groups of the oligomeric and/or polymeric methylsilanol precursor (3-2x). As a result of the further amount of substance y of water, it can be ensured that the remaining ethoxy groups of the oligomeric and/or polymeric methylsilanol precursor are hydrolyzed completely (y=3-2x) or at least partially, in particular at least half (y=(3-2x)/2), and react to form hydroxy groups.

TABLE 2
amounts in second hydrolysis (2nd hydrolysis) of oligomeric and/or polymeric
methylsilanol precursors having ethoxy groups from exemplary embodiments 1a
to 1d to form oligomeric and/or polymeric methylsilanols and/or (poly)methyl
silsesquioxane prepolymers according to exemplary embodiments 2a to 2d

| | [MeSi(OEt)₃₋₂ₓ(O)_{2x/2}]ₙ | | H₂O | y = 3 − | [MeSi(OH)₃₋₂ₓ(O)_{2x/2}]ₙ | H₂O |
|---|---|---|---|---|---|---|
| No. | [mmol] | x | [mmol] | 2x | [wt. %] | [wt. %] |
| 2a | 99.14 | 1.00 | 99.14 | 1.00 | 62.29 | 37.71 |
| 2b | 120.70 | 1.25 | 60.35 | 0.50 | 75.63 | 24.37 |
| 2c | 195.90 | 1.35 | 58.77 | 0.30 | 83.45 | 16.55 |
| 2d | 166.90 | 1.45 | 16.69 | 0.10 | 93.65 | 6.35 |

In the second hydrolysis, the oligomeric and/or polymeric methylsilanol precursors having ethoxy groups from exemplary embodiments 1a to 1d were stirred with the further amount of substance y of water indicated in Table 2 at a temperature of 70° C. The second hydrolysis can also take place in particular in a closed vessel.

The second hydrolysis was carried out until a clear solution was obtained. The time period for this hydrolysis can vary, for example, between 10 hours and 30 hours, depending on the age and degree of condensation, in particular which proportion of the ethoxy groups have already been reacted. Since the oligomeric and/or polymeric methylsilanol precursors having ethoxy groups are not soluble in water, the mixture is initially a two-phase system. However, as a result of the hydrolysis of the ethoxy groups to hydroxy groups, the mixture becomes a single-phase system, in the form of a clear, in particular transparent, solution, which also makes it possible to determine the completion of the second hydrolysis by a visual inspection. In exemplary embodiments 1a to 1d, the second hydrolysis was carried out for a period of 24 hours.

In the second hydrolysis too, only the respective oligomeric and/or polymeric methylsilanol precursor having ethoxy groups and water were mixed or reacted with one another. Here too, no catalyst, no additional organic solvent, no base/alkaline solution and/or no other additives were added.

By means of the second hydrolysis, for example, oligomeric and/or polymeric methylsilanols and/or (poly)methyl silsesquioxane prepolymers can be prepared, in particular in accordance with the following reaction equation:
[MeSi(OEt)₃₋₂ₓ(O)_{2x/2}]ₙ+y H₂O→[MeSi(OH)_{y}(OEt)_{3-2x-y}(O)_{2x/2}]ₙ+y EtOH where (3-2x)/2 y 3-2x, in particular
[MeSi(OEt)₃₋₂ₓ(O)_{2x/2}]+3-2x H₂O→[MeSi(OH)₃₋₂ₓ(O)_{2x/2}]ₙ+3-2x EtOH where y=3-2x.

After completion of the second hydrolysis, a clear solution of the respective oligomeric and/or polymeric methylsilanol and/or (poly)methyl silsesquioxane prepolymer formed. The alcohol, in particular ethanol, produced in this hydrolysis was not evaporated, since it can be helpful for liquefying the slip.

The oligomeric and/or polymeric methylsilanols and/or (poly)methyl silsesquioxane prepolymers prepared by means of the second hydrolysis can be condensed or cured in a second condensation, for example in accordance with the following reaction equation:
[MeSi(OH)_{y}(OEt)_{3-2x-y}(O)_{2x/2}]ₙ→[MeSi(O)_{1,5}]ₙ++y−(3-2x)/2H₂O+3-2x-y EtOH where (3-2x)/2≤y≤3-2x, in particular
[RSi(OH)₃₋₂ₓ(O)_{2x/2}]ₙ→[RSi(O)_{1,5}]_{n′}+(3-2x)/2H₂O where y=3-2x.

The oligomeric and/or polymeric methylsilanols and/or (poly)methyl silsesquioxane prepolymers prepared in the exemplary embodiments 2a to 2d can in particular be condensed or cured in such a way that the amounts of (poly)methyl silsesquioxanes and water indicated in Table 3 are formed.

TABLE 3
amounts of (poly) methyl silsesquioxanes and water
produced in condensation or curing of oligomeric and/or
polymeric methylsilanols and/or (poly) methyl silsesquioxane
prepolymers prepared in exemplary embodiments 2a to 2d

| | [MeSi (OH)₃₋₂ₓ (O)_{2x/2}]ₙ | | | [MeSi (O)_{1,5}]ₙ | H₂O |
|---|---|---|---|---|---|
| No. | [mmol] | x | y = 3 − 2x | [wt. % ] | [wt. %] |
| 2a | 99.14 | 1.00 | 1.00 | 88.17 | 11.83 |
| 2b | 120.70 | 1.25 | 0.50 | 93.72 | 6.28 |
| 2c | 195.90 | 1.35 | 0.30 | 96.13 | 3.87 |
| 2d | 166.90 | 1.45 | 0.10 | 98.68 | 1.32 |

Table 3 shows that comparatively small amounts of water, namely less than 12 wt. % of water are formed in the condensation or curing of the oligomeric and/or polymeric methylsilanols and/or (poly)methyl silsesquioxane prepolymers prepared in exemplary embodiments 2a to 2d, in comparison with the condensation of the corresponding, completely hydrolyzed silanol methylsilanol triol (MeSi(OH)₃), in which almost 30 wt. % of water is formed. Due to this significantly reduced amount of water forming during curing, the oligomeric and/or polymeric methylsilanols and/or (poly)methyl silsesquioxane prepolymers prepared in exemplary embodiments 2a to 2d advantageously have a significantly reduced curing shrinkage.

Table 3 illustrates that the oligomeric and/or polymeric methylsilanol and/or (poly)methyl silsesquioxane prepolymer prepared in exemplary embodiment 2d, which was prepared by using an amount of substance of water in a ratio x of 1.45 relative to the amount of substance of the methyl triethoxysilane used in the first hydrolysis, the curing shrinkage is minimal. The oligomeric and/or polymeric methylsilanols and/or (poly)methyl-silsesquioxane prepolymers prepared in exemplary embodiments 2b and 2c, which were prepared by using an amount of substance of water in a ratio x of 1.25 and 1.35 relative to the amount of substance of the methyl triethoxysilane used in the first hydrolysis, also had a relatively low curing shrinkage. With regard to achieving an optimally reduced curing shrinkage, it has therefore proven to be advantageous if water is used in the first hydrolysis in an amount of substance in a ratio of 1.1<x<1.5, for example 1.15≤x≤1.45 relative to the amount of substance of the methyl triethoxysilane.

However, the tests carried out have shown that the flowability increases with a reduction in the ratio x of the amount of substance of water to the amount of substance of the methyl triethoxysilane. However, with regard to flowability, the oligomeric and/or polymeric methylsilanol and/or (poly)methyl silsesquioxane prepolymer prepared in exemplary embodiment 2a, which was prepared in the first hydrolysis using an amount of substance of water in a ratio x of 1.00 relative to the amount of substance of the methyl triethoxysilane, was found to be the best, wherein this still had a significantly reduced curing shrinkage in comparison with the corresponding, fully hydrolyzed methylsilanol triol (MeSi(OH)₃). With regard to achieving an optimized flowability with at the same time reduced curing shrinkage, it can therefore be advantageous in particular if water is used in the first hydrolysis in an amount of substance in a ratio of around 1, for example of 0.80≤x≤1.1, for example of 0.90≤x≤1.1, relative to the amount of substance of the methyl triethoxysilane.

### Exemplary Embodiments 3a to 3d: Preparation of Composite Compositions Comprising Oligomeric and/or Polymeric Methylsilanols and/or (Poly)Methyl Silsesquioxane Prepolymers

In exemplary embodiments 3a to 3d, the, in particular alcoholic, for example ethanolic, solutions containing oligomeric and/or polymeric methylsilanols and/or (poly)methyl silsesquioxane prepolymers prepared in exemplary embodiments 2a to 2d for preparing composite compositions, were used to form composites. For this purpose, the alcoholic, in particular ethanolic, solutions containing oligomeric and/or polymeric methylsilanols and/or (poly)methyl silsesquioxane prepolymers from the exemplary embodiments 2a to 2d were mixed with inorganic fillers, in particular with a coarse aluminum oxide and with a fine aluminum oxide, and with a wetting agent and with a defoamer, in the amounts indicated in Table 4. By means of a mixture of a coarse and a fine aluminum oxide, the flowability of the mass can advantageously be further improved and an increased filling level can be achieved. The thermal conductivity can in turn advantageously be increased by an increased filling level.

TABLE 4
Components and amounts of the composite compositions of
exemplary embodiments 3a to 3d

| Material | Weight [wt. %] | [Vol. %] |
|---|---|---|
| Coarse Al₂O₃ | 82.70 | 56.84 |
| Fine Al₂O₃ | 4.86 | 3.34 |
| No. 2a-2d | 12.10 | 23.11 |
| Ethanol from no. 2a-2d | — | 15.75 |
| Wetting agent | 0.27 | 0.73 |
| Defoamer | 0.08 | 0.23 |

The mixing process took place in a vacuum stirrer. In this way, an introduction of air could be avoided and a bubble-free slip could be obtained. The slip can be used after about five minutes of vacuum stirring. In this, in particular uncured, state, the composite compositions thus obtained, which can be used, for example, as potting compound and/or encasing compound, were flowable or had a viscosity that was low enough for them to flow by themselves, in particular without the application of an external force. A vacuum can therefore optionally be used for potting the composite compositions but is advantageously not absolutely necessary.

### Exemplary Embodiments 4a to 4d: Preparation of Composites

Electronic components were potted with the composite compositions from exemplary embodiments 3a to 3d. After potting, the composite composition was first dried, in particular in order to evaporate or remove the proportion of alcohol, in particular ethanol. This can in principle take place even at room temperature, for example at 24° C., but preferably at an elevated temperature, for example at approximately 50° C. The drying was carried out over a period of at least half an hour, for example for up to six hours, in particular for approximately four hours. The composite composition was then cured in a thermal process at a temperature in a range from ≥100° C. to 250° C., in particular at approximately 150° C. The actual (poly)condensation reaction (2nd condensation) takes place in the process, and the oligomeric and/or polymeric methylsilanols and/or (poly)methyl silsesquioxane prepolymers are converted to (poly)methyl silsesquioxanes, as a result of which the composite composition is solidified, in particular cured, to form the composite. Curing was carried out over a period of at least half an hour, for example for up to ten hours, in particular for approximately five hours.

After this temperature treatment, the composite formed was dimensionally stable and could be handled. The formed composites were able to withstand temperatures of up to 300° C., had a thermal conductivity of around and above 5 W/(m·K), an adhesive strength on copper of about 8 MPa and a coefficient of thermal expansion of 6-10 ppm/K. In addition, the composites formed had a snow-white color, which remained color-stable even under temperature loading at temperatures of up to 300° C. Furthermore, the composites formed had hydrophobic properties and an associated low water absorption. In tests under voltage, the formed composites showed very good insulation resistances, in particular even in the presence of moisture (test via SIR test), and no silver electromigration was observed between silver conductor tracks.

1-31. (canceled)

32. A composite composition for forming a composite, wherein the composite composition comprises, relative to a total weight of the composite composition:
≥10 wt. % to ≤95 wt. % of at least one filler, and:
(i) ≥1 wt. % to ≤20 wt. % of at least one oligomeric and/or polymeric silanol and/or polysilsesquioxane prepolymer, and/or
(ii) ≥1 wt. % to ≤20 wt. % of at least one oligomeric and/or polymeric silanol precursor having hydrolyzable groups, and/or
(iii) ≥1 wt. % to ≤20 wt. % of at least one silanol having hydrolyzable groups.

33. The composite composition according to claim 32, wherein the composite composition comprises, relative to the total weight of the composite composition: ≥1 wt. % to ≤20 wt. % in total: (i) of the at least one oligomeric and/or polymeric silanol and/or polysilsesquioxane prepolymer, and/or (ii) of the at least one oligomeric and/or polymeric silanol precursor having hydrolyzable groups, and/or (iii) of the at least one silanol having hydrolyzable groups.

34. The composite composition according to claim 32, wherein the composite composition comprises, relative to the total weight of the composite composition:
(i) ≥75 wt. % to ≤95 wt. %, of the at least one filler, and/or (ii) ≥5 wt. % to ≤20 wt. % in total: (a) of the at least one oligomeric and/or polymeric silanol and/or polysilsesquioxane prepolymer, and/or (b) of the at least one oligomeric and/or polymeric silanol precursor having hydrolyzable groups, and/or (c) of the at least one silanol having hydrolyzable groups.

35. The composite composition according to claim 32, wherein the at least one oligomeric and/or polymeric silanol and/or polysilsesquioxane prepolymer, and/or the at least one oligomeric and/or polymeric silanol precursor having hydrolyzable groups, and/or the at least one silanol, have hydrolyzable groups having an organic radical per silicon atom, wherein the organic radical is a methyl group.

36. The composite composition according to claim 32, wherein: (i) the at least one oligomeric and/or polymeric silanol and/or polysilsesquioxane prepolymer, and/or (ii) the at least one oligomeric and/or polymeric silanol precursor having hydrolyzable groups, and/or (iii) the at least one silanol having hydrolyzable groups, is prepared by a first hydrolysis of at least one silane having three hydrolyzable groups with an amount of substance of water that is half-stoichiometric or less than half-stoichiometric, relative to an amount of substance of the hydrolyzable groups, wherein: (i) the hydrolyzable groups are alkoxy groups and/or halogen atoms, and/or (ii) the at least one silane having three hydrolyzable groups includes or is at least one trialkoxysilane and/or at least one trihalosilane.

37. The composite composition according to claim 36, wherein the hydrolyzable groups are ethoxy groups, and/or the at least one silane having three hydrolyzable groups comprises at least one triethoxysilane.

38. The composite composition according to claim 32, wherein:
(i) the at least one oligomeric and/or polymeric silanol and/or polysilsesquioxane prepolymer is based on average on the following chemical formula, relative to the sum of all the silicon atoms: [RSi(OH)₃₋₂ₓ(O)_{2x/2}]ₙ, and/or
(ii) the at least one oligomeric and/or polymeric silanol precursor having hydrolyzable groups is based on average on the following chemical formula, relative to the sum of all the silicon atoms: [RSi(OR′)₃₋₂ₓ(O)_{2x/2}]ₙ, and/or
(iii) the at least one silanol having hydrolyzable groups is based on average on the following chemical formula, relative to the sum of all the silicon atoms: RSi(OR′)₃₋ₓ(OH)ₓ, and
wherein n stands for the number of repeat units,
wherein 0.80≤x<1.50,
wherein (3-2x)/2≤y≤3-2x,
wherein R stands for a methyl group,
wherein X stands for an alkoxy group or a halogen atom,
wherein R′ stands for an ethyl group.

39. The composite composition according to claim 32, wherein the at least one filler includes at least one oxidic filler and/or nitridic filler and/or carbidic filler and/or siliceous filler.

40. The composite composition according to claim 32, wherein:
(i) the at least one filler includes at least one coarse filler and at least one fine filler, the at least one coarse filler has a granulation band in a range from ≥1 μm to ≤200 μm and/or a D50 value of ≥5 μm to ≤110 μm, and the at least one fine filler has a granulation band in a range from ≥0.05 μm to ≤1 μm and/or a D50 value of ≥0.1 μm to ≤0.9 μm, and/or
(ii) the composite composition includes, relative to the total weight of the composite composition, ≥60 wt. % to ≤90 wt. % of the at least one coarse filler and ≥0 wt. % to ≤8 wt. % of the at least one fine filler.

41. A silanol having hydrolyzable groups, for a composite composition which includes, relative to a total weight of the composite composition:
≥10 wt. % to ≤95 wt. % of at least one filler, and:
(i) ≥1 wt. % to ≤20 wt. % of at least one oligomeric and/or polymeric silanol and/or polysilsesquioxane prepolymer, and/or
(ii) ≥1 wt. % to ≤20 wt. % of at least one oligomeric and/or polymeric silanol precursor having hydrolyzable groups, and/or
(iii) ≥1 wt. % to ≤20 wt. % of at least one silanol having hydrolyzable groups;
wherein the silanol having hydrolyzable groups is based on average on the following chemical formula, relative to a sum of all silicon atoms:
RSi(X)₃₋ₓ(OH)ₓ,
wherein 0.80≤x<1.50,
wherein R stands for an organic radical,
wherein X stands for a hydrolyzable group.

42. The silanol having hydrolyzable groups according to claim 41, wherein the silanol having hydrolyzable groups is based on average on the following chemical formula, relative to the sum of all the silicon atoms:
RSi(OR′)₃₋ₓ(OH)ₓ,
wherein 0.80≤x<1.50,
wherein R stands for an alkyl group, in particular a methyl group,
wherein R′ stands for an alkyl group, in particular an ethyl group.

43. An oligomeric and/or polymeric silanol precursor having hydrolyzable groups for a composite composition which includes, relative to a total weight of the composite composition:
≥10 wt. % to ≤95 wt. % of at least one filler, and:
(i) ≥1 wt. % to ≤20 wt. % of at least one oligomeric and/or polymeric silanol and/or polysilsesquioxane prepolymer, and/or
(ii) ≥1 wt. % to ≤20 wt. % of at least one oligomeric and/or polymeric silanol precursor having hydrolyzable groups, and/or
(iii) ≥1 wt. % to ≤20 wt. % of at least one silanol having hydrolyzable groups;
wherein the at least one oligomeric and/or polymeric silanol precursor having hydrolyzable groups is based on average on the following chemical formula, relative to a sum of all silicon atoms:
[RSi(X)₃₋₂ₓ(O)_{2x/2}]ₙ,
wherein n stands for the number of repeat units,
wherein 0.90≤x≤1.45,
wherein R stands for an organic radical, and
wherein X stands for a hydrolyzable group.

44. The oligomeric and/or polymeric silanol precursor having hydrolyzable groups according to claim 43, wherein the at least one oligomeric and/or polymeric silanol precursor having hydrolyzable groups is based on average on the following chemical formula, relative to the sum of all the silicon atoms:
[RSi(OR′)₃₋₂ₓ(O)_{2x/2}]ₙ,
wherein n stands for the number of repeat units,
wherein 0.90≤x≤1.45,
wherein R stands for the organic radical, and
wherein R′ stands for an alkyl group.

45. An electronics and/or electrics composite and/or silsesquioxane, in the form of a potting and/or a casting and/or an encasing and/or a coating and/or a solid structure, prepared by curing, at a temperature of ≥100° C., a composite composition, and/or at least one oligomeric and/or polymeric silanol and/or silsesquioxane prepolymer, and/or an oligomeric and/or polymeric silanol composition, and/or at least one silanol precursor having hydrolyzable groups, and/or a silanol precursor composition, and/or at least one silanol having hydrolyzable groups, and/or a silanol composition.

46. The composite composition according to claim 32, wherein the composite composition is used as a potting compound and/or casting compound and/or encasing compound and/or coating agent and/or binder, for electrics and/or electronics.
